(19) United States
(12) Patent Application Publication
(10) Pub. No.: US 2017/0278332 A1
(43) Pub. Date: Sep. 28, 2017

(54) WRAPPED-COIN DISPENSING APPARATUS

(71) Applicant: GLORY LTD., Himeji-shi, Hyogo (JP)

(72) Inventor: Jason Ammar NADER, Hyogo (JP)

(21) Appl. No.: 15/505,516

(22) PCT Filed: Jul. 16, 2015
(86) PCT No.: PCT/JP2015/070416

§ 371 Date: Feb. 21, 2017

(30) Foreign Application Priority Data
Aug. 26, 2014 (CN) 201410424698.X
Aug. 26, 2014 (CN) 201420484709.9

(51) Int. Cl. G07D 1/00; G07D 9/00

(52) U.S. Cl. CPC G07D 1/00; G07D 9/006

(57) ABSTRACT

Provided is a wrapped-coin dispensing apparatus 300 in which a storage unit 310 includes a pair of side walls forming a storage area for wrapped coin rolls therebetween, and at least one of the pair of side walls is configured as an openable and closable door 314 through which the wrapped coin rolls are taken in and out from the storage unit 310. The height of a storage area differs between a side, in the storage unit 310, where a dispensing mechanism 319 is provided, and a side opposite to the side where the dispensing mechanism 319 is provided.

### FIELD OF THE INVENTION

The present invention relates to a wrapped-coin dispensing apparatus configured to dispense wrapped coin rolls stored in a machine body to the outside of the machine body.

### DESCRIPTION OF THE RELATED ART

Various types of wrapped-coin dispensing apparatus for dispensing wrapped coin rolls stored in a machine body to the outside of the machine body have been used to date. For example, wrapped-coin dispensing apparatus disclosed in Japanese Patent No. 3857001 (JP38570018), Japanese Laid-Open Patent Publication No. 2002-109607 (JP2002-109607A), U.S. Pat. No. 7,111,754 (U.S. Pat. No. 7,111,754B), and U.S. Pat. No. 7,571,833 (U.S. Pat. No. 7,571,8338) have been known.

### SUMMARY OF THE INVENTION

In such a wrapped-coin dispensing apparatus, in the case where a plurality of wrapped coin rolls are stored in a storage unit so as to be stacked in multiple layers, if the height of a storage area in the storage unit is uniform, the number of wrapped coin rolls stored in the storage unit might be too great. In this case, the wrapped coin rolls stacked in multiple layers in the storage unit may cause so-called bridge phenomenon, and the wrapped coin rolls stored in the storage unit cannot be dispensed by a dispensing mechanism.

The present invention has been made in view of such circumstances. In the present invention, the height of the storage area is made different between the side, in the storage unit, where the dispensing mechanism is provided, and the side opposite to the side where the dispensing mechanism is provided. Thus, the number of wrapped coin rolls stored in the storage unit is prevented from being too great, thereby preventing the wrapped coin rolls stored in the storage unit from causing so-called bridge phenomenon.

A wrapped-coin dispensing apparatus according to the present invention includes a storage unit and a lift unit. The storage unit is provided with a dispensing mechanism configured to dispense a plurality of wrapped coin rolls which are stored on a storage face inclined with respect to a horizontal plane so as to be stacked in a direction in which the wrapped coin rolls run along the inclined storage face. The dispensing mechanism dispenses the wrapped coin rolls, one by one, from a side closest to a portion, at a lowest height level, of the storage face. The lift unit includes a wrapped-coin storage member configured to store, therein, the wrapped coin rolls dispensed from the storage unit by the dispensing mechanism. The lift unit is movable in a vertical direction. The storage unit includes a pair of side walls which form a storage area for the wrapped coin rolls therebetween. At least one of the pair of side walls is configured as an openable and closable door through which the wrapped coin rolls are taken in and out from the storage unit. The height of the storage area differs between a side of the storage unit where the dispensing mechanism is provided, and a side opposite to the side where the dispensing mechanism is provided.

In the wrapped-coin dispensing apparatus according to the present invention, a storage area regulating portion configured to reduce the height of the storage area may be provided in an upper portion of the storage unit on the side opposite to the side where the dispensing mechanism is provided.

In the wrapped-coin dispensing apparatus according to the present invention, a wrapped-coin insertion preventing portion configured to prevent wrapped coin rolls from being inserted into an upper portion of the storage area from the outside of the storage unit may be provided in an upper portion at a side face of the storage unit, on the side where the dispensing mechanism is provided.

In the wrapped-coin dispensing apparatus according to the present invention, the storage unit may be provided with a denomination indicating part which indicates a denomination of wrapped coin rolls to be stored in the storage unit.

In the wrapped-coin dispensing apparatus according to the present invention, a wrapped-coin insertion method indicating part which indicates a method of inserting wrapped coin rolls into the storage area from the outside of the storage unit may be provided.

In the wrapped-coin dispensing apparatus according to the present invention, the side wall of the storage unit, other than the door, may be divided into a plurality of members, each member having a comb teeth shaped joint portion, and the comb teeth shaped joint portions of the members may be mutually meshed.

In the wrapped-coin dispensing apparatus according to the present invention, the dispensing mechanism may include: a rotor configured to rotate about an axial center extending in a direction orthogonal to a direction of inclination of the storage unit and in a horizontal direction, and have at least two recessed portions, each recessed portion receiving, one by one, the wrapped coin rolls stored in the storage unit; and a drive unit configured to rotate the rotor about the axial center. A gear configured to transmit a rotational drive force to the rotor may be provided on a side of the rotor, and the gear may be provided with a plurality of through-holes corresponding to the recessed portions of the rotor.

In the wrapped-coin dispensing apparatus according to the present invention, a scale indicating the number of wrapped coin rolls stored at the bottom of the storage area may be provided on the storage face of the storage unit.

In the wrapped-coin dispensing apparatus according to the present invention, the door may be configured such that an operator is able to visually observe the inside of the storage unit, and the door may be provided with a scale indicating the number of wrapped coin rolls stored at the bottom of the storage area.

### BRIEF DESCRIPTION OF THE DRAWINGS

FIG. 1 is a perspective view showing the external appearance of a money changer according to an embodiment of the present invention.

FIG. 2 is a perspective view showing the internal structure of the money changer shown in FIG. 1 with a lower door provided at a front face of an outer housing being opened.

FIG. 3 is a perspective view showing the internal structure of the money changer shown in FIG. 1 with an upper door provided at the front face of the outer housing being additionally opened from the state shown in FIG. 2.

FIG. 4 is a top view showing the structure of the lower door, as seen from above, in the money changer shown in FIG. 1 etc.

FIG. 5 is a perspective view showing the structure of the upper door in the money changer shown in FIG. 1 etc.

FIG. 6 is a vertical cross-sectional view of the upper door shown in FIG. 5.

FIG. 7 is a vertical cross-sectional view showing, in an enlarged manner, a small article placement part of the upper door shown in FIG. 6.

FIG. 8 is a front view of the upper door shown in FIG. 5.

FIG. 9 is a vertical cross-sectional view of the upper door shown in FIG. 5.

FIG. 10 is a schematic block diagram schematically showing the structure of the money changer shown in FIG. 1.

FIG. 11 is a perspective view showing the external appearance of a loose coin depositing and dispensing apparatus provided inside the outer housing of the money changer shown in FIG. 1.

FIG. 12 is a side view showing the internal structure of the loose coin depositing and dispensing apparatus shown in FIG. 11.

FIG. 13 is a front view showing the internal structure of the loose coin depositing and dispensing apparatus shown in FIG. 11.

FIG. 14 is a perspective view showing the structure of a coin insertion mechanism provided in the loose coin depositing and dispensing apparatus shown in FIG. 11.

FIG. 15 is a top view showing the structure of the coin insertion mechanism shown in FIG. 14.

FIG. 16 is a vertical cross-sectional view of the coin insertion mechanism shown in FIG. 15, taken along a direction of arrows A-A in FIG. 15, showing the state before a coin receiving section is inclined.

FIG. 17 is a vertical cross-sectional view of the coin insertion mechanism shown in FIG. 15, taken along the direction of arrows A-A in FIG. 15, showing the state after the coin receiving section is inclined.

FIG. 18 is a vertical cross-sectional view of the coin insertion mechanism shown in FIG. 15, taken along a direction of arrows B-B in FIG. 15.

FIG. 19 is a vertical cross-sectional view of the coin insertion mechanism shown in FIG. 15, taken along a direction of arrows C-C in FIG. 15.

FIG. 20 is a perspective view showing the state where a coin receiving unit is opened upward in the coin insertion mechanism shown in FIG. 15.

FIG. 21 is a perspective view showing the structure of a foreign material receiving unit provided in the coin insertion mechanism shown in FIG. 15.

FIG. 22 is a perspective view showing the structure of a collection box which collects coins from the loose coin depositing and dispensing apparatus shown in FIG. 11.

FIG. 23 is a side view showing the state where the collection box shown in FIG. 22 is conveyed by pulling a cord hooked on the collection box.

FIG. 24 is a perspective view showing the structure, on the bottom face, of the collection box shown in FIG. 22.

FIG. 25 is a vertical cross-sectional view showing the structure of a rear wheel provided on the collection box shown in FIG. 24.

FIG. 26 is a side view schematically showing the state where the collection box shown in FIG. 22 is housed inside a collection box housing disposed below the housing of the loose coin depositing and dispensing apparatus.

FIG. 27 is a side view schematically showing the state where the collection box shown in FIG. 22 is in the process of being pulled out from the collection box housing disposed below the housing of the loose coin depositing and dispensing apparatus.

FIG. 28 is a top view showing the internal structure of the collection box shown in FIG. 22 as seen from above, with an upper lid thereof being opened.

FIG. 29 is a perspective view showing the external appearance of a loose banknote depositing and dispensing apparatus provided inside the outer housing of the money changer shown in FIG. 1 etc.

FIG. 30 is a side view showing the internal structure of the loose banknote depositing and dispensing apparatus shown in FIG. 29.

FIG. 31 is a perspective view showing the external appearance of a wrapped-coin dispensing apparatus provided inside the outer housing of the money changer shown in FIG. 1 etc.

FIG. 32 is a side view showing the internal structure of the wrapped-coin dispensing apparatus shown in FIG. 31.

FIG. 33 is a perspective view showing the structure of a dispensing mechanism provided in each of storage units in the wrapped-coin dispensing apparatus shown in FIG. 31.

FIG. 34 is a side view of the dispensing mechanism shown in FIG. 33.

FIG. 35 is a side view showing, in detail, components such as a rotor of the dispensing mechanism shown in FIG. 34.

FIG. 36 is a side view showing, in detail, the components such as the rotor of the dispensing mechanism shown in FIG. 34.

FIG. 37 is a side view showing an operation of dispensing wrapped coin rolls stored in the storage unit by means of the dispensing mechanism in the wrapped-coin dispensing apparatus shown in FIG. 31.

FIG. 38 is a side view showing an operation of dispensing the wrapped coin rolls stored in the storage unit by means of the dispensing mechanism in the wrapped-coin dispensing apparatus shown in FIG. 31.

FIG. 39 is a side view showing an operation of dispensing the wrapped coin rolls stored in the storage unit by means of the dispensing mechanism in the wrapped-coin dispensing apparatus shown in FIG. 31.

FIG. 40 is a side view showing an operation of dispensing the wrapped coin rolls stored in the storage unit by means of the dispensing mechanism in the wrapped-coin dispensing apparatus shown in FIG. 31.

FIG. 41 is a side view showing the state where the so-called bridge phenomenon of wrapped coin rolls occurs in the vicinity of the dispensing mechanism in the storage unit of the wrapped-coin dispensing apparatus shown in FIG. 31.

FIG. 42 is a perspective view showing the structure of a wrapped-coin storage member in a lift unit of the wrapped-coin dispensing apparatus shown in FIG. 31.

FIG. 43 is a perspective view showing the structure of the wrapped-coin storage member shown in FIG. 42, as seen from another angle.

FIG. 44 is a vertical cross-sectional view showing the internal structure of the wrapped-coin storage member shown in FIG. 42 and FIG. 43, in the state where no wrapped coin roll is stored therein.

FIG. 45 is a vertical cross-sectional view showing the internal structure of the wrapped-coin storage member shown in FIG. 42 and FIG. 43, in the state where wrapped coin rolls are stored therein.

FIG. 46 is a perspective view showing the structure of a lifting and lowering mechanism which causes the wrapped-coin storage member in the lift unit of the wrapped-coin dispensing apparatus shown in FIG. 31 to move up and down.

FIG. 47 is a perspective view showing the structure of the lifting and lowering mechanism shown in FIG. 46, as seen from another angle.

FIG. 48 is a perspective view showing the structure of the money changer shown in FIG. 1 in the state where the wrapped-coin dispensing apparatus is pulled out frontward from the outer housing after the lower door and the upper door are opened.

FIG. 49 is a perspective view showing the structure in the state where a door of a storage unit of the wrapped-coin dispensing apparatus is opened from the state shown in FIG. 48.

FIG. 50 is a side view showing the internal structure of each of the storage units of the wrapped-coin dispensing apparatus shown in FIG. 31.

FIG. 51 is a side view showing the state where the doors of the storage units of the wrapped-coin dispensing apparatus shown in FIG. 31 are opened.

FIG. 52 is a diagram showing the structure of the door in the wrapped-coin dispensing apparatus shown in FIG. 31.

FIG. 53 is a side view showing the structure of a door fixing member (door lock member) for fixing (locking) the door in the wrapped-coin dispensing apparatus shown in FIG. 31 in the closed state.

FIG. 54 is a side view showing the structure in the case where the door is opened from the state shown in FIG. 53.

FIG. 55 is a side view showing the structure of the door fixing member shown in FIG. 53 in detail.

FIG. 56 is a side view showing the state where the door is opened by turning the door fixing member shown in FIG. 55 upward.

FIG. 57 is a perspective view showing the structure of a fixing unit (lock unit) for fixing (locking) the wrapped-coin dispensing apparatus shown in FIG. 31 inside the outer housing.

FIG. 58 is a side view of the fixing unit shown in FIG. 57.

FIG. 59 is a perspective view showing an operation of canceling the fixed state of the wrapped-coin dispensing apparatus due to the fixing unit, by pushing a handle provided in the fixing unit shown in FIG. 57 downward.

FIG. 60 is a diagram showing the content of a wrapped-coin insertion method indicating part provided on a side face of the housing of the wrapped-coin dispensing apparatus shown in FIG. 31.

FIG. 61 is a perspective view showing the structure of the money changer shown in FIG. 1, in which a back plate is attached to the outer housing.

FIG. 62 is an enlarged perspective view showing, in an enlarged manner, the structure shown in FIG. 61 in which the back plate is attached to the outer housing.

FIG. 63 is a perspective view showing the structure of the money changer shown in FIG. 1, as seen from the rear side.

### DETAILED DESCRIPTION OF THE INVENTION

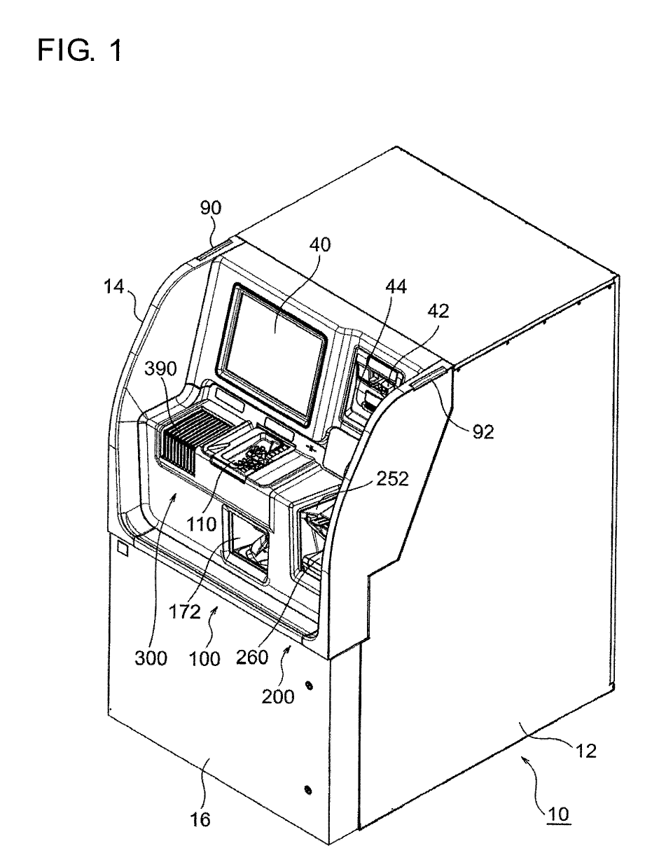

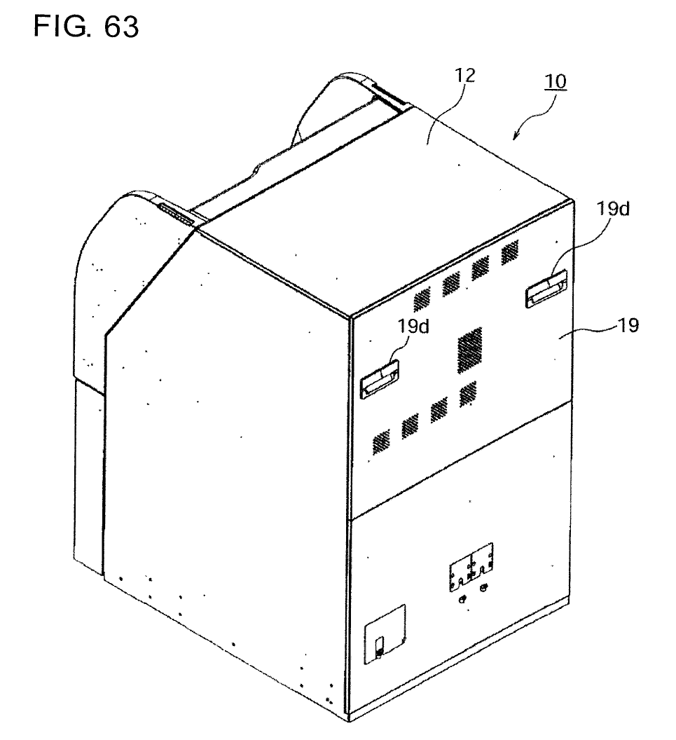

Hereinafter, an embodiment of the present invention will be described with reference to the drawings. FIGS. 1 to 63 are diagrams illustrating the structure of a money changer according to the present embodiment. The money changer according to the present embodiment is installed in a lobby of a financial facility or the like, and is used for money change processes performed thereon through operations of customers. More specifically, the money changer according to the present embodiment is able to perform, as money change processes, a forward money change process in which the denomination of dispensed money is smaller than the denomination of deposited money, and a reverse money change process in which the denomination of dispensed money is larger than the denomination of deposited money. In the money changer according to the present embodiment, when the above money change processes are performed, there is a case where a service charge for money changing is deducted from the amount of the deposited money and the remaining amount of money is dispensed. Further, in the money changer according to the present embodiment, new banknotes of the same total amount as that of deposited old banknotes, or of an amount after deduction of a service charge for money changing from the total amount, may be dispensed. Alternatively, fit notes of the same total amount as that of deposited unfit notes, or of an amount after deduction of a service charge for money changing from the total amount, may be dispensed. Still alternatively, brand-new notes (so-called new bills) of the same total amount as that of deposited circulated notes, or of an amount after deduction of a service charge for money changing from the total amount, may be dispensed.

[Overall Structure of Money Changer]

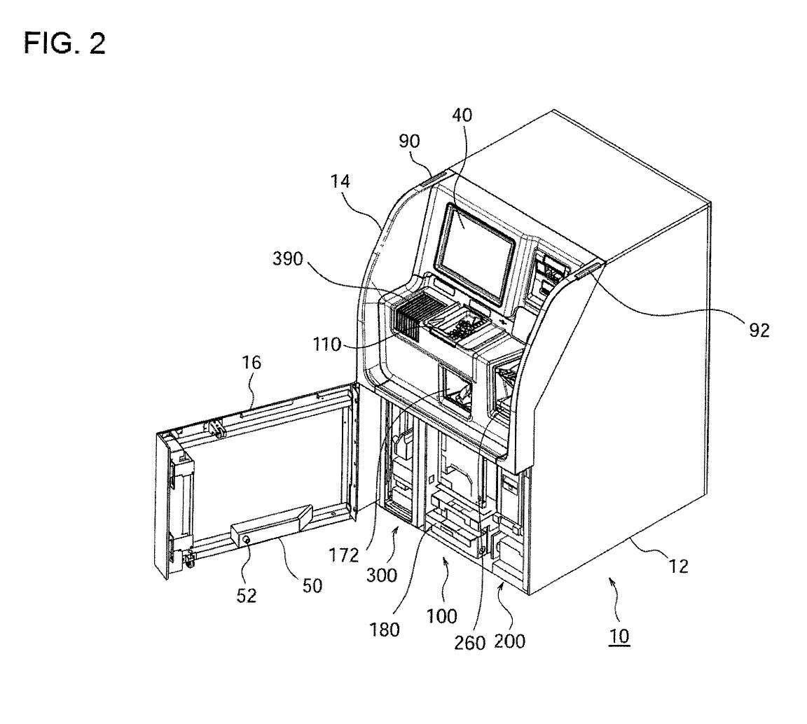

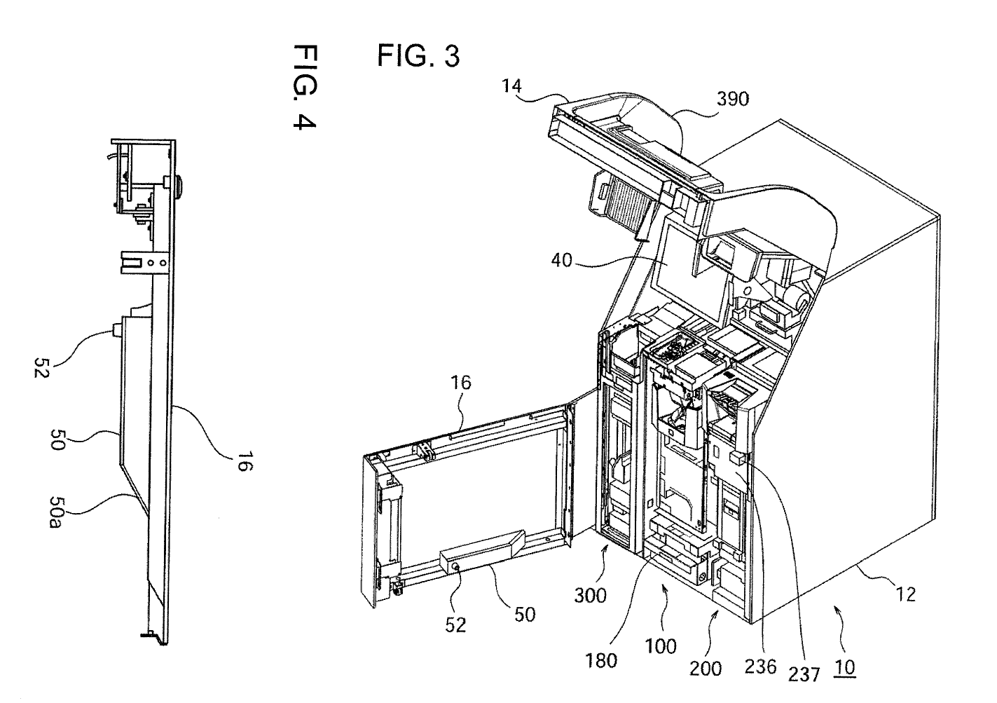

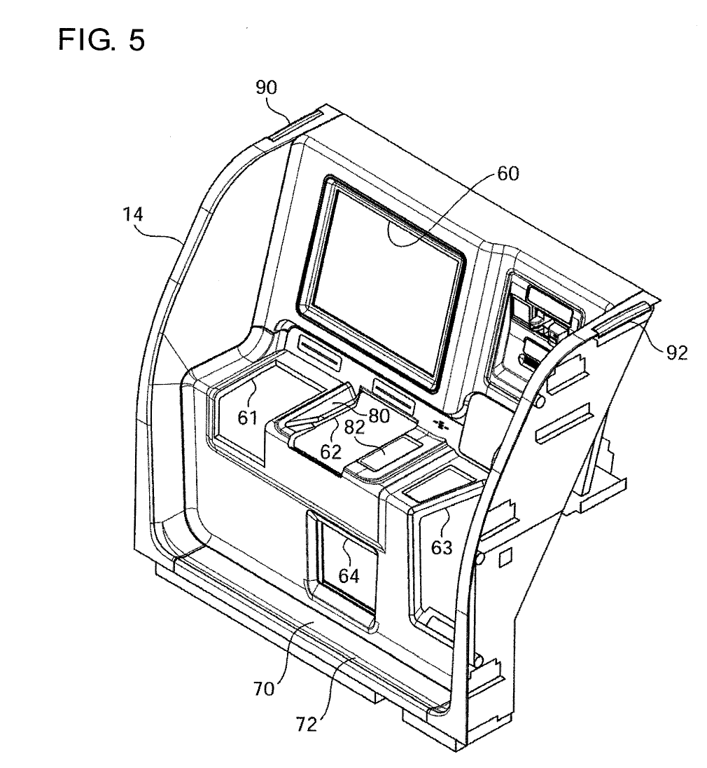

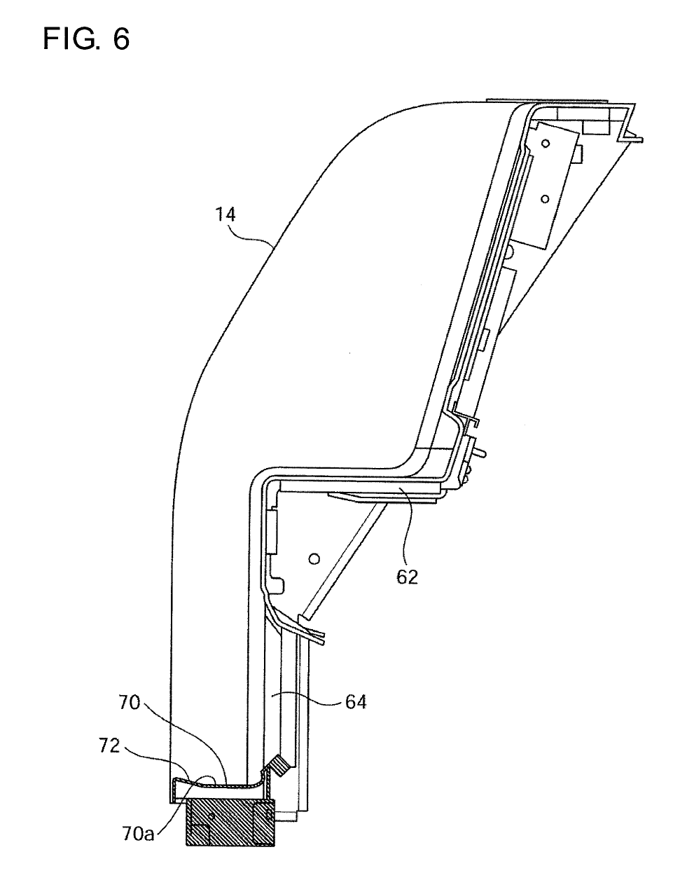

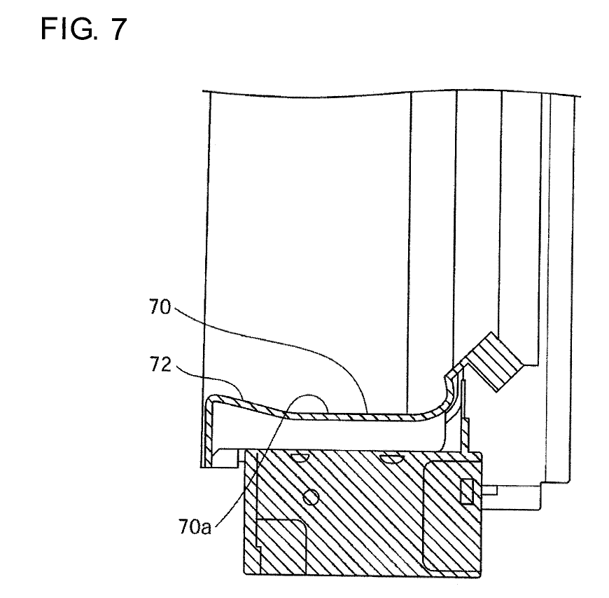

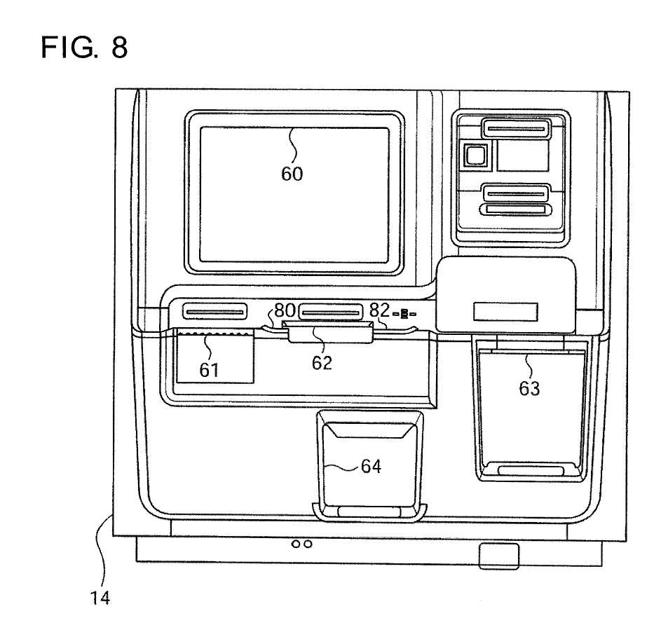

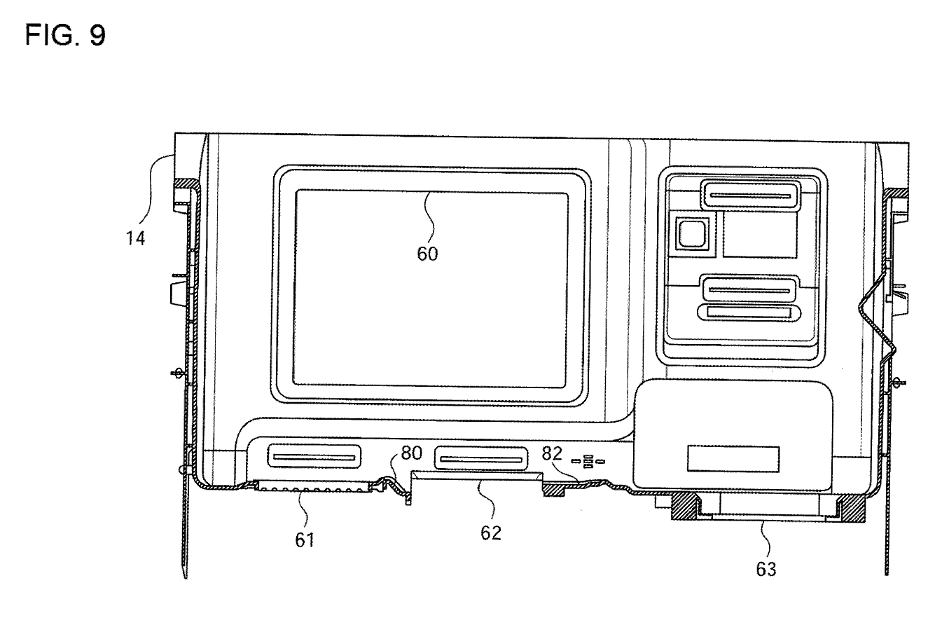

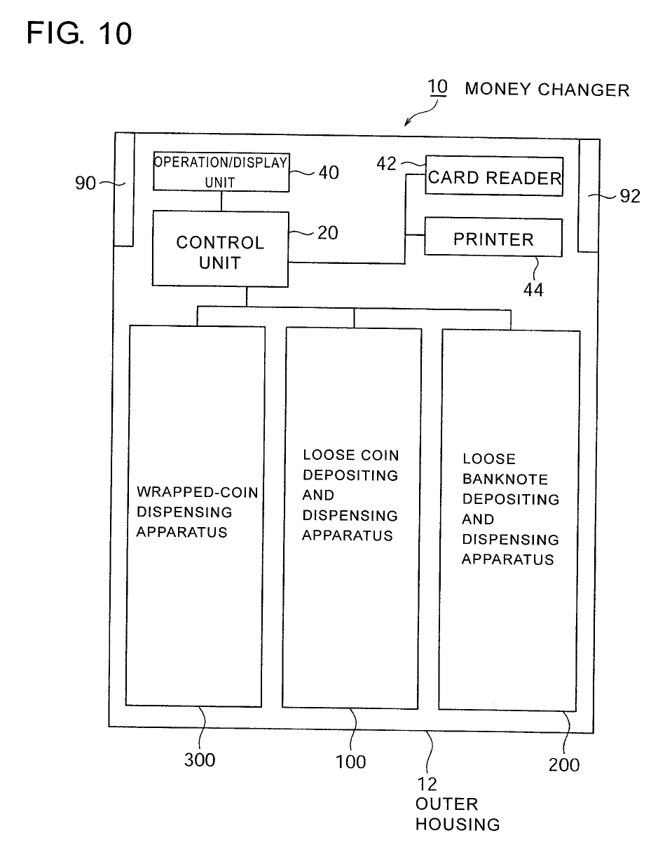

First, the overall structure of the money changer according to the present embodiment will be described with reference to FIG. 1 through FIG. 10. FIG. 1 is a perspective view showing the external appearance of the money changer according to the present embodiment. FIG. 2 is a perspective view showing the internal structure of the money changer shown in FIG. 1 with a lower door provided at a front face of an outer housing being opened. FIG. 3 is a perspective view showing the internal structure of the money changer shown in FIG. 1 with an upper door provided at the front face of the outer housing being additionally opened from the state shown in FIG. 2. FIG. 4 is a top view showing the structure of the lower door, as seen from above, in the money changer shown in FIG. 1 etc. FIG. 5 is a perspective view showing the structure of the upper door in the money changer shown in FIG. 1 etc. FIG. 6 is a vertical cross-sectional view of the upper door shown in FIG. 5. FIG. 7 is a vertical cross-sectional view showing, in an enlarged manner, a small article placement part of the upper door shown in FIG. 6. FIG. 8 is a front view of the upper door shown in FIG. 5. FIG. 9 is a vertical cross-sectional view of the upper door shown in FIG. 5. FIG. 10 is a schematic block diagram schematically showing the structure of the money changer shown in FIG. 1.

As shown in FIG. 1 etc., the money changer 10 according to the present embodiment includes an outer housing 12 having a substantially rectangular parallelepiped shape. Inside the outer housing 12, a loose coin depositing and dispensing apparatus 100, a loose banknote depositing and dispensing apparatus 200, and a wrapped-coin dispensing apparatus 300 are arranged side by side in a horizontal direction. The loose coin depositing and dispensing apparatus 100, the loose banknote depositing and dispensing apparatus 200, and the wrapped-coin dispensing apparatus 300 each can be pulled out frontward in the horizontal direction to be taken out from the inside of the outer housing 12 independently from the other apparatuses.

Further, the upper door 14 and the lower door 16 are provided at the front face of the outer housing 12 of the money changer 10. As shown in FIG. 3, the upper door 14 can be opened upward from the closed state shown in FIG. 1, and the lower door 16 can be laterally opened from the closed state shown in FIG. 1. In the present embodiment, each of the upper door 14 and the lower door 16 constitutes a part of the outer housing 12. At the left and right sides of an upper part of the upper door 14, light-emitting diodes (LED) 90 and 92 serving as state notifying units are provided, respectively. The light-emitting diodes 90 and 92 notify, to the outside by optical display, which of a plurality of previously set states the money changer 10 is in.

As shown in FIG. 10, the money changer 10 according to the present embodiment is provided with a control unit 20 which is connected to each of the loose coin depositing and dispensing apparatus 100, the loose banknote depositing and dispensing apparatus 200, and the wrapped-coin dispensing apparatus 300 to control these apparatuses 100, 200, and 300. Further, as shown in FIG. 1 through FIG. 3, an operation/display unit 40 composed of, for example, a touch panel or the like is provided on the back side of the upper door 14 of the money changer 10, and the operation/display unit 40 is connected to the control unit 20 (refer to FIG. 10). The operation/display unit 40 displays information about the handling condition of money, the inventory amount of money, and the like in each of the apparatuses 100, 200, and 300, and allows an operator to input various instructions to the control unit 20 through operations performed on the operation/display unit 40. In addition, as shown in FIG. 5, the upper door 14 is provided with an opening 60 which allows the operator to operate the operation/display unit 40 and see the displayed content on the operation/display unit 40. The money changer 10 may be provided with a display unit composed of a monitor or the like, and an operation unit composed of a keyboard, operation keys, or the like, which units are provided separately from each other instead of the operation/display unit 40 composed of a touch panel or the like.

In the present embodiment, the operation/display unit 40 is vertically moved in conjunction with an opening/closing operation of the upper door 14. That is, when the upper door 14 is opened upward from a front face upper portion of the outer housing 12 (refer to FIG. 3), the operation/display unit 40 is moved upward from the position thereof at which the upper door 14 is closed. Thus, when the loose coin depositing and dispensing apparatus 100 or the wrapped-coin dispensing apparatus 300 is pulled out frontward from the inside of the outer housing 12 after the upper door 14 is opened, the operation/display unit 40 is moved upward so that the loose coin depositing and dispensing apparatus 100 or the wrapped-coin dispensing apparatus 300 does not come into contact with the operation/display unit 40. Since the operation/display unit 40 is vertically moved in conjunction with the opening/closing operation of the upper door 14, the space inside the outer housing 12 can be utilized more effectively than in the case where the position of the operation/display unit 40 is fixed. Moreover, the operability of the operation/display unit 40 is improved. In addition, when the loose coin depositing and dispensing apparatus 100 or the wrapped-coin dispensing apparatus 300 is pulled out, the operation of pulling out the apparatus 100 or 300 can be reliably performed without being hindered by the operation/display unit 40. The operation/display unit 40 is not limited to the above structure that is vertically moved in conjunction with the opening/closing operation of the upper door 14. The operation/display unit 40 may have alternative structures as follows. That is, the operation/display unit 40 may be moved in the left-right direction or the front-rear direction in conjunction with the opening/closing operation of the upper door 14, or may be pivotally moved in conjunction with the opening/closing operation of the upper door 14.

As shown in FIG. 5, the upper door 14 is provided with: an opening 62 through which the operator inserts coins into a coin insertion mechanism 110 (described later) of the loose coin depositing and dispensing apparatus 100; an opening 64 through which the operator takes out coins from a coin outlet 172 (described later) of the loose coin depositing and dispensing apparatus 100; an opening 63 through which the operator inserts banknotes into a depositing unit 252 of the loose banknote depositing and dispensing apparatus 200 and takes out banknotes from a dispensing unit 260 of the loose banknote depositing and dispensing apparatus 200; and an opening 61 through which the operator takes out wrapped coin rolls from a wrapped-coin storage member 382 of a lift unit 380 in the wrapped-coin dispensing apparatus 300. On the rear side (the inner side of the apparatus) of the upper door 14 at positions near the respective openings 61, 62, 63, and 64, rubber cushion, sponge, or the like is attached, and the cushion rubber, sponge, or the like prevents coins and/or banknotes from being accidentally inserted into the money changer 10 through gaps between the rear side of the upper door 14 and housings 102, 202, and 302 of the respective apparatuses 100, 200, and 300.

As shown in FIG. 10, a card reader 42 and a printer 44 are connected to the control unit 20 of the money changer 10. The card reader 42 reads an ID card or the like possessed by the operator to perform identification of the operator. The printer 44 functions as a printing unit which prints, on a receipt or the like, information about the handling condition of money, the inventory amount of money, and the like in each of the apparatuses 100, 200, and 300, or information about a money change process performed by the operator. As shown in FIG. 1, a card insertion port through which a card is inserted into the card reader 42 and a receipt dispensing port through which a receipt is dispensed from the printer 44 are provided on the upper door 14 of the money changer 10. Further, the card reader 42 adopted in the present embodiment does not take therein an ID card or the like inserted into the card insertion port, but returns the ID card or the like to the outside from the card insertion port after reading the card. Using this card reader 42 prevents the operator, who has inserted the ID card or the like into the card insertion port, from forgetting to take out the ID card or the like from the card insertion port.

Further, as shown in FIG. 2, on a lower portion of an inner face of the lower door 16, a projecting member 50 projecting inward from the inner face of the lower door 16 is provided. The structure of this projecting member 50 will be described with reference to FIG. 4. As shown in FIG. 4, the projecting member 50 has a slanted surface 50a inclined with respect to the inner face of the lower door 16. Since the projecting member 50 has the slanted surface 50a, even when the wrapped-coin dispensing apparatus 300 is pulled out frontward in the horizontal direction from the inside of the outer housing 12 in the state where the lower door 16 is not completely opened from a front face lower portion of the outer housing 12 of the money changer 10, a front end portion of the wrapped-coin dispensing apparatus 300 hits the slanted surface 50a of the projecting member 50, whereby the lower door 16 is opened in accordance with the operation of pulling out the wrapped-coin dispensing apparatus 300. Thus, the wrapped-coin dispensing apparatus 300 can be smoothly pulled out without being hindered by the lower door 16. Further, as shown in FIG. 2 and FIG. 4, the projecting member 50 is provided with a projection-shaped buffer member 52 formed of rubber cushion or the like. Since the buffer member 52 is provided on the projecting member 50, even when the lower door 16 is closed in the state where a collection box 180 described later is not completely housed in a collection box housing 103 provided below the housing 102 of the loose coin depositing and dispensing apparatus 100, the projection-shaped buffer member 52, such as rubber cushion, provided on the projecting member 50 comes into contact with the collection box 180, whereby the collection box 180 can be pushed into the collection box housing 103. At this time, since the buffer member 52 is formed of rubber cushion or the like, the front face of the collection box 180 is prevented from being damaged.

In the present embodiment, and shown in FIG. 5, a small article placement part 70 on which small articles such as a wrapped coin roll taken out from the wrapped-coin dispensing apparatus 300 are placed is provided on the front face of the outer housing 12 (in particular, the upper door 14), and a raised portion 72 for preventing the small articles such as a wrapped coin roll placed on the small article placement part 70 from falling is provided at the front side of the small article placement part 70. The structure of the small article placement part 70 will be described in detail with reference to FIG. 5 through FIG. 7. As described above, FIG. 5 is a perspective view showing the structure of the upper door 14 of the money changer 10 shown in FIG. 1, FIG. 6 is a vertical cross-sectional view of the upper door 14 shown in FIG. 5, and FIG. 7 is a vertical cross-sectional view showing, in an enlarged manner, the small article placement part 70 of the upper door 14 shown in FIG. 6.

As shown in FIG. 5, the small article placement part 70 is provided over the whole area in the width direction of the outer housing 12 (in particular, the upper door 14), and the small article placement part 70 has a small article placement surface 70a extending along a horizontal plane (refer to FIG. 6 and FIG. 7). In addition, as shown in FIG. 6 and FIG. 7, the raised portion 72 is formed so as to be raised from the small article placement surface 70a at a position on the front side of the small article placement part 70. This raised portion 72 is also provided over the whole area in the width direction of the outer housing 12 (in particular, the upper door 14). Since the small article placement part 70 is provided, the operator can temporarily place a small article, such as a wrapped coin roll taken out from the wrapped-coin dispensing apparatus 300, on the small article placement part 70, in order to assist the operator. Further, since the small article placement part 70 has the raised portion 72, the small article placed on the small article placement surface 70a of the small article placement part 70 is prevented from falling.

Further, as shown in FIG. 8 and FIG. 9, on the upper door 14, at positions on the both sides of the opening 62 through which the operator inserts coins into the coin insertion mechanism 110 (described later) of the loose coin depositing and dispensing apparatus 100, slanted surfaces 80 and 82 are provided which are inclined with respect to the horizontal plane so as to be gradually increased in height with distance from the opening 62. Specifically, as shown in FIG. 8 and FIG. 9, the slanted surface 80 provided to the left of the opening 62 is inclined with respect to the horizontal plane so as to be gradually increased in height with distance from the opening 62 in the leftward direction, and the slanted surface 82 provided to the right of the opening 62 is inclined with respect to the horizontal plane so as to be gradually increased in height with distance from the opening 62 in the rightward direction. Since the slanted surfaces 80 and 82 are provided, coins accidentally dropped from the coin insertion mechanism 110 when the operator inserts coins into the coin insertion mechanism 110 of the loose coin depositing and dispensing apparatus 100 are prevented from moving toward the opening 61 and the opening 63 located at the both sides of the opening 62, and therefore, the dropped coins are prevented from being accidentally input to the depositing unit 252 of the loose banknote depositing and dispensing apparatus 200 and/or the wrapped-coin storage member 382 of the lift unit 380 in the wrapped-coin dispensing apparatus 300.

[Structure of Loose Coin Depositing and Dispensing Apparatus]

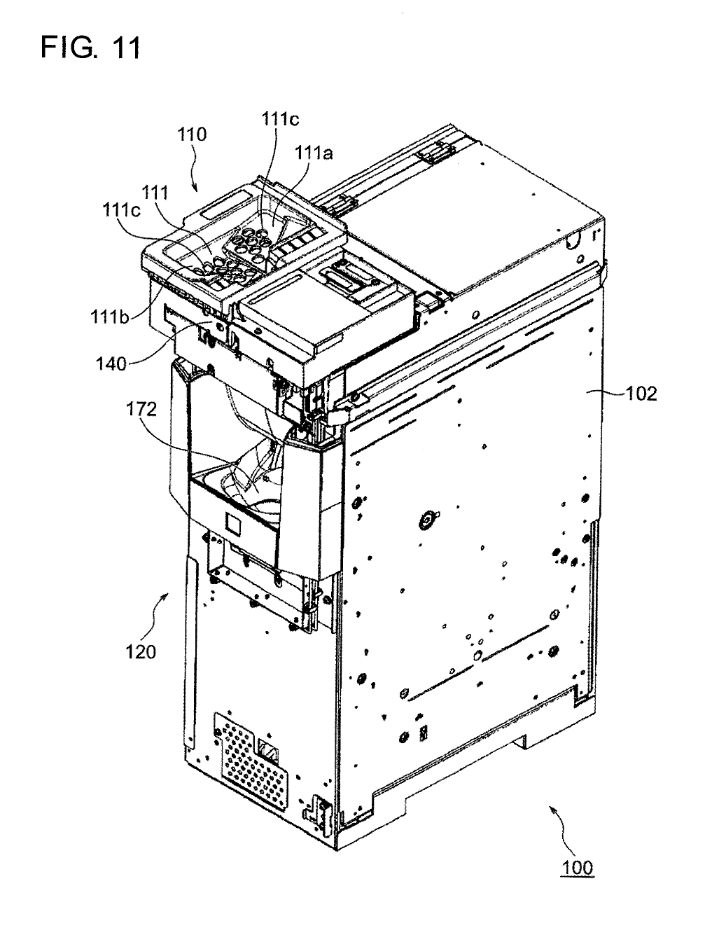

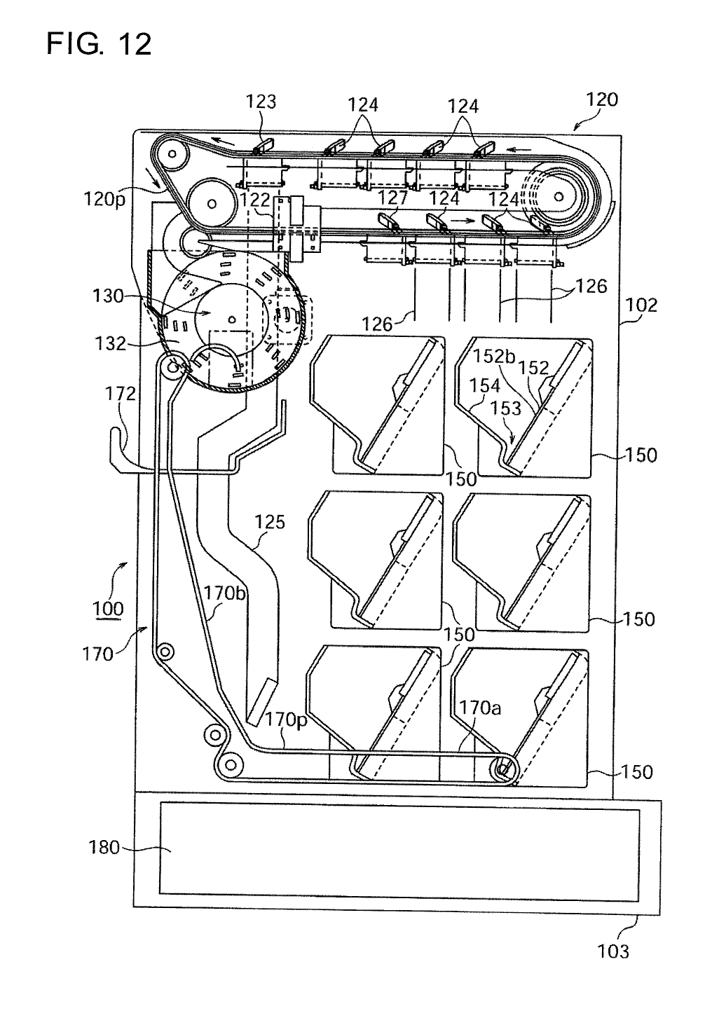

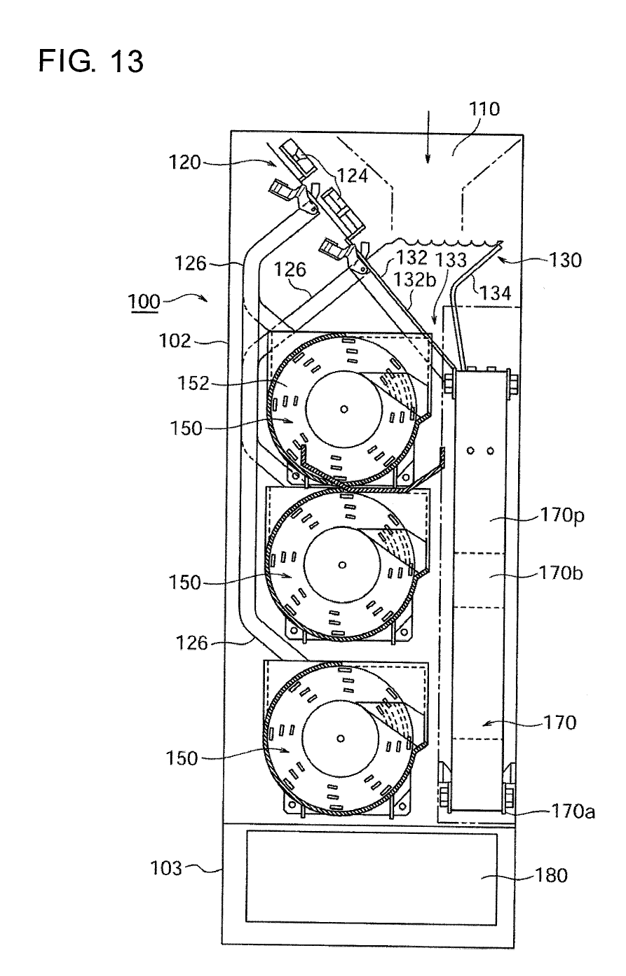

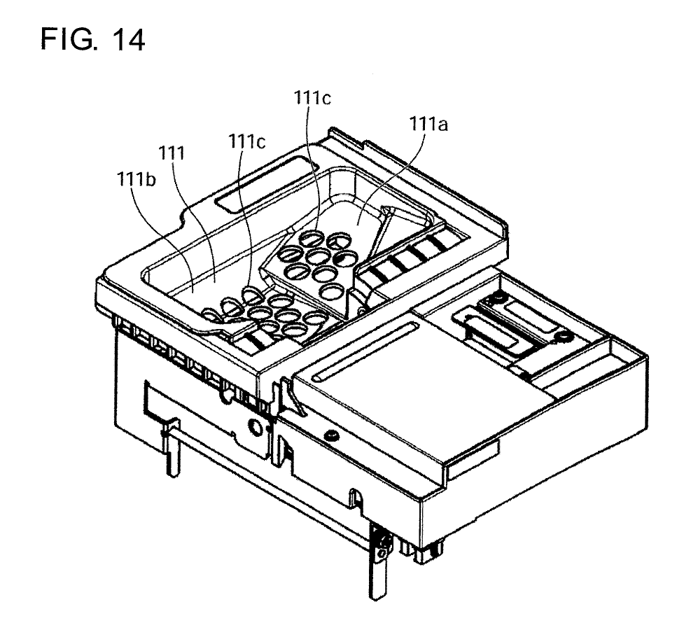

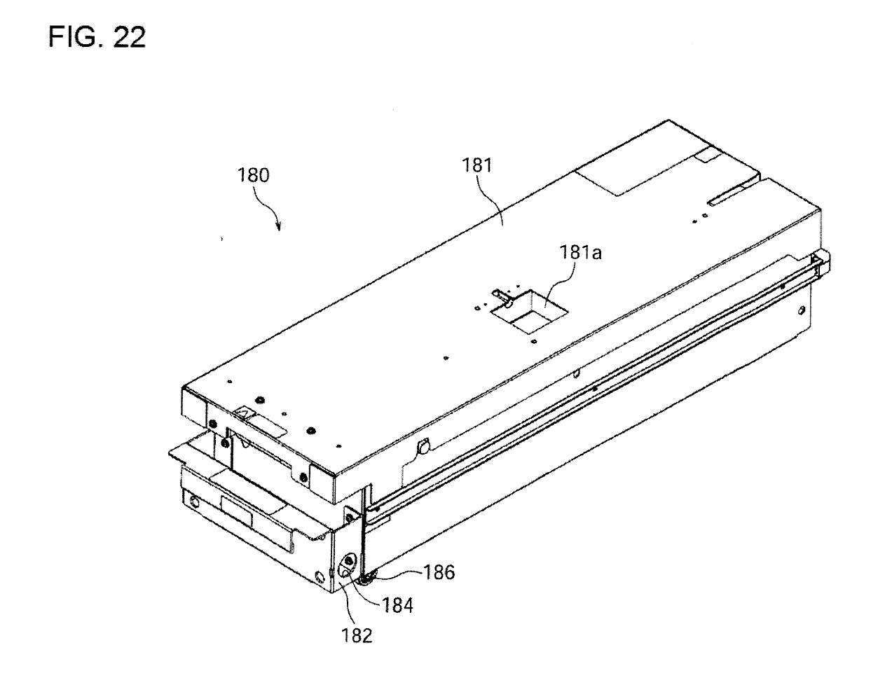

Next, the structure of the loose coin depositing and dispensing apparatus 100 in the money changer 10 according to the present embodiment will be described with reference to FIG. 11 through FIG. 28. FIG. 11 is a perspective view showing the external appearance of the loose coin depositing and dispensing apparatus 100. FIG. 12 is a side view showing the internal structure of the loose coin depositing and dispensing apparatus 100 shown in FIG. 11. FIG. 13 is a front view showing the internal structure of the loose coin depositing and dispensing apparatus 100 shown in FIG. 11. FIGS. 14 to 21 illustrate the structure of the coin insertion mechanism 110 provided in the loose coin depositing and dispensing apparatus 100 shown in FIG. 11. FIGS. 22 to 28 illustrate the structure of the collection box 180 housed in the collection box housing 103 provided adjacent to an external lower portion of the housing 102 of the loose coin depositing and dispensing apparatus 100 shown in FIG. 11.

As shown in FIG. 11 through FIG. 13, the loose coin depositing and dispensing apparatus 100 is provided with: the housing 102 having a substantially rectangular parallelepiped shape; the coin insertion mechanism 110 for inserting coins from the outside to the inside of the housing 102; and an escrowing/feeding mechanism 130 to which coins inserted into the housing 102 by the loose coin depositing and dispensing apparatus 100 are transported and escrowed, and which feeds the escrowed coins one by one. The structure of the coin insertion mechanism 110 will be described later in detail. The escrowing/feeding mechanism 130 includes: a rotary disk 132 which is inclined at a predetermined angle with respect to the vertical direction and is rotated in the inclined position; and a cover member 134 which forms a coin escrow space 133 for escrowing coins therein, between a surface 132b of the rotary disk 132 and the cover member 134.

In an upper portion of the housing 102, a depositing transport unit 120 is provided which transports, one by one, the coins fed from the escrowing/feeding mechanism 130, and the depositing transport unit 120 is provided with a recognition unit 122 which recognizes the denomination, authenticity, fitness, version (old/new), and the like of the coins transported by the depositing transport unit 120.

Further, the depositing transport unit 120 is provided with an endless belt 120p. The endless belt 120p is stretched over a plurality of pulleys. The endless belt 120p is circularly moved in a counter clockwise direction in FIG. 12 by a motor mounted to one pulley. Further, a plurality of projecting members (not shown) are provided on the endless belt 120p at equal intervals, and one coin is hooked by one projecting member, so that the coins are transported on a transport surface one by one.

In the housing 102, a plurality of (for example six, as shown in FIG. 12) storing/feeding mechanisms 150 are provided below the depositing transport unit 120. Coins are transported from the depositing transport unit 120 to the storing/feeding mechanisms 150 through chutes 126 by sorting units 124 provided in the depositing transport unit 120, on the basis of the recognition result of the coins processed by the recognition unit 122. The transported coins are then stored in the storing/feeding mechanism 150. The depositing transport unit 120 is provided with a reject sorting unit 127 which is a sorting unit for reject coins. A coin which is recognized to be a counterfeit coin by the recognition unit 122 is transported to a coin outlet 172 described later through a chute (not shown) for reject coins by the reject sorting unit 127. Further, separately from the coin outlet 172, a reject unit (not shown) for rejecting the reject coins to the outside of the apparatus may be provided in the vicinity of the coin outlet 172. In this case, a coin recognized to be a counterfeit coin by the recognition unit 122 is transported by the reject sorting unit 127, as a reject coin, to the reject unit through the chute for reject coins.

Each storing/feeding mechanism 150 feeds out, one by one, the coins stored in the storing/feeding mechanism 150. More specifically, each storing/feeding mechanism 150 includes: a rotary disk 152 which is inclined at a predetermined angle with respect to the vertical direction and is rotated in the inclined position; and a cover member 154 which forms a coin storage space 153 for storing coins therein, between a surface 152b of the rotary disk 152 and the cover member 154.

The loose coin depositing and dispensing apparatus 100 is provided with the coin outlet 172 through which coins are dispensed to the outside of the housing 102. A dispensing transport unit 170 for transporting the coins fed out from each storing/feeding mechanism 150 to the coin outlet 172 is provided in the housing 102. The dispensing transport unit 170 includes: a first dispensing transport section 170a which is provided below the storing/feeding mechanisms 150 and extends substantially in the horizontal direction; and a second dispensing transport section 170b which transports the coins is transported from the first dispensing transport section 170a to the coin outlet 172. The dispensing transport unit 170 is composed of an endless belt 170p stretched over a plurality of pulleys. The endless belt 170p is circularly moved by a motor mounted to one pulley in both a clockwise direction and a counter clockwise direction in FIG. 12. Further, a plurality of projecting members (not shown) are provided on the endless belt 170p at equal intervals, and one or more coins are hooked by one projecting member, so that the coins are transported one or more at a time by the endless belt 170p.

The collection box 180 used as an overflow coin storage unit is provided below the dispensing transport unit 170. The collection box 180 can be pulled out frontward in the horizontal direction from the collection box housing 103 provided below the housing 102. When the endless belt 170p is circularly moved in the clockwise direction in FIG. 12, coins are transported from the first dispensing transport section 170a of the dispensing transport unit 170 to the collection box 180. After the coins are stored in the collection box 180, the collection box 180 is pulled out frontward from the collection box housing 103, whereby the coins can be collected together with the collection box 180. The structure of the collection box 180 will be described later in detail.

As shown in FIG. 12, the loose coin depositing and dispensing apparatus 100 is provided with an overflow chute 125 for directly transporting coins from the depositing transport unit 120 to the dispensing transport unit 170 without transporting the coins through the storing/feeding mechanisms 150. Further, the depositing transport unit 120 is provided with an overflow sorting unit 123 for sorting coins to be transported to the overflow chute 125, separately from the sorting unit 124 for sorting coins to be transported to the chute 126 corresponding to each storing/feeding mechanism 150. A lower end portion of the overflow chute 125 is located above the endless belt 170p of the dispensing transport unit 170. In this structure, the coins sorted by the overflow sorting unit 123 among the coins transported by the depositing transport unit 120 are transported onto the endless belt 170p of the dispensing transport unit 170 through the overflow chute 125.

Since the overflow chute 125 is provided, when the storing/feeding mechanism 150 corresponding to the denomination of a coin recognized by the recognition unit 122 is full of coins, the coin of the denomination for which the storing/feeding mechanism 150 is full of coins is sorted by the overflow sorting unit 123 to be transported onto the endless belt 170p of the dispensing transport unit 170 by the overflow chute 125, without suspending transport of coins by the depositing transport unit 120. Then, the coin transported onto the endless belt 170p of the dispensing transport unit 170 by the overflow chute 125 is transported to the collection box 180 by the endless belt 170p. In the loose coin depositing and dispensing apparatus 100 having the above structure, even when the storing/feeding mechanism 150 corresponding to the denomination of a coin recognized by the recognition unit 122 is full of coins, this coin can be transported to the collection box 180 without suspending transport of coins by the depositing transport unit 120, whereby reduction in the coin handing speed can be avoided.

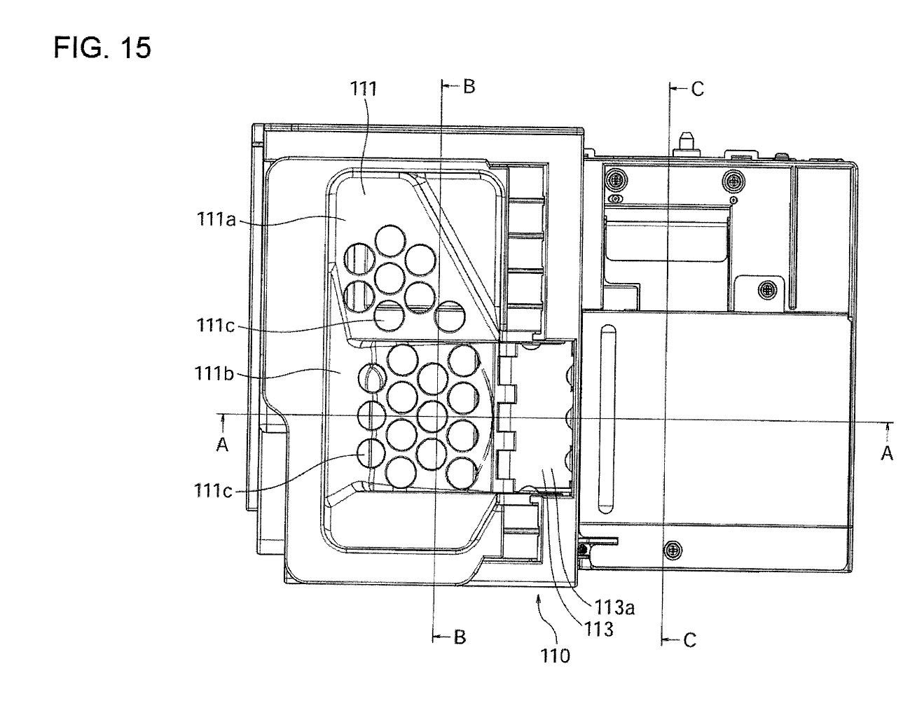

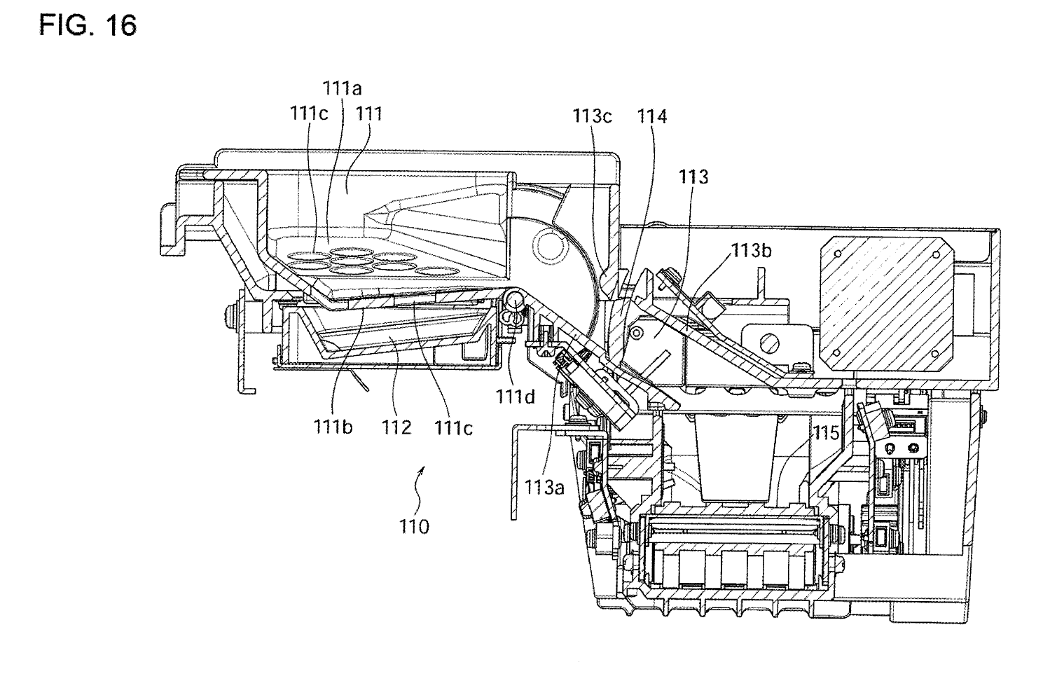

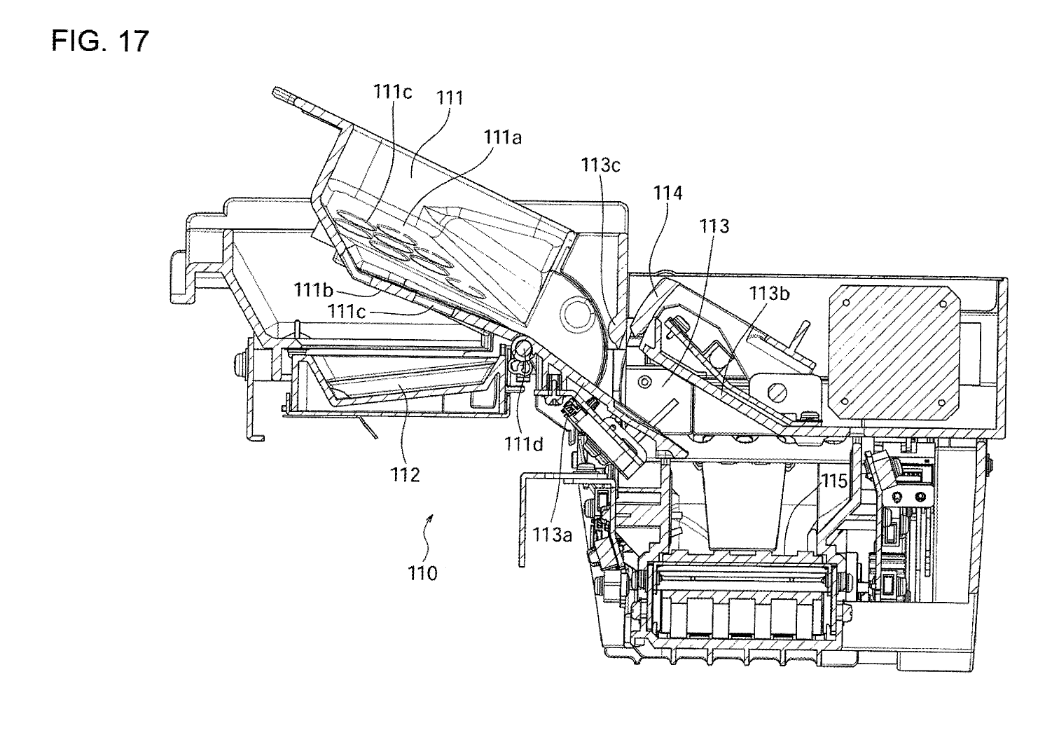

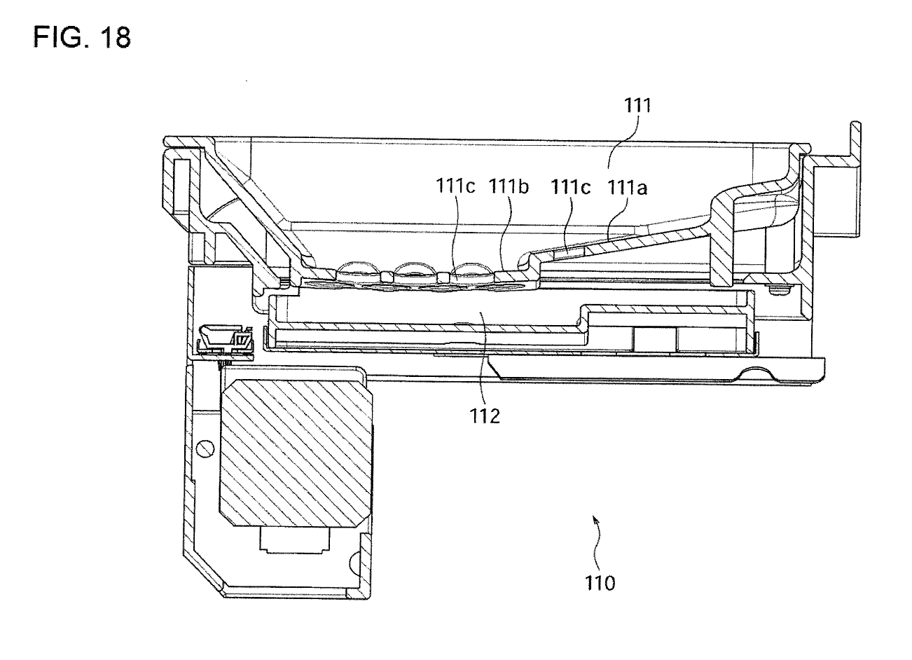

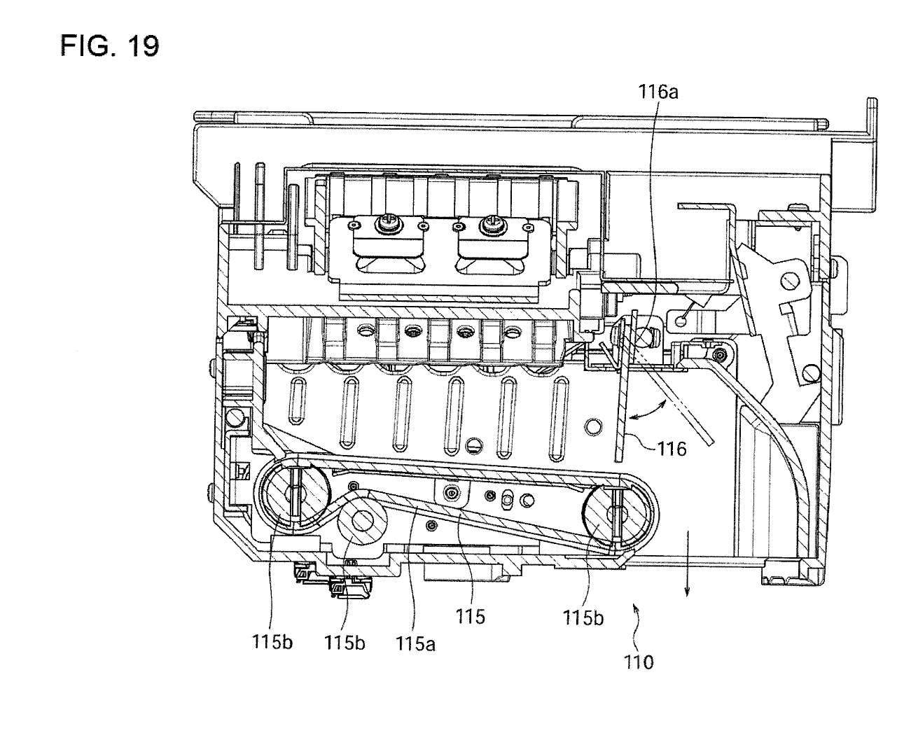

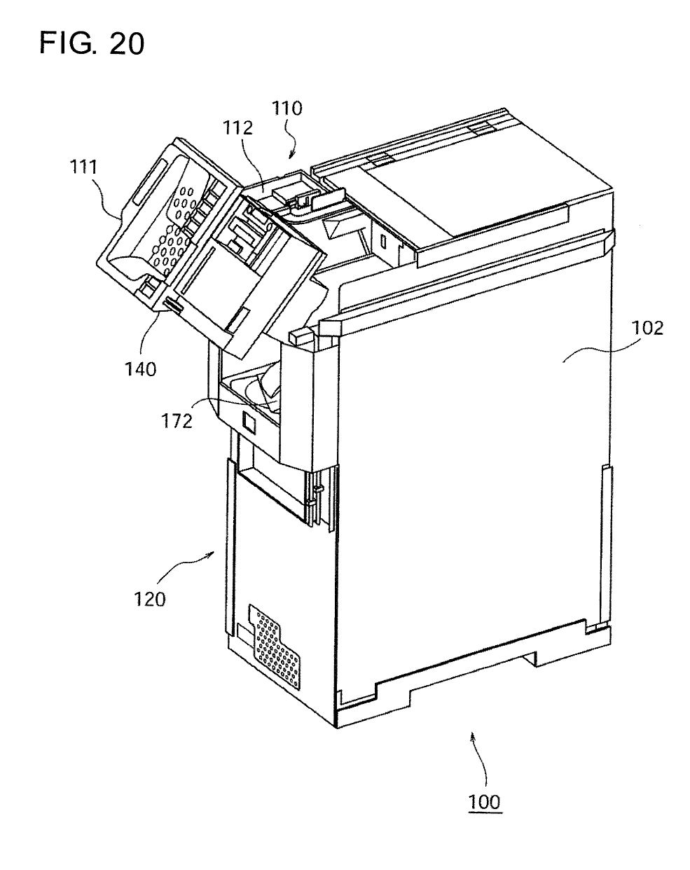

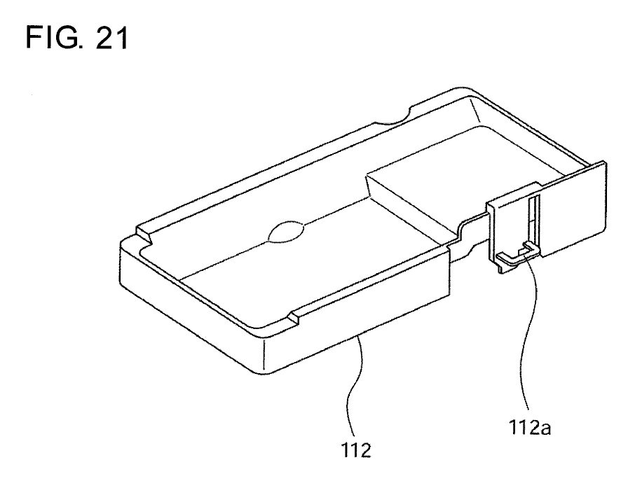

Next, the structure of the coin insertion mechanism 110 in the loose coin depositing and dispensing apparatus 100 will be described in detail with reference to FIG. 14 through FIG. 21. FIG. 14 is a perspective view showing the structure of the coin insertion mechanism 110. FIG. 15 is a top view showing the structure of the coin insertion mechanism 110 shown in FIG. 14. Each of FIG. 16 and FIG. 17 is a vertical cross-sectional view of the coin insertion mechanism 110 shown in FIG. 15, taken along the direction of arrows A-A in FIG. 15. FIG. 18 is a vertical cross-sectional view of the coin insertion mechanism 110 shown in FIG. 15, taken along the direction of arrows B-B in FIG. 15. FIG. 19 is a vertical cross-sectional view of the coin insertion mechanism 110 shown in FIG. 15, taken along the direction of arrows C-C in FIG. 15. FIG. 20 is a perspective view showing the state where a coin receiving unit 140 is opened upward in the coin insertion mechanism 110 shown in FIG. 15. FIG. 21 is a perspective view showing the structure of a foreign material receiving unit 112 provided in the coin insertion mechanism 110 shown in FIG. 15.

As shown in FIG. 14 through FIG. 19, the coin insertion mechanism 110 for inserting coins from the outside to the inside of the housing 102 of the loose coin depositing and dispensing apparatus 100 includes: a coin receiving section 111 which receives coins inserted into a coin inlet provided at an upper face of the housing 102, and removes a foreign material such as a clip mixed with the received coins; and a coin feeding unit 115 which feeds the coins transported from the coin receiving section 111 to the inside of the housing 102 of the loose coin depositing and dispensing apparatus 100, and transports the coins to the escrowing/feeding mechanism 130. In addition, a chute 113 which forms a coin transport path for transporting the coins received by the coin receiving section 111 to the coin feeding unit 115 is provided between the coin receiving section 111 and the coin feeding unit 115. As shown in FIG. 20, the coin receiving section 111 and the chute 113 are provided in the coin receiving unit 140 which can be opened upward from the upper portion of the housing 102 of the loose coin depositing and dispensing apparatus 100, and the operator can access the coin feeding unit 115 by opening the coin receiving unit 140 upward. Therefore, when, for example, failure in feeding coins occurs in the coin feeding unit 115, the operator can remove coins jammed in the coin feeding unit 115 by opening the coin receiving unit 140 upward as shown in FIG. 20.

The coin receiving section 111 is composed of a tray including a first tray portion 111a and a second tray portion 111b, and the coins inserted into the coin inlet are received by this tray. As shown in FIG. 15 etc., the second tray portion 111b is provided adjacent to the chute 113. The first tray portion 111a is inclined with respect to the horizontal plane so that an upper face thereof extends obliquely downward toward the second tray portion 111b, and the first tray portion 111a is not adjacent to the chute 113. Therefore, the coins received by the first tray portion 111a are first transported to the second tray portion 111b and then transported from the second tray portion 111b to the chute 113.

As shown in FIG. 16 and FIG. 17, the first tray portion 111a and the second tray portion 111b in the coin receiving section 111 are integrally turnable about a shaft 111d extending in the horizontal direction. More specifically, the first tray portion 111a and the second tray portion 111b are integrally turnable between a coin receiving position at which the coins inserted into the coin inlet are received as shown in FIG. 16 and a coin transport position at which the coins received by the first tray portion 111a and the second tray portion 111b are transported to the chute 113 as shown in FIG. 17. When no force is applied to the first tray portion 111a and the second tray portion 111b, the first tray portion 111a and the second tray portion 111b are at the coin receiving position shown in FIG. 16 by their own weights. After the coins inserted into the coin inlet are received by the first tray portion 111a and the second tray portion 111b, if the operator manually lifts the first tray portion 111a and the second tray portion 111b integrally so that the first tray portion 111a and the second tray portion 111b are turned about the shaft 111d to be moved to the coin transport position shown in FIG. 17, the coins received by the first tray portion 111a and the second tray portion 111b are transported to the chute 113 by their own weights. In the present embodiment, the coin insertion mechanism 110 is not limited to the above structure in which the first tray portion 111a and the second tray portion 111b are manually turned about the shaft 111d. In another structure according to a modification, the coin insertion mechanism 110 may be provided with a drive motor (not shown) for turning the first tray portion 111a and the second tray portion 111b about the shaft 111d. In still another structure, the operator may manually transport the coins received by the first tray portion 111a and the second tray portion 111b to the chute 113.

In the present embodiment, a step is formed between the first tray portion 111a and the second tray portion 111b so that an edge portion, on the second tray portion 111b side, of the first tray portion 111a is slightly higher in height than an edge portion, on the first tray portion 111a side, of the second tray portion 111b. Thus, when the first tray portion 111a and the second tray portion 111b are moved to the coin transport position shown in FIG. 17, firstly, the coins received by the second tray portion 111b are transported to the chute 113 and thereafter the coins received by the first tray portion 111a are transported to the chute 113 through the second tray portion 111b. This structure avoids a situation that the coins received by the first tray portion 111a and the second tray portion 111b are transported to the chute 113 at one time and cause a trouble such as a coin jam.

Further, in the present embodiment, as shown in FIG. 16, the upper face of the second tray portion 111b is inclined with respect to the horizontal plane so that the height thereof is gradually reduced with distance from the shaft 111d, when the second tray portion 111b is in the coin receiving position. Thus, even when the operator puts a foreign material such as a clip together with coins on the first tray portion 111a or the second tray portion 111b, transport of the foreign material from the second tray portion 111b to the chute 113 is prevented as long as the first tray portion 111a and the second tray portion 111b are in the coin receiving position (in other words, unless the operator manually lifts the first tray portion 111a and the second tray portion 111b integrally to turn them about the shaft 111d), and consequently, transport of the foreign material to the escrowing/feeding mechanism 130 is prevented.

Further, as shown in FIG. 15 etc., each of the first tray portion 111a and the second tray portion 111b is provided with a plurality of holes 111c for eliminating foreign materials. The size of each hole 111c is smaller than the size of coins to be handed by the loose coin depositing and dispensing apparatus 100. As shown in FIG. 16 and FIG. 17, the foreign material receiving unit 112 for receiving foreign materials that have passed through the holes 111c is provided below the first tray portion 111a and the second tray portion 111b.

In the present embodiment, the foreign material receiving unit 112 is detachable from the coin insertion mechanism 110. The structure of the foreign material receiving unit 112 is shown in FIG. 21 in detail. The foreign material receiving unit 112 is formed of, for example, plastic or the like. As shown in FIG. 21, a projection 112a for mounting the foreign material receiving unit 112 to the coin insertion mechanism 110 is provided on one of side faces of the foreign material receiving unit 112. Although not shown in FIG. 21, a projection for mounting the foreign material receiving unit 112 to the coin insertion mechanism 110 is also provided on a side face, of the foreign material receiving unit 112, opposite to the side face on which the projection 112a is provided. In addition, the position of the foreign material receiving unit 112 is not changed even when the coin receiving unit 140 is opened upward as shown in FIG. 20. The foreign material receiving unit 112 can be detached from the coin insertion mechanism 110 in the state where the coin receiving unit 140 is opened upward. Specifically, the projection 112a is detached from the coin insertion mechanism 110 by pressing the side face, of the foreign material receiving unit 112, on which the projection 112a is provided. Then, the side face, of the foreign material receiving unit 112, on which the projection 112a is provided is lifted upward and slightly turned, and the foreign material receiving unit 112 is slightly displaced rightward, whereby the projection (not shown) provided on the side face, of the foreign material receiving unit 112, opposite to the side face on which the projection 112a is provided is detached from the coin insertion mechanism 110. Thereafter, the foreign material receiving unit 112 is lifted further upward to detach the foreign material receiving unit 112 from the coin insertion mechanism 110.

As shown in FIG. 16 and FIG. 17, the chute 113 includes a first guide portion 113a forming a bottom face of the coin transport path, and a second guide portion 113b forming an upper face of the coin transport path. The coins transported from the coin receiving section 111 to the chute 113 are conveyed so as to pass through an area between the first guide portion 113a and the second guide portion 113b to be transported to the coin feeding unit 115. As shown in FIG. 16 and FIG. 17, the first guide portion 113a forming the bottom face of the coin transport path is inclined with respect to the horizontal plane so as to extend obliquely downward toward the coin feeding unit 115 from the coin receiving section 111. Therefore, the coins transported from the coin receiving section 111 to the chute 113 are transported to the coin feeding unit 115 by their own weights. Further, as shown in FIG. 16 and FIG. 17, in the vicinity of the second guide portion 113b, a wrapped-coin transport regulating unit 113c is provided so as to be spaced apart from the first guide portion 113a. The distance between the first guide portion 113a and the wrapped-coin transport regulating unit 113c is smaller than the diameter of coins to be handled by the loose coin depositing and dispensing apparatus 100, and the coins transported from the coin receiving section 111 to the chute 113 move toward the second guide portion 113b while sliding on the first guide portion 113a by their own weights, not in a standing state but in a laterally lying state. Since the wrapped-coin transport regulating unit 113c is provided, even when the operator mistakenly inserts a wrapped coin roll into the coin inlet of the loose coin depositing and dispensing apparatus 100, the wrapped coin roll does not pass through the space between the first guide portion 113a and the wrapped-coin transport regulating unit 113c but is caught by the wrapped-coin transport regulating unit 113c, thereby preventing the wrapped coin roll from being transported to the coin feeding unit 115 described later. When the wrapped coin roll is caught by the wrapped-coin transport regulating unit 113c, the operator can take out the wrapped coin roll by putting his/her hand into the coin inlet.

As shown in FIG. 16 and FIG. 17, a shutter 114 for selectively blocking transport of coins from the coin receiving section 111 to the coin feeding unit 115 is openably and closably provided on the chute 113. This shutter 114 is movable between a closed position at which the shutter 114 is located between the first guide portion 113a and the second guide portion 113b of the chute 113 and closes the coin transport path as shown in FIG. 16, and an opened position at which the shutter 114 is retracted from the coin transport path to be located above the second guide portion 113b as shown in FIG. 17. When the shutter 114 is in the closing position shown in FIG. 16, the coins transported from the coin receiving section 111 to the chute 113 are blocked by the shutter 114 and are not transported to the coin feeding unit 115. In the vicinity of the shutter 114 in the chute 113, a coin passage detecting sensor (not shown) for detecting passage of coins is provided.

As shown in FIG. 19, the coin feeding unit 115 includes a transport belt 115a stretched over a plurality of pulleys 115b, and the coins transported from the chute 113 to the coin feeding unit 115 are received on the transport belt 115a. A drive motor (not shown) is connected to one of the plurality of pulleys 115b, and the pulley 115b connected to the drive motor is driven to rotate by the drive motor, whereby the transport belt 115a can be circularly moved in both the clockwise direction and the counter clockwise direction in FIG. 19. When the transport belt 115a is circularly moved in the clockwise direction in FIG. 19, the coins transported from the chute 113 to the coin feeding unit 115 are transported rightward in FIG. 19 on the transport belt 115a, and drop off from an end portion of the transport belt 115a as indicated by an arrow in FIG. 19 to be transported to the escrowing/feeding mechanism 130.

Further, as shown in FIG. 19, a coin transport amount restricting member 116 for restricting the amount of coins to be transported from the coin feeding unit 115 to the escrowing/feeding mechanism 130 is provided above an end portion, of the transport belt 115a, on the escrowing/feeding mechanism 130 side (i.e., on the right side in FIG. 19). The coin transport amount restricting member 116 is formed of a plate-shaped elastic body (specifically, a material having flexibility) such as urethane rubber, and a lower end portion of the coin transport amount restricting member 116 is slightly separated upward from an upper face of the transport belt 115a. Since the coin transport amount restricting member 116 is provided above the transport belt 115a, it is possible to avoid a situation that a large number of coins present on the transport belt 115a drop off from the end portion of the transport belt 115a at one time like an avalanche and are transported to the escrowing/feeding mechanism 130. Further, the coin transport amount restricting member 116 is swingable about a shaft 116a, between a position indicated by a solid line in FIG. 19 and a position indicated by a two-dot chain line in FIG. 19. Thus, when coins received on the transport belt 115a are transported to the escrowing/feeding mechanism 130 by the transport belt 115a, even if some of the coins are caught between a side wall of the coin feeding unit 115 and the coin transport amount restricting member 116 and do not drop from the transport belt 115a, the caught coins can be separated from the coin transport amount restricting member 116 to be received on the transport belt 115a or can be dropped off toward the escrowing/feeding mechanism 130 side, by causing the coin transport amount restricting member 116 to swing.

Next, the operation of the coin insertion mechanism 110 having the above structure will be described. When an operator inputs, to the operation/display unit 40, an instruction to start a loose-coin depositing process, the shutter 114 provided on the chute 113 is opened. In addition, the transport belt 115a of the coin feeding unit 115 is circularly moved in the clockwise direction in FIG. 19. When the operator inserts coins into the coin inlet provided at the upper face of the housing 102, the coins are received by the first tray portion 111a and/or the second tray portion 111b of the coin receiving section 111. At this time, foreign materials mixed with the coins are transported to the foreign material receiving unit 112 through the holes 111c for eliminating foreign materials. Thereafter, when the operator manually lifts up the first tray portion 111a and the second tray portion 111b integrally so that the first tray portion 111a and the second tray portion 111b are turned about the shaft 111d and moved to the coin transport position as shown in FIG. 17, the coins received by the first tray portion 111a and/or the second tray portion 111b are transported to the chute 113 by their own weights and then transported from the chute 113 to the coin feeding unit 115. The coins transported to the coin feeding unit 115 are received on the transport belt 115a. Then, the transport belt 115a is circularly moved in the clockwise direction in FIG. 19, whereby the coins on the transport belt 115a drop off from the end portion of the transport belt 115a as indicated by an arrow in FIG. 19 to be transported to the escrowing/feeding mechanism 130.

When a predetermined period of time has passed after the coin passage detecting sensor (not shown) provided in the chute 113 no longer detects passage of coins, it is determined that the coins received by the first tray portion 111a and/or the second tray portion 111b of the coin receiving section 111 have been transported to the escrowing/feeding mechanism 130. In this case, the shutter 114 is closed to block transport of coins from the coin receiving section 111 to the coin feeding unit 115. Further, at this time, the transport belt 115a is circularly moved for a predetermined period of time in a direction opposite to the direction of transporting the coins to the escrowing/feeding mechanism 130 (i.e., counter clockwise direction in FIG. 19), and the coin transport amount restricting member 116 swings so that the coins in contact with the coin transport amount restricting member 116 are separated from the coin transport amount restricting member 116. Thus, the coins caught between the side wall of the coin feeding unit 115 and the coin transport amount restricting member 116 can be separated from the coin transport amount restricting member 116 and received on the transport belt 115a. Then, the transport belt 115a is circularly moved for a predetermined period of time in the direction opposite to the coin transporting direction toward the escrowing/feeding mechanism 130, and thereafter is again circularly moved in the coin transporting direction toward the escrowing/feeding mechanism 130 (clockwise direction in FIG. 19). Thus, the coins separated from the coin transport amount restricting member 116 and received on the transport belt 115a are transported to the escrowing/feeding mechanism 130.

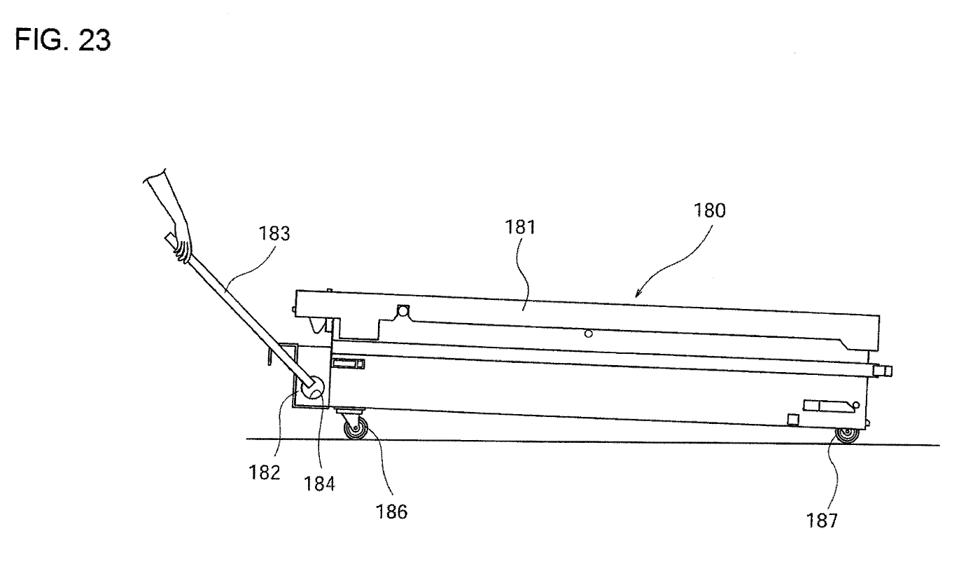

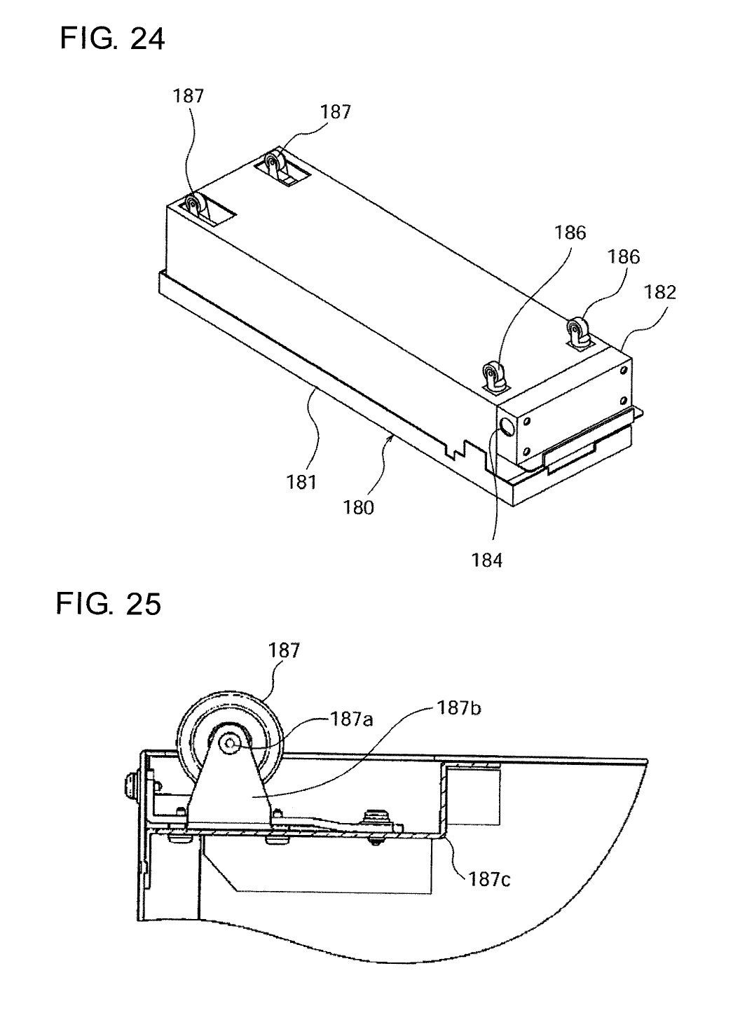

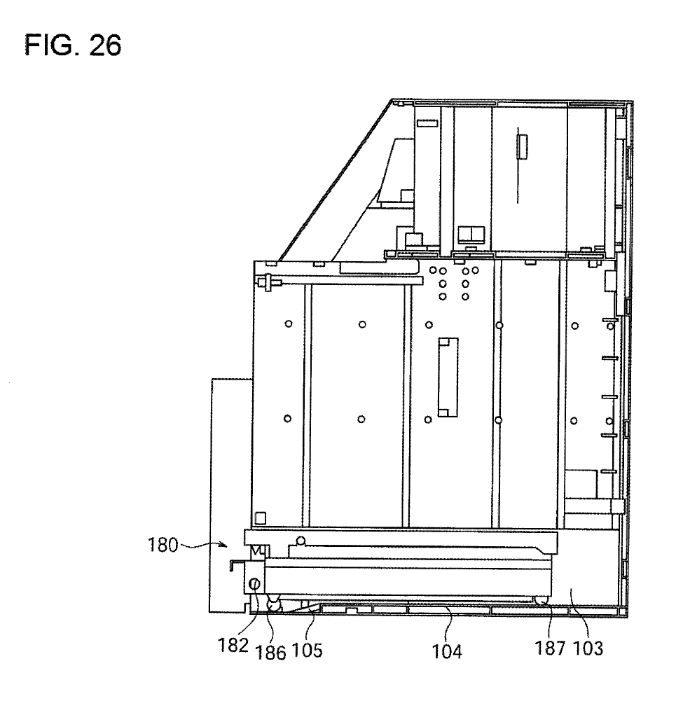

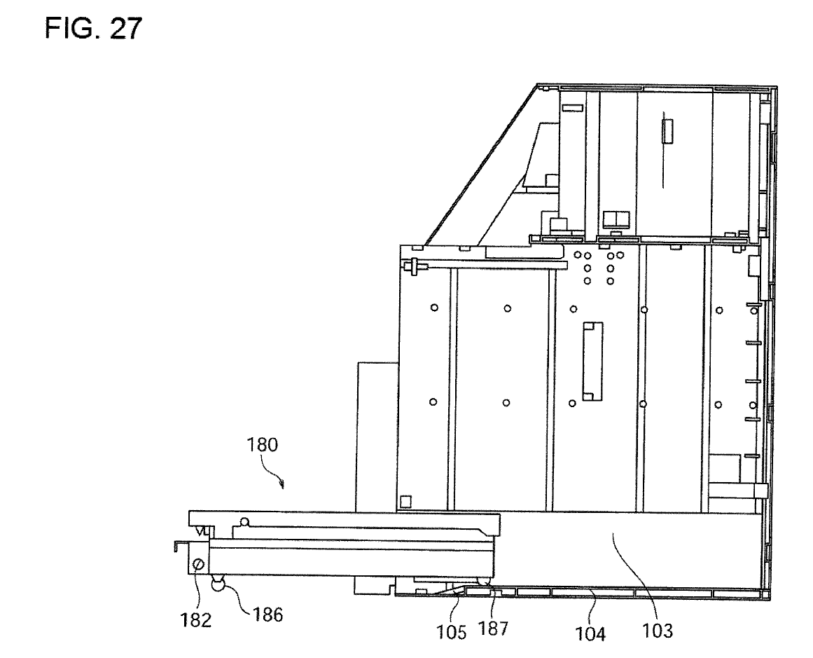

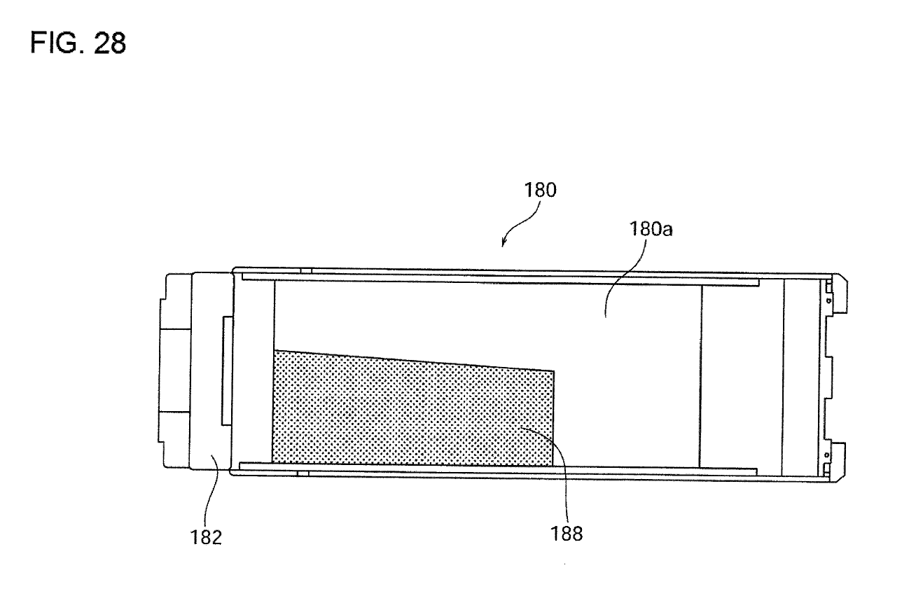

Next, the structure of the collection box 180 will be described in detail with reference to FIG. 22 through FIG. 28. FIG. 22 is a perspective view showing the structure of the collection box 180. FIG. 23 is a side view showing the state where a cord 183 is hooked on the collection box 180 shown in FIG. 22, and the cord 183 is pulled to convey the collection box 180. FIG. 24 is a perspective view showing the structure, on a bottom face side, of the collection box 180 shown in FIG. 22. FIG. 25 is a vertical cross-sectional view showing the structure of a rear wheel 187 provided on the collection box 180 shown in FIG. 24. FIG. 26 is a side view schematically showing the state where the collection box 180 shown in FIG. 22 is housed inside the collection box housing 103 disposed below the housing 102 of the loose coin depositing and dispensing apparatus 100. FIG. 27 is a side view schematically showing the state where the collection box 180 shown in FIG. 22 is in the middle of being pulled out from the inside of the collection box housing 103. FIG. 28 is a top view showing the internal structure of the collection box 180 shown in FIG. 22 as seen from above, with an upper lid 181 being opened.

First, the overall structure of the collection box 180 will be described with reference to FIG. 22 etc. As shown in FIG. 22 etc., the collection box 180 has a substantially rectangular parallelepiped shape. At the bottom of the collection box 180, a pair of left and right front wheels 186 and a pair of left and right rear wheels 187 are provided at the front and the rear, respectively. In addition, the collection box 180 is provided with the upper lid 181. The operator can take out the coins stored in the collection box 180 by opening the upper lid 181. The upper lid 181 is provided with an opening 181a through which the coins transported from the endless belt 170p of the dispensing transport unit 170 pass, and the opening 181a is provided with a shutter for closing the opening 181a. When the collection box 180 is pulled out from the collection box housing 103, the opening 181a is closed by the shutter. On the other hand, when the collection box 180 is housed into the collection box housing 103, the shutter automatically opens the opening 181a.

The collection box housing 103 for housing the collection box 180 is provided below the housing 102 of the loose coin depositing and dispensing apparatus 100 (refer to FIG. 26 and FIG. 27). This collection box housing 103 is attached to a lower face of the housing 102 of the loose coin depositing and dispensing apparatus 100. Regardless of whether the collection box 180 is housed in the collection box housing 103 or is pulled out from the collection box housing 103, the collection box housing 103 can be pulled out frontward, integrally with the housing 102 of the loose coin depositing and dispensing apparatus 100, from the inside of the outer housing 12 of the money changer 10.

In the present embodiment, as shown in FIG. 23, when the cord 183 is hooked on a front-side end portion of the collection box 180 and pulled, the collection box 180 can be pulled out from the collection box housing 103 and/or the collection box 180 pulled out from the collection box housing 103 can be conveyed. More specifically, as shown in FIG. 22 and FIG. 23, the collection box 180 is provided with a cord housing 182 for housing the cord 183. The cord housing 182 is provided at a position on the front side in the depth direction of the housing 102 when the collection box 180 is housed in the collection box housing 103. Further, the cord housing 182 is provided with through-holes 184 on which the cord 183 taken out from the cord housing 182 is hooked. The through-holes 184 are formed at both side faces of the cord housing 182 when the collection box housing 103 is viewed from the front.

As described above, in the present embodiment, the operator pulls out the collection box 180 from the collection box housing 103 and/or conveys the collection box 180 pulled out from the collection box housing 103, by hooking the cord 183 on the front-side end portion of the collection box 180 and pulling the cord 183. Therefore, when the operator pulls out, from the collection box housing 103, or conveys the heavy collection box 180 in which a large number of coins are stored, the burden on the operator can be reduced as compared to the case where the operator conveys the collection box 180 with his/her hands holding the collection box 180.

Further, in the present embodiment, the front wheels 186 and the rear wheels 187 have different heights. Specifically, as shown in FIG. 24 and FIG. 25, there is an opening in the vicinity of each rear wheel 187 at the bottom face of the collection box 180, and a half of the rear wheel 187 is in the opening so as to be lower in height than the front wheel 186. More specifically, each rear wheel 187 is supported by a wheel support member 187b so as to rotate about a shaft 187a, and the wheel support member 187b is mounted on a metal plate 187c provided inside the collection box 180. Thus, the rear wheel 187 is half inserted in the opening formed at the bottom face of the collection box 180, and therefore is lower in height than the front wheel 186.

In the present embodiment, as shown in FIG. 26 and FIG. 27, the bottom face of the collection box housing 103 is substantially flush with a floor surface on which the money changer 10 is installed. Thus, the operator can smoothly perform the action of pulling out the collection box 180 from the collection box housing 103 and the action of housing the collection box 180 in the collection box housing 103.

In the present embodiment, since the collection box housing 103 is provided below the housing 102 of the loose coin depositing and dispensing apparatus 100, even when the lower door 16 of the money changer 10 is opened but the upper door 14 thereof is not opened as shown in FIG. 2, the collection box 180 can be pulled out from the collection box housing 103. Thus, the operator can pull out the collection box 180 from the collection box housing 103 without opening the upper door 14, whereby the work burden on the operator can be reduced.

The height of the bottom face of the collection box housing 103 varies depending on the position in the depth direction (rightward direction in FIG. 26 and FIG. 27) of the housing 102. Specifically, the height of the collection box housing 103 is set so that the internal bottom face of the collection box 180 is in the horizontal state when the collection box 180 is housed in the collection box housing 103. More specifically, the collection box housing 103 includes: a pedestal portion 104 on which the rear wheels 187 of the collection box 180 ride when the collection box 180 is housed in the collection box housing 103; and an inclined portion 105 which has a slanted surface inclined with respect to the horizontal plane, and connects the bottom face of the housing 102 to the pedestal portion 104. Since the rear wheels 187 of the collection box 180 ride on the pedestal portion 104 when the collection box 180 is housed in the collection box housing 103, the internal bottom face of the collection box 180 is in the horizontal state although the height of the front wheels 186 is different from the height of the rear wheels 187 as shown in FIG. 26. On the other hand, when the collection box 180 is pulled out from the collection box housing 103, the rear wheels 187 of the collection box 180 run on the pedestal portion 104 and come into contact with the floor surface through the inclined portion 105. Thus, in the present embodiment, since the height of the collection box housing 103 is set so that the internal bottom face of the collection box 180 is in the horizontal state when the collection box 180 is housed in the collection box housing 103, the coins transported from the endless belt 170p of the dispensing transport unit 170 to the collection box 180 can be uniformly stacked over the entirety of the internal area of the collection box 180.

As shown in FIG. 28, a sheet 188 formed of an elastic material such as rubber is spread on an inner bottom face 180a of the collection box 180. The sheet 188 provided on the inner bottom face 180a of the collection box 180 can reduce impact sound that is generated when the coins drop from the endless belt 170p of the dispensing transport unit 170 and hit the inner bottom face of the collection box 180, thereby providing noise prevention.

[Structure of Loose Banknote Depositing and Dispensing Apparatus]

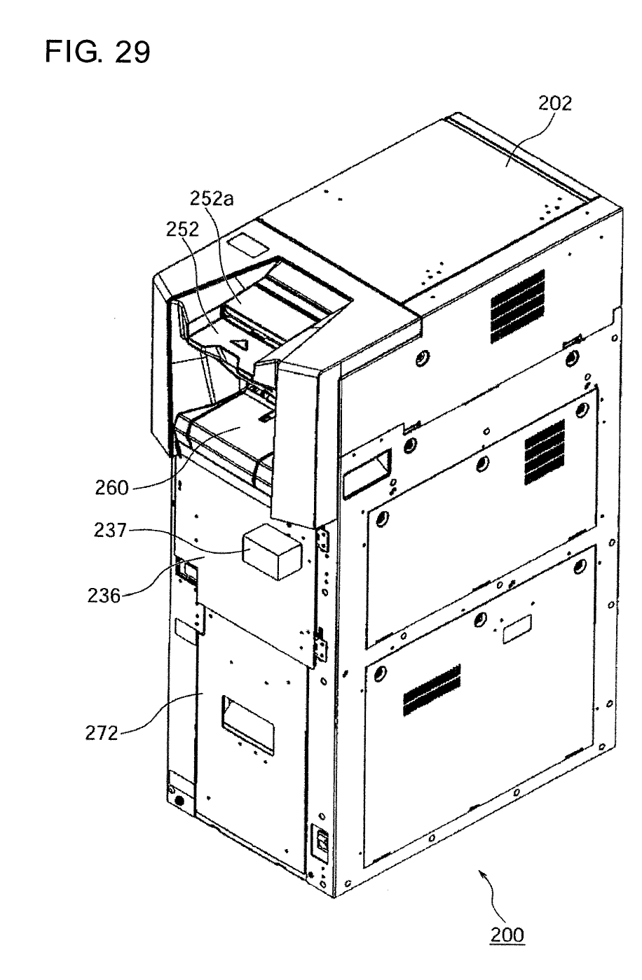

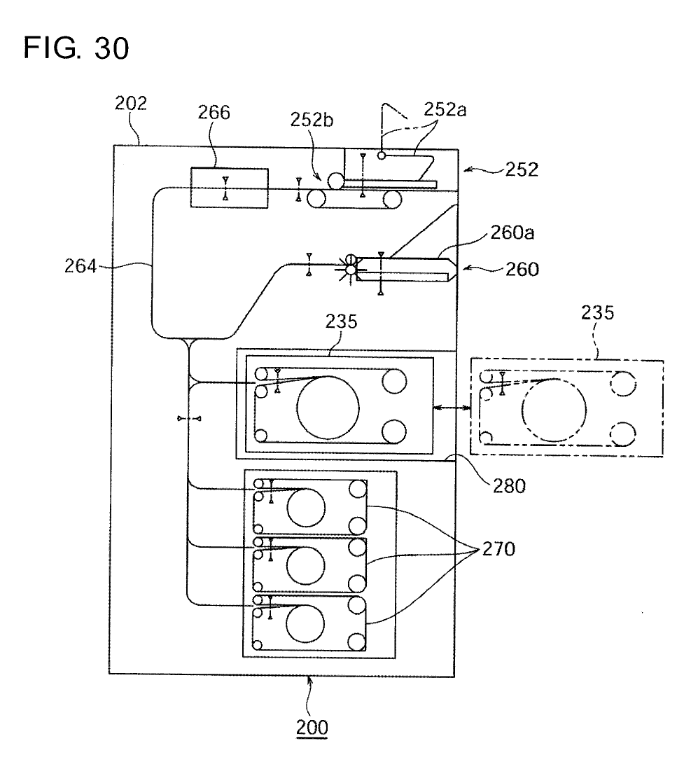

Next, the structure of the loose banknote depositing and dispensing apparatus 200 in the money changer 10 according to the present embodiment will be described with reference to FIG. 29 and FIG. 30. FIG. 29 is a perspective view showing an external appearance of the loose banknote depositing and dispensing apparatus 200. FIG. 30 is a side view showing the internal structure of the loose banknote depositing and dispensing apparatus 200 shown in FIG. 29.

As shown in FIG. 29, the loose banknote depositing and dispensing apparatus 200 includes a housing 202 having a substantially rectangular parallelepiped shape, and a depositing unit 252 and a dispensing unit 260 are provided at a front face (right side face in FIG. 30) of the housing 202. The depositing unit 252 is provided with a depositing unit cover 252a and a banknote feeding mechanism 252b. When an operator deposits a small number of banknotes into the loose banknote depositing and dispensing apparatus 200, the banknotes are set in the depositing unit 252 in a stacked state, and then the banknotes are fed by the banknote feeding mechanism 252b into the housing 202 one by one. When the operator deposits a large number of banknotes, the large number of banknotes are set in the depositing unit 252 with the cover 252a being opened upward, and then the banknotes are fed by the banknote feeding mechanism 252b into the housing 202 one by one. Further, a transport unit 264 is provided in the housing 202 of the loose banknote depositing and dispensing apparatus 200, and the transport unit 264 transports, one by one, the banknotes fed into the housing 202 by the banknote feeding mechanism 252b. The transport unit 264 is provided with a recognition unit 266, and the recognition unit 266 recognizes the denomination, authenticity, fitness, version (old/new), and the like of each of the banknotes fed into the housing 202 by the banknote feeding mechanism 252b.

Further, a plurality of storing/feeding units 270 are provided in the housing 202, and each storing/feeding unit 270 is connected to the transport unit 264. The respective storing/feeding units 270 store banknotes by denominations. More specifically, the banknotes fed into the housing 202 by the banknote feeding mechanism 252b are transported by denominations by the transport unit 264 to the storing/feeding units 270 on the basis of the recognition result by the recognition unit 266. Each storing/feeding unit 270 is able to feed, one by one, the banknotes stored therein to the transport unit 264. Each storing/feeding unit 270 may be a tape-reel type storing/feeding unit which reels up a pair of tapes, between which banknotes are sandwiched one by one, together with the banknotes as shown in FIG. 30, or may be a stacker type storing/feeding unit (not shown) which stores banknotes in a stacked manner.

As shown in FIG. 30, in the housing 202, a cassette attaching unit 280 to which a cash transport cassette 235 is detachably attached is provided. The cassette attaching unit 280 is connected to the transport unit 264. When the cash transport cassette 235 is attached to the cassette attaching unit 280, banknotes can be transported from the transport unit 264 to the cash transport cassette 235, and banknotes stored in the cash transport cassette 235 can be fed to the transport unit 264. When the cash transport cassette 235 is pulled outward from the housing 202, the banknotes can be collected together with the cash transport cassette 235. In FIG. 30, a tape-reel type storing/feeding unit which reels up a pair of tapes, between which banknotes are sandwiched one by one, together with the banknotes, is provided in the cash transport cassette 235. However, the structure of the cash transport cassette 235 is not limited thereto. In an alternative structure of the cash transport cassette 235, a stacker type storing/feeding unit which stores banknotes in a stacked manner may be provided in the cash transport cassette 235.

The dispensing unit 260 is provided with a dispensing unit shutter 260a. After banknotes are transported to the dispensing unit 260, the operator can take out the banknotes stacked in the dispensing unit 260 by opening the dispensing unit shutter 260a. Alternatively, the shutter 260a may be automatically opened after dispensing is completed.

As shown in FIG. 29, a door 236 is provided on the front face of the housing 202 at a position opposed to the cash transport cassette 235. By opening the door 236, the operator can pull out the cash transport cassette 235 from the housing 202. The storing/feeding units 270 are housed in a drawer unit 272, and the drawer unit 272 can be pulled out frontward from the housing 202. In addition, an elastic body 237, such as sponge or rubber, having a substantially rectangular parallelepiped shape is adhered to a front face of the door 236. Since the elastic body 237 is adhered to the front face of the door 236, when the upper door 14 of the money changer 10 is closed from the state shown in FIG. 3, the upper door 14 comes into contact with the elastic body 237, thereby preventing the door 236 from being damaged by the upper door 14.

[Structure of Wrapped-Coin Dispensing Apparatus]

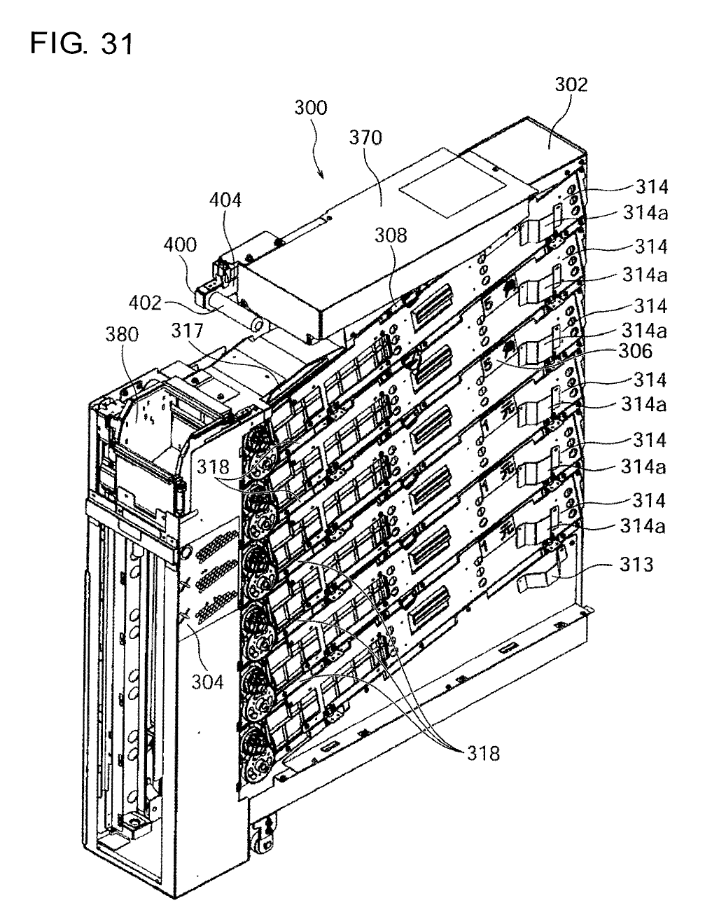

Next, the structure of the wrapped-coin dispensing apparatus 300 in the money changer 10 according to the present embodiment will be described with reference to FIG. 31 through FIG. 60. In FIG. 31 through FIG. 60, wrapped coin rolls are represented by reference character W.

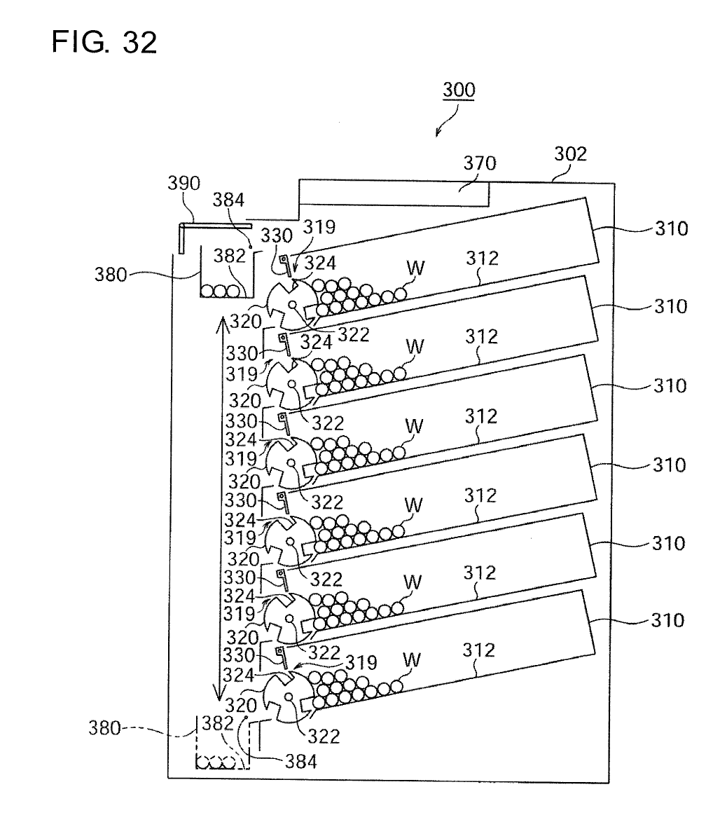

As shown in FIG. 31 and FIG. 32, the wrapped-coin dispensing apparatus 300 includes: the housing 302 having a substantially rectangular parallelepiped shape; a plurality of (e.g., six) storage units 310 arranged along the vertical direction in the housing 302; and the lift unit 380 movable in the vertical direction. Each storage unit 310 is provided with a dispensing mechanism 319 which dispenses, one by one, wrapped coin rolls stored in the storage unit from a side closest to a portion, at a lowest height level, of a bottom face 312. The lift unit 380 includes: the wrapped-coin storage member 382 in which wrapped coin rolls dispensed by the dispensing mechanism 319 of each storage unit 310 are stored; and a dispensed wrapped-coin detection unit 384 which detects the wrapped coin rolls dispensed by the dispensing mechanism 319 of each storage unit 310. At an upper face of the housing 302, a shutter 390 is provided which opens and closes a wrapped-coin outlet through which the wrapped coin rolls stored in the wrapped-coin storage member 382 of the lift unit 380 are taken out when the wrapped-coin storage member 382 is at an upper position (solid-line position in FIG. 32). In an upper portion of the wrapped-coin dispensing apparatus 300, a control unit 370 is provided which controls the lift unit 380, and the dispensing mechanisms 319 provided in the respective storage units 310. Hereinafter, the components of the wrapped-coin dispensing apparatus 300 will be described in detail.

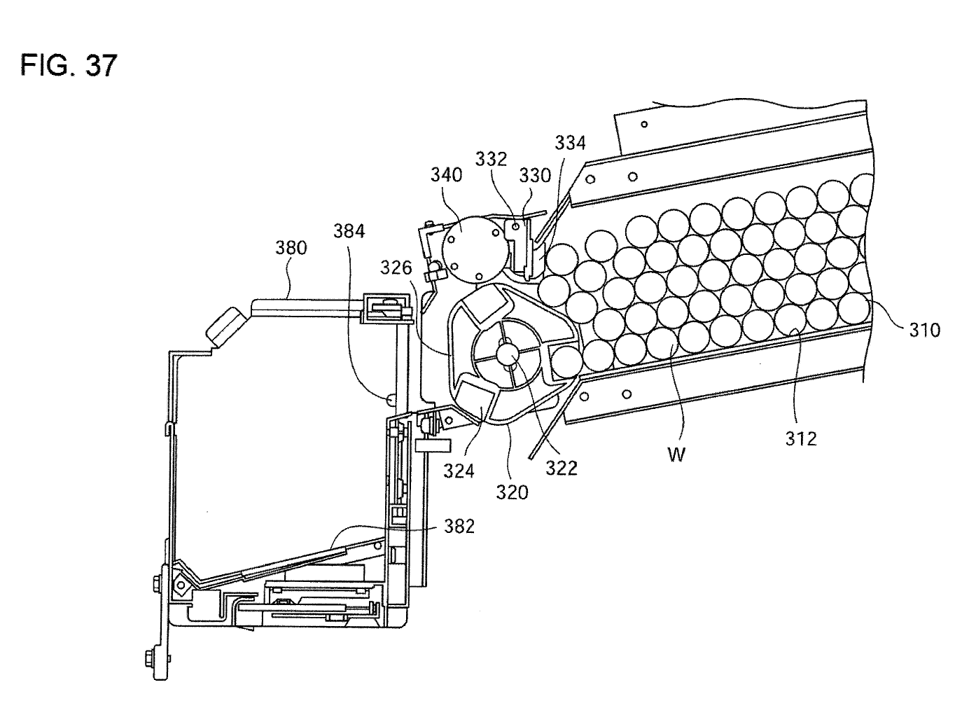

As shown in FIG. 32, FIG. 37, etc., each storage unit 310 stores, therein, a plurality of wrapped coin rolls on the bottom face (storage face) 312 inclined with respect to the horizontal plane so that the wrapped coin rolls are stacked in a direction (i.e., a lower left direction in FIG. 32, FIG. 37, etc.) in which the wrapped coin rolls run along the inclined bottom face 312. The expression “a plurality of wrapped coin rolls are stored so as to be stacked” may include: a case where the wrapped coin rolls are stored so as to be stacked in multiple layers on the bottom face 312; a case where the wrapped coin rolls are stored side by side in a single layer (single line) on the bottom face 312; and a case where one wrapped coin roll is stored, depending on the number of the wrapped coin rolls stored in the storage unit 310. In addition, the above expression may also include: a case where the wrapped coin rolls are stored in a regularly arranged manner; and a case where the wrapped coin rolls are stored in the same direction but not in a regularly arranged manner. That is, the above expression means that it is possible to store the wrapped coin rolls so as to be stacked in multiple layers. The wrapped coin rolls are not necessarily stored so as to be stacked in multiple layers, and the wrapped coin rolls are not necessarily stored in a regularly arranged manner.

The inclination angle of the bottom face 312 of each storage unit 310 with respect to the horizontal plane is within a range of 8 to 20°, and the maximum static friction coefficient of the bottom face 312 of each storage unit 310 with respect to the wrapped coin rolls is within a range of 0.01 to 0.15. Thus, among the wrapped coin rolls stored in each storage unit 310, each wrapped coin roll present on the bottom face 312 slides or runs by its own weight along the inclined bottom face 312 without being stopped by a friction acting between the wrapped coin roll and the bottom face 312, and is shifted to the dispensing mechanism 319 side.

Each storage unit 310 has a pair of side walls that form a storage area for wrapped coin rolls therebetween. As shown in FIG. 31, at least one of the pair of side walls is configured as an openable/closable door 314 through which wrapped coin rolls are put in and taken out from the storage unit 310. The side wall of the storage unit 310, configured as the door 314, is formed of a transparent member or a semi-transparent member, for example, so that the operator can visually observe the inside of the storage unit 310 through the door 314. Instead of being formed of a transparent member or a semi-transparent member, the door 314 may have a slit, hole, or the like through which the operator can visually observe the inside of the storage unit 310. As shown in FIG. 52, for example, two hinges 316 are provided at a lower edge portion of the door 314, and the door 314 is openably and closably attached to a side face of the housing 302 of the wrapped-coin dispensing apparatus 300 by means of the hinges 316. Thus, when replenishing each storage unit 310 with wrapped coin rolls, the operator can put the wrapped coin rolls from the lateral side of the storage unit 310 by opening the door 314.

As shown in FIG. 31, FIG. 52, at a front face of the door 314, a stopper member 314a is provided which regulates the open angle of the door 314 to a predetermined angle so that, when the door 314 is opened, a gap of a predetermined size is formed between the opened door 314 and the side face of the wrapped-coin dispensing apparatus 300. Specifically, when a door 314 is opened, the stopper member 314a of the opened door 314 comes into contact with the stopper member 314a of a door 314 provided immediately beneath the opened door 314, whereby the open angle of the door 314 is regulated to the predetermined angle. As shown in FIG. 31, a stopper member 313 is also provided below a door 314 located at the lowermost position among the six doors 314. When the door 314 located at the lowermost position is opened, the stopper member 314a of this door 314 comes into contact with the stopper member 313, whereby the open angle of the door 314 located at the lowermost position is set at the predetermined angle. Since the stopper member 314a is provided on each door 314 and the stopper member 313 is provided, an operator's finger(s) is/are prevented from being caught between each door 314 and the side face of the wrapped-coin dispensing apparatus 300 when the operator opens the door 314. When vertically adjacent doors 314 are opened, the stopper members 313 of these doors 314 do not come into contact with each other. Instead, screw heads of the hinges 316 provided on each door 314 come into contact with each other, whereby the open angle of each door 314 is set at a predetermined angle, thereby preventing the operator's finger(s) from being caught between the opened door 314 and the side face of the wrapped-coin dispensing apparatus 300. Thus, the hinges 316 provided on each door 314 also act as a stopper member for regulating the open angle of the door 314 to a predetermined angle, similarly to the stopper member 314a provided on each door 314, and the stopper member 313.

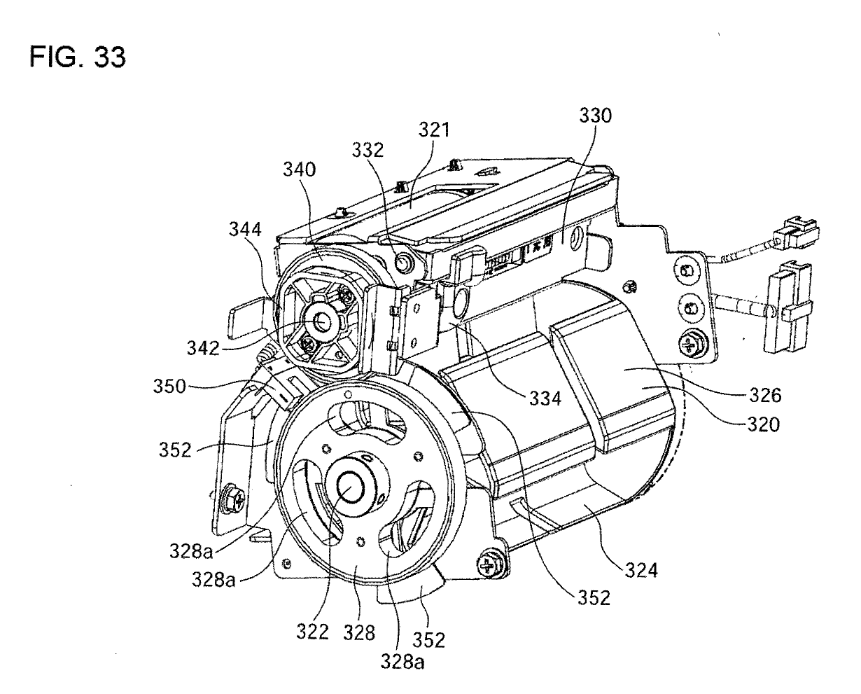

As described above, each storage unit 310 is provided with the dispensing mechanism 319 which dispenses, one by one, the wrapped coin rolls stored in the storage unit 310 from the side closest to the portion, at the lowest height level, of the bottom face 312. This structure of the dispensing mechanism 319 will be described in detail with reference to FIG. 33 through FIG. 36. The dispensing mechanism 319 includes a rotor 320 which rotates in the counter clockwise direction in FIG. 32 about a rotation shaft 322 as an axial center extending in a direction orthogonal to the inclination direction of the storage unit 310 and in the horizontal direction (i.e., extending in a direction orthogonal to the surface of the sheet of FIG. 32). Each rotor 320 is provided with at least two (three in the example shown in FIG. 32 through FIG. 36, etc.) recessed portions 324 each receiving, one by one, the wrapped coin rolls stored in the storage unit 310. The dispensing mechanism 319 includes: a drive unit 321 (refer to FIG. 33) which causes the rotor 320 to rotate about the rotation shaft 322; a rotation position detecting unit 350 which detects a rotation position of the rotor 320; and a gate unit 330 which is provided above the rotor 320, and avoids a situation that a wrapped coin roll stored in the storage unit 310 does not enter the recessed portion 324 of the rotor 320 but passes above the rotor 320 and is dispensed. In each dispensing mechanism 319, the drive unit 321 can cause the rotor 320 to rotate in both a forward direction (i.e., the counter clockwise direction in FIG. 32) in which wrapped coin rolls are dispensed from the storage unit 310 by the rotor 320 and a reverse direction (i.e., the clockwise direction in FIG. 32) opposite to the forward direction. In addition, the drive unit 321 can change the rotation speed of the rotor 320.

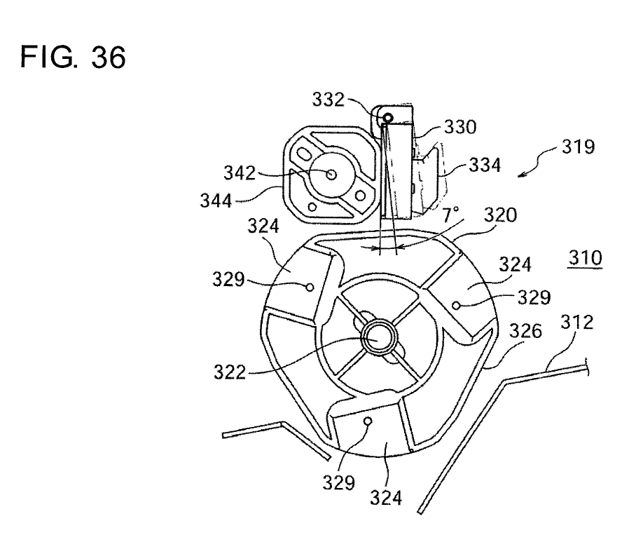

As shown in FIG. 35 and FIG. 36, three recessed portions 324 are provided in the rotor 320 at equal intervals in the rotation direction of the rotor 320 about the rotation shaft 322. When the rotor 320 is in the rotation position as shown in FIG. 35, one wrapped coin roll located on a portion, at the lowest height level, of the bottom face 312, among a plurality of wrapped coin rolls stored in the storage unit 310, is received by the recessed portion 324. Each recessed portion 324 may be provided with a received wrapped-coin detecting unit 329 which detects whether or not a wrapped coin roll is received in the recessed portion 324. The received wrapped-coin detecting unit 329 is composed of an optical sensor or the like having a photoemitter and a photodetector, for example. When a wrapped coin roll is received in the recessed portion 324, an optical axis between the photoemitter and the photodetector is cut off by the wrapped coin roll, whereby this wrapped coin roll is detected.

As shown in FIG. 35 and FIG. 36, an outer face 326 of the rotor 320, with which any of the wrapped coin rolls stored in the storage unit 310 comes into contact, is formed so that the distance between the outer face 326 and the rotation shaft 322 as an axial center varies. Specifically, a lateral cross section of the rotor 320 has a substantially polygonal shape (substantially triangular shape in the example shown in FIG. 35 and FIG. 36), and the recessed portion 324 are located at positions near the vertices of the polygonal shape, respectively. In the case where a large number of wrapped coin rolls are stored in the storage unit 310 so as to be stacked in multiple layers, some of the wrapped coin rolls stored in the storage unit 310 come into contact with the outer face 326 of the rotor 320. In this case, depending on the storage state of the wrapped coin rolls in the storage unit 310, the wrapped coin rolls may become unable to move in the storage unit 310, and no wrapped coin roll may be transported to each recessed portion 324 of the rotor 320 even though the recessed portion 324 is empty. On the other hand, in the case where the outer face 326 of the rotor 320 has such a structure that the distance between the outer face 326 of the rotor 320 and the center of the rotation shaft 322 as an axial center varies, the position of the wrapped coin roll in contact with the outer face 326 changes when the rotor 320 rotates about the rotation shaft 322. Thus, the wrapped coin rolls in the storage unit 310 are agitated and movable, whereby the wrapped coin rolls can be transported to the recessed portions 324 of the rotor 320.

Each recessed portion 324 of the rotor 320 is structured as follows. That is, when a certain recessed portion 324 of the rotor 320 is located at a storage position (i.e., the position shown in FIG. 35) in which a wrapped coin roll from the storage unit 310 at the rotation position of the rotor 320 should be received in the recessed portion 324, an inner side wall (represented by reference numeral 324a in FIG. 35) of this recessed portion 324 and the bottom face 312 of the storage unit 310 are located on a substantially straight line. Thus, when the rotor 320 is at the rotation position as shown in FIG. 35, one wrapped coin roll located on the portion, at the lowest height level, of the bottom face 312 among the plurality of wrapped-coin rolls stored in the storage unit 310 is smoothly received in the recessed portion 324.

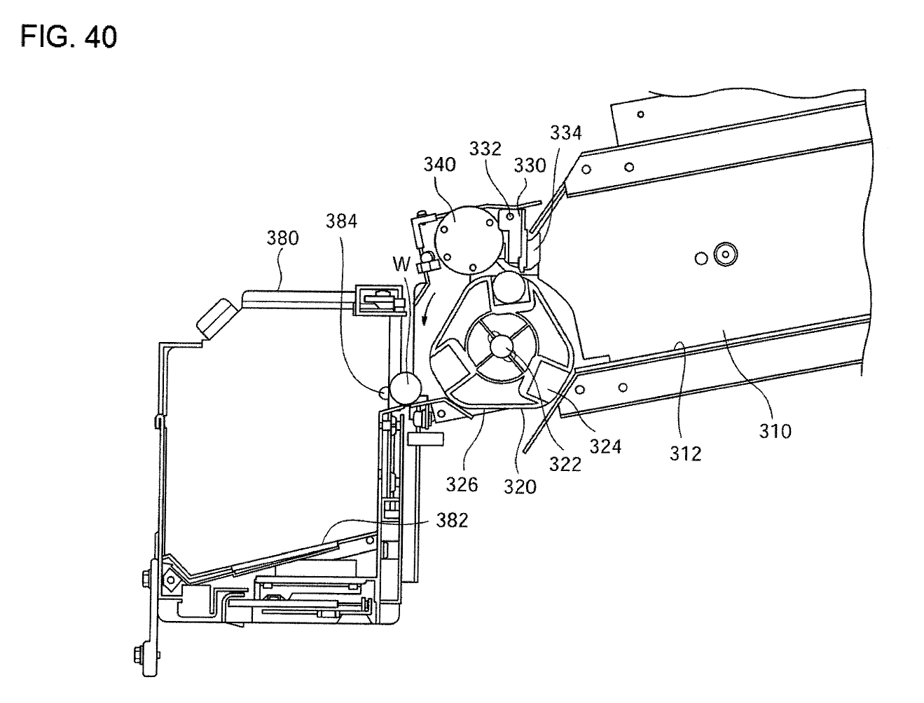

Further, the shape and position of each of the recessed portions 324 of the rotor 320 have been determined so that, when a certain recessed portion 324 of the rotor 320 is located at a dispensing position as shown in FIG. 40 in which a wrapped coin roll is dispensed from the recessed portion 324 at the rotation position of the rotor 320, another recessed portion 324 preceding this recessed portion 324 does not receive a wrapped coin roll from the storage unit 310, that is, the preceding other recessed portion 324 is positioned lower than the bottom face 312 of the storage unit 310.

In the present embodiment, the length, in the longitudinal direction, of the rotor 320 along the rotation shaft 322 (i.e., the length, in the depth direction, of the rotor 320 in FIG. 33) is greater than ½ of the maximum length, in the longitudinal direction, of the wrapped coin rolls to be dispensed. Thus, the wrapped coin rolls stored in the storage unit 310 can be stably and reliably dispensed by the rotor 320 while keeping balance even for wrapped coin rolls that are long in the longitudinal direction.

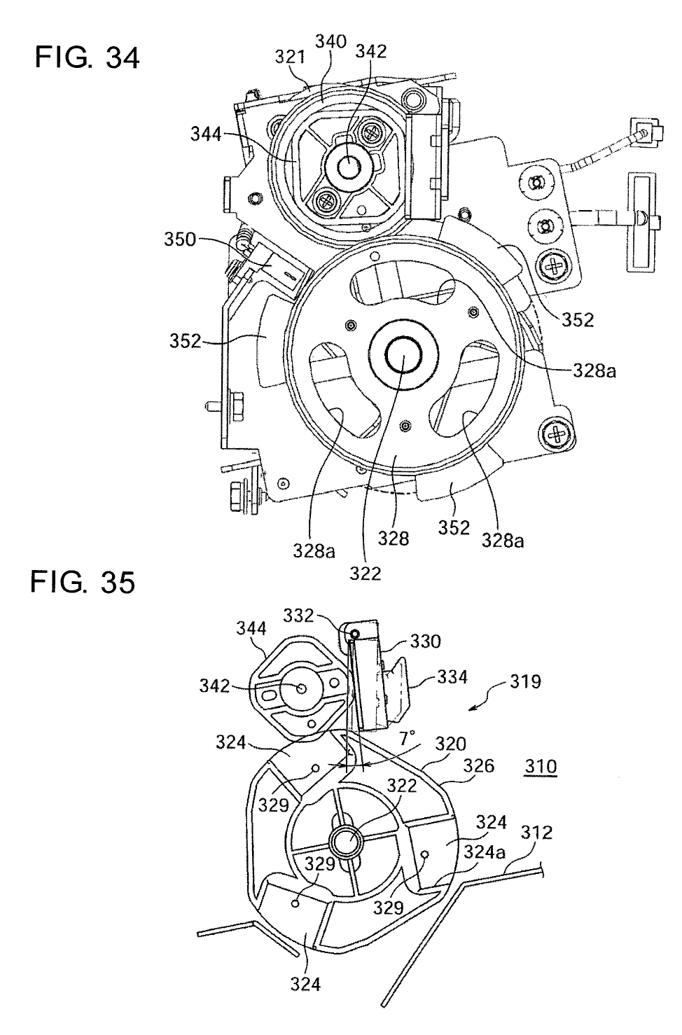

As shown in FIG. 33, on the side of the rotor 320, a gear 328 is provided on the rotation shaft 322, and the gear 328 rotates in synchronization with the rotor 320. As shown in FIG. 33 and FIG. 34, the gear 328 has three through-holes 328a, each having an elongated hole, corresponding to the respective recessed portions 324. Thus, when the operator pulls out the wrapped-coin dispensing apparatus 300 frontward from the outer housing 12 of the money changer 10, the operator can visually observe whether or not a wrapped coin roll is loaded in each of the recessed portions 324 of the rotor 320. Therefore, when a wrapped coin roll remains in any of the recessed portions 324 of the rotor 320, the operator can see the remaining wrapped coin roll.

Further, three members-to-be-detected 352 are provided at equal intervals on an outer circumference of a rotor which is coaxial with the gear 328 and located on the side of the rotor, and the rotation position detecting unit 350 for detecting the members-to-be-detected 352 is fixedly provided on the side radially outward the gear 328. When the rotation position detecting unit 350 detects the members-to-be-detected 352, the rotation position of the rotor 320 is detected. More specifically, the rotation position detecting unit 350 is composed of an optical sensor or the like having a photoemitter and a photodetector, for example. When each member-to-be-detected 352 is positioned between the photoemitter and the photodetector, an optical axis between the photoemitter and the photodetector is cut off by the member-to-be-detected 352, whereby this member-to-be-detected 352 is detected.

The gate unit 330 is provided above the rotor 320, and avoids a situation that a wrapped coin roll stored in the storage unit 310 does not enter the recessed portion 324 of the rotor 320 but passes above the rotor 320 and is dispensed. That is, as shown in FIG. 32, a gap between the upper face of the storage unit 310 and the rotor 320 is closed by the gate unit 330, whereby wrapped coin rolls are prevented from being dispensed to the lift unit 380 side through the gap between the upper face of the storage unit 310 and the rotor 320 when a large number of wrapped coin rolls are stored in the storage unit 310.

As shown in FIG. 35 and FIG. 36, a swing shaft 332 as an axial center extending in the horizontal direction is provided in an upper portion of the gate unit 330, and the gate unit 330 is swingable about the swing shaft 332. The mechanism of swinging the gate unit 330 will be described below. As shown in FIG. 34, a gear 340 is provided above the gear 328 so as to be engaged with the gear 328. This gear 340 is rotated about a rotation shaft 342 by the drive unit 321. When the gear 340 rotates, the gear 328 also rotates along with the gear 340 through teeth provided on outer circumferences of the gear 328 and the gear 340. Thus, the rotor 320 is rotated by the drive unit 321 through the gears 340 and 328. In addition, a cam 344 is provided on a side face of the gear 340, and the cam 344 rotates about the rotation shaft 342 in synchronization with the gear 340. As shown in FIG. 33 through FIG. 36, the cam 344 has a substantially rectangular cross section. When the cam 344 rotates about the rotation shaft 342, each of vertex portions of the cam 344 intermittently pushes the side face of the gate unit 330 from the left side in FIG. 35 and FIG. 36, whereby the gate unit 330 swings about the swing shaft 332 between a position indicated by a solid line and a position indicated by a two-dotted line in FIG. 35 and FIG. 36. For simplification, the shape of the teeth of the gears 328 and 340 is not illustrated in the drawings.

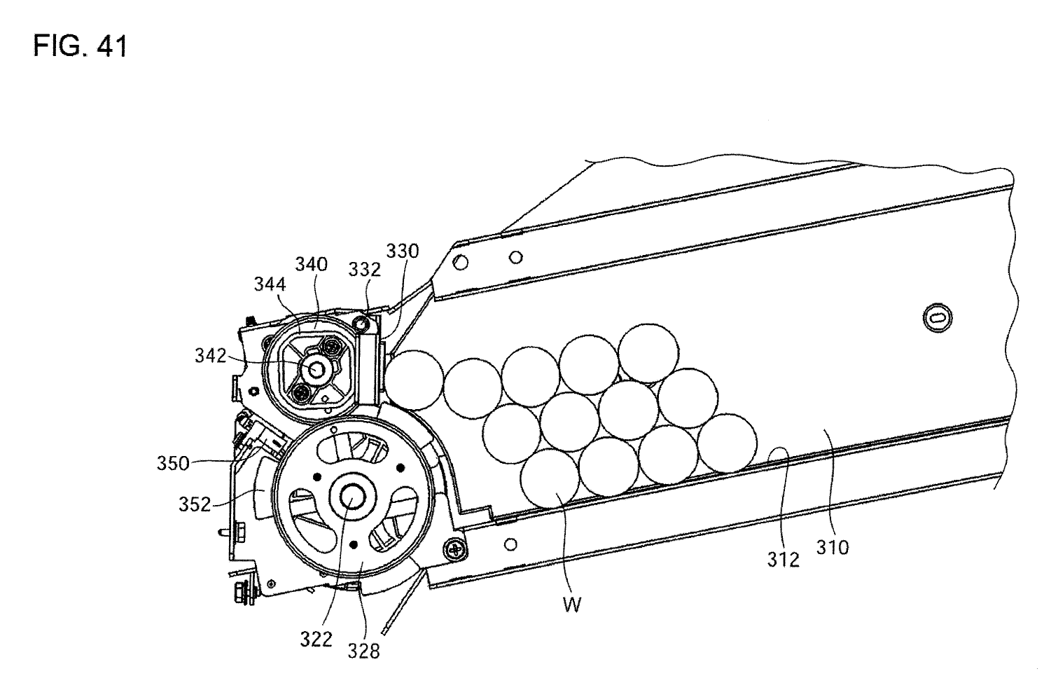

In the case where any of the wrapped coin rolls stored in the storage unit 310 is in contact with the gate unit 330, if the position of the gate unit 330 is fixed, the wrapped coin roll in contact with the gate unit 330 and other wrapped coin rolls in the storage unit 310 may not smoothly move in the storage unit 310, depending on the storage state of the wrapped coin rolls in the storage unit 310. For example, in the case where the wrapped coin rolls are stored in the storage unit 310 as shown in FIG. 41 and a plurality of (four in FIG. 41) wrapped coin rolls cause so-called bridge phenomenon W between the bottom face 312 of the storage unit 310 and the gate unit 330, each wrapped coin roll cannot move in the storage unit 310, and wrapped coin rolls cannot be transported to the recessed portions 324 of the rotor 320 even though the wrapped coin rolls are stored in the storage unit 310. On the other hand, in the present embodiment, the gate unit 330 swings about the swing shaft 332 extending in the horizontal direction in conjunction with the rotation of the rotor 320. Therefore, when any of the wrapped coin rolls stored in the storage unit 310 is in contact with the gate unit 330, this wrapped coin roll is pushed by the gate unit 330. Thereby, the positions of the wrapped coin rolls in the storage unit 310 are changed, and the wrapped coin rolls in the storage unit 310 are agitated to be movable, whereby wrapped coin rolls can be transported to the recessed portions 324 of the rotor 320. The swing angle of the gate unit 330 about the swing shaft 332 is, for example, 7° as shown in FIG. 35 and FIG. 36.

Even if the gate unit 330 swings when any of the wrapped coin rolls stored in the storage unit 310 is in contact with the gate unit 330, the wrapped coin roll pushed by the gate unit 330 and other wrapped coin rolls stored in the storage unit 310 may not smoothly move in the storage unit 310, depending on the storage state of the wrapped coin rolls in the storage unit 310. Such a phenomenon is often caused by, for example, the distance between the bottom face 312 of the storage unit 310 and the face, of the gate unit 330, to be in contact with the wrapped coin roll, or the size of the diameter of the wrapped coins. Therefore, in preparation for such a problem, one or a plurality of attachment members 334 which can be in contact with the wrapped coin roll(s) stored in the storage unit 310 are detachably attached to the face, of the gate unit 330, to be in contact with the wrapped coin roll, so as to make the distance between the bottom face 312 of the storage unit 310 and the face, of the gate unit 330, to be in contact with the wrapped coin roll variable. More specifically, on the face, of the gate unit 330, to be in contact with the wrapped coin roll, a plurality of attachment holes (not shown) are provided side by side along a direction in which the rotation shaft 322 of the rotor 320 extends, and the attachment member 334 can be fitted in any one of the plurality of attachment holes.

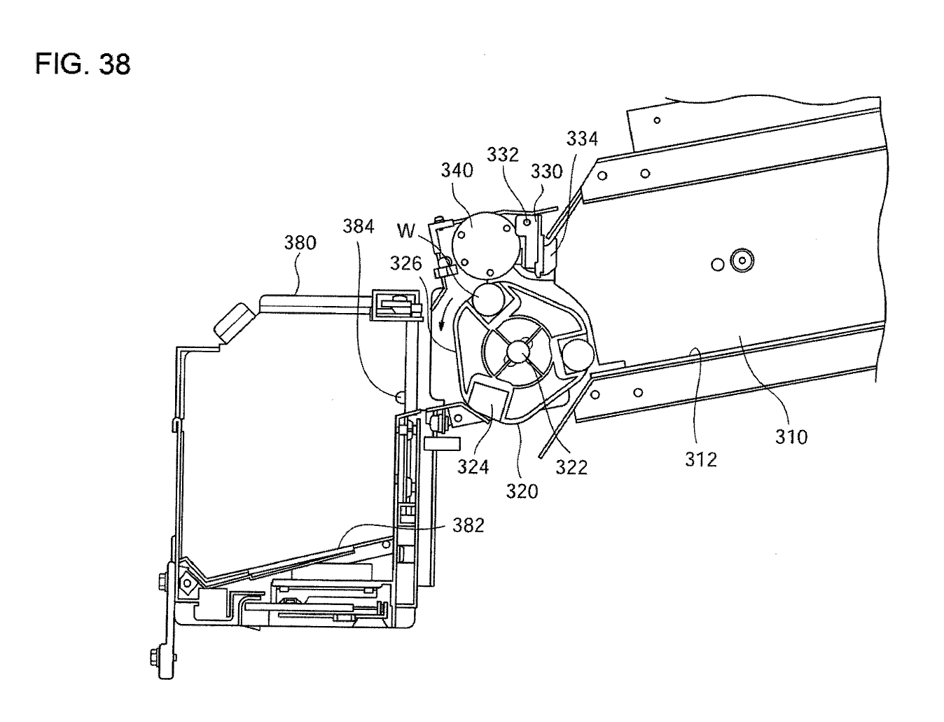

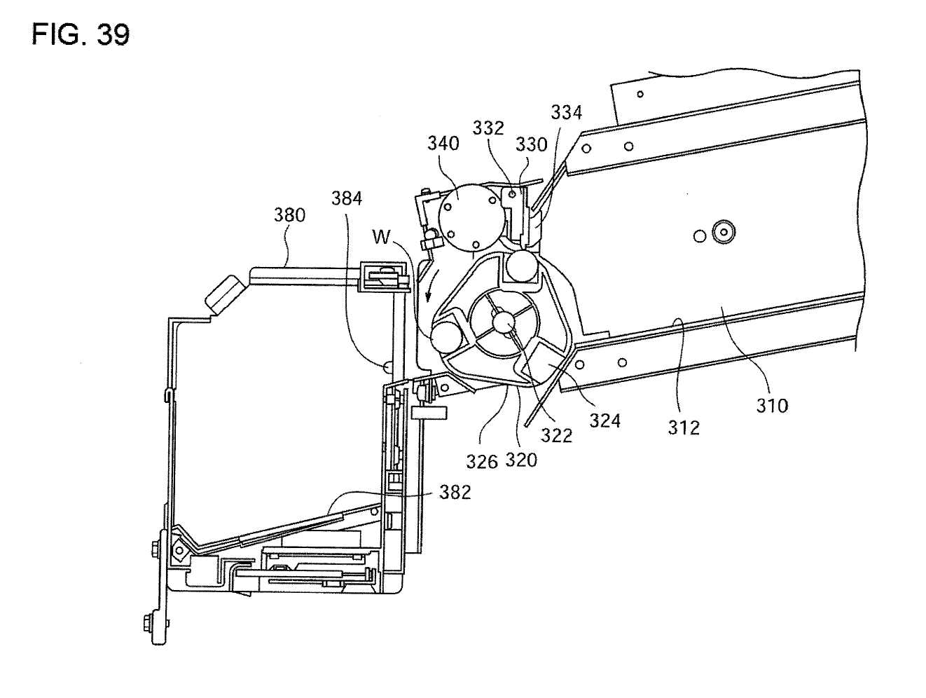

The operation of dispensing the wrapped coin rolls stored in the storage unit 310 by the dispensing mechanism 319 configured as described above will be described with reference to FIG. 37 through FIG. 40. As shown in FIG. 37, when a certain recessed portion 324 of the rotor 320 is located at a storage position in which a wrapped coin roll from the storage unit 310 should be received in the recessed portion 324 at the rotation position of the rotor 320, one wrapped coin roll located on a portion, at the lowest height level, of the bottom face 312 can be smoothly received in the recessed portion 324, among the plurality of wrapped coin rolls stored in the storage unit 310. When the rotor 320 is rotated by the drive unit 321 in the counter clockwise direction in FIG. 37 from the rotation position of the rotor 320 shown in FIG. 37, the rotor 320 reaches the dispensing position as shown in FIG. 40 through the position shown in FIG. 38 and the position shown in FIG. 39. At the dispensing position, the wrapped coin roll is dispensed from the recessed portion 324 of the rotor 320 to be transported to the wrapped-coin storage member 382 of the lift unit 380.

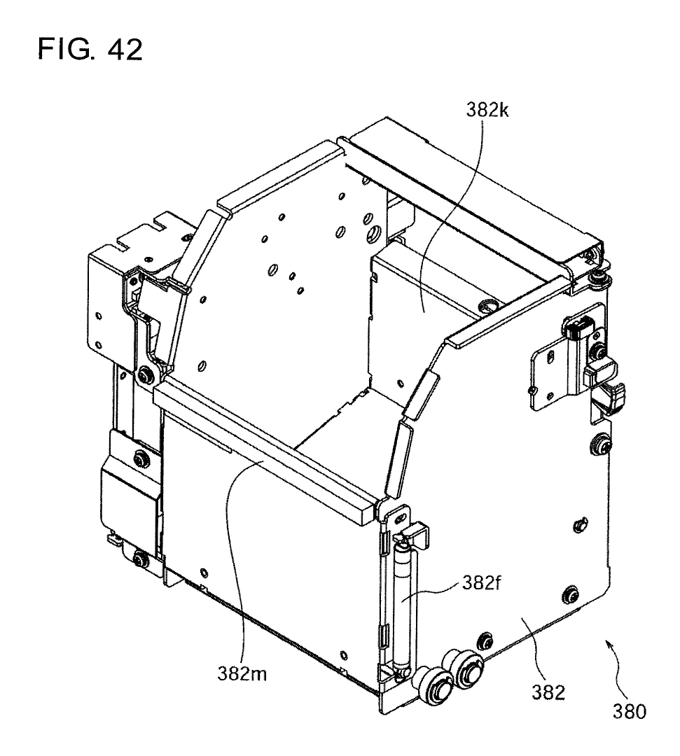

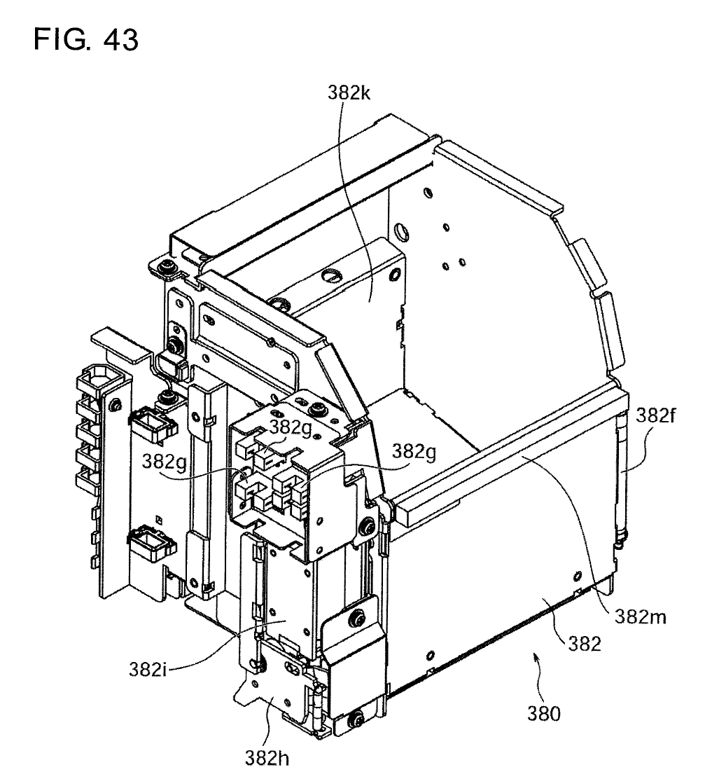

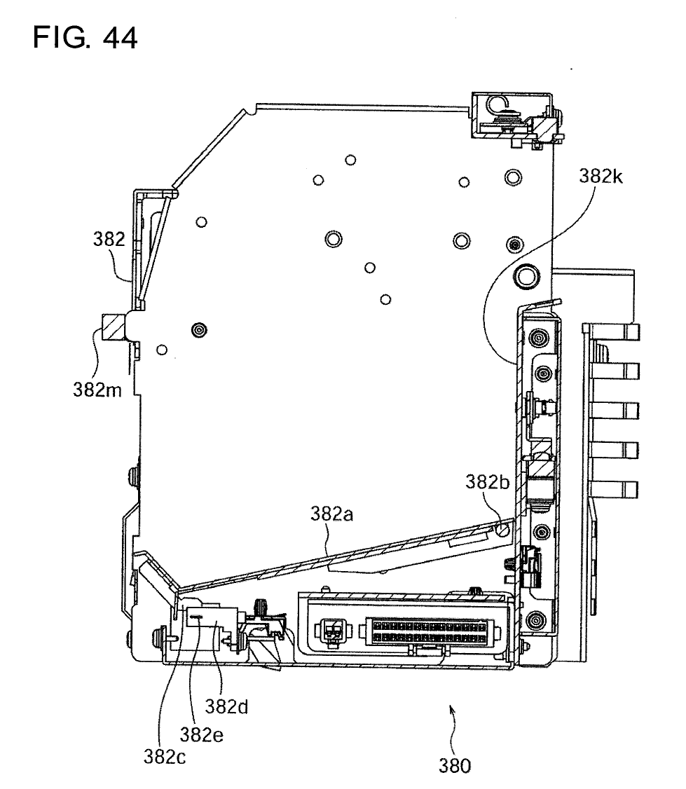

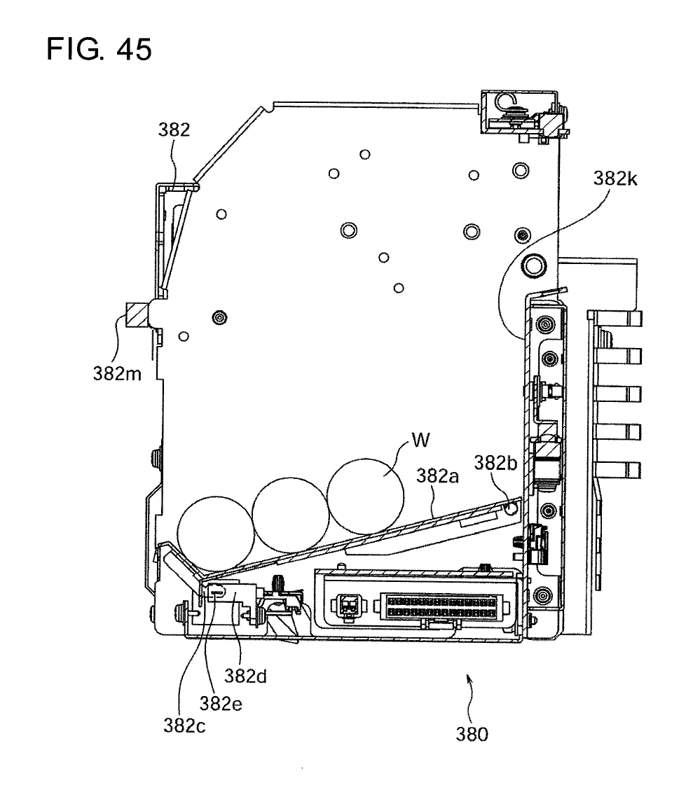

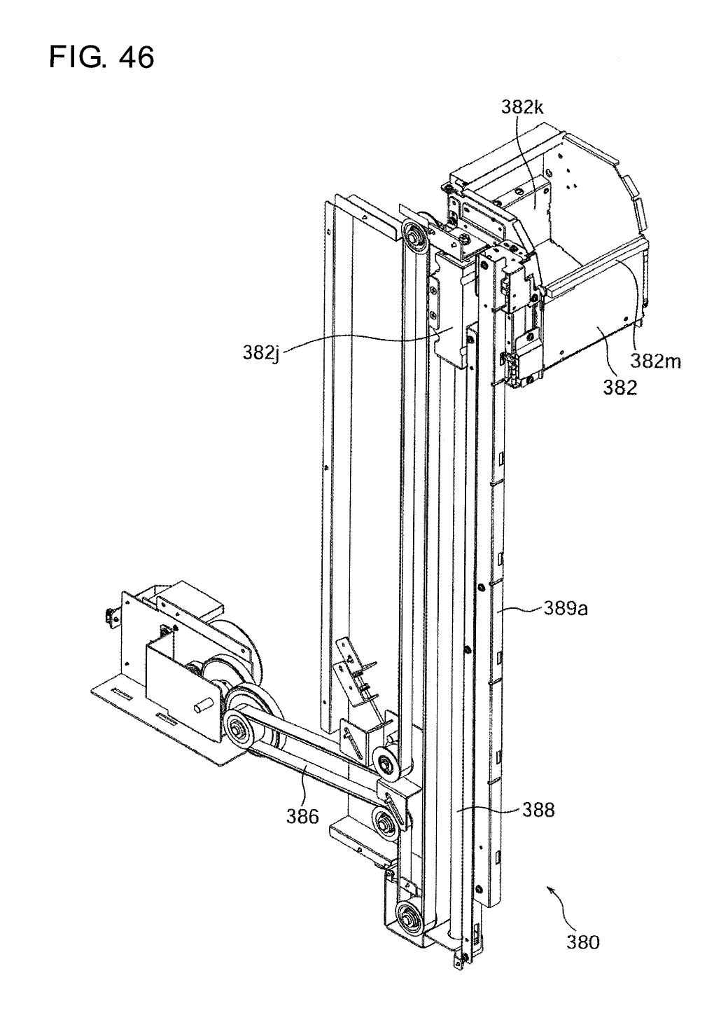

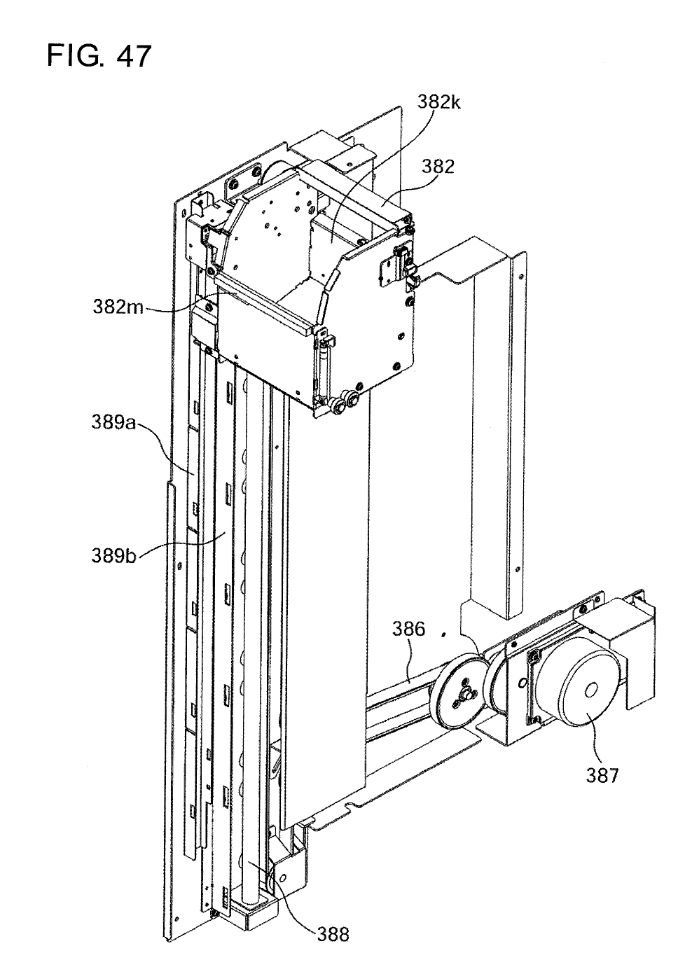

Next, the structure of the lift unit 380 will be described in detail with reference to FIG. 42 through FIG. 47. FIG. 42 is a perspective view showing the structure of the wrapped-coin storage member 382 in the lift unit 380. FIG. 43 is a perspective view showing the structure of the wrapped-coin storage member 382 shown in FIG. 42 as seen from another angle. FIG. 44 and FIG. 45 are vertical cross-sectional views showing the internal structure of the wrapped-coin storage member 382 shown in FIG. 42 and FIG. 43. FIG. 46 is a perspective view showing the structure of a lifting and lowering mechanism for lifting and lowering the wrapped-coin storage member 382 in the lift unit 380. FIG. 47 is a perspective view showing the structure of the lifting and lowering mechanism shown in FIG. 46 as seen from another angle.

The lift unit 380 includes the wrapped-coin storage member 382 in which wrapped coin rolls dispensed by the dispensing mechanisms 319 of the respective storage units 310 are stored. The wrapped-coin storage member 382 is able to move up and down between an upper position near the shutter 390 and each of positions facing the dispensing mechanisms 319 provided in the respective storage units 310 as indicated by an arrow in FIG. 32. When a wrapped coin roll stored in each storage unit 310 is dispensed to the wrapped-coin storage member 382 by the dispensing mechanism 319, the wrapped-coin storage member 382 moves to the position facing this dispensing mechanism 319. As shown in FIG. 32, the wrapped-coin storage member 382 is provided with the dispensed wrapped-coin detecting unit 384 which detects a wrapped coin roll dispensed by the dispensing mechanism 319 of each storage unit 310. When a wrapped coin roll is dispensed from each storage unit 310 by the dispensing mechanism 319, this wrapped coin roll is detected by the dispensed wrapped-coin detecting unit 384 and then stored in the wrapped-coin storage member 382. The dispensed wrapped-coin detecting unit 384 is composed of an optical sensor or the like having a photoemitter and a photodetector, for example. When the wrapped coin roll dispensed by the dispensing mechanism 319 is transported to the wrapped-coin storage member 382, an optical axis between the photoemitter and the photodetector is cut off by the wrapped coin roll, whereby this wrapped coin roll is detected.

As shown in FIG. 44, in a bottom portion of the wrapped-coin storage member 382, a placement unit 382a on which wrapped coin rolls are to be placed is provided. An upper face of the placement unit 382a is inclined with respect to the horizontal plane. More specifically, the placement unit 382a is rotatable about a shaft 382b extending in the horizontal direction. An end (lower end portion) of a spring 382f serving as a biasing member is connected to an end portion, of the placement unit 382a, opposite to an end portion thereof on which the shaft 382b is provided, while the other end (upper end portion) of the spring 382f is attached to the wrapped-coin storage member 382. The end portion, of the placement unit 382a, opposite to the end portion on which the shaft 382b is provided is pulled upward by the spring 382f, whereby the placement unit 382a is maintained at a predetermined position (specifically, the position shown in FIG. 44) when no wrapped coin roll is placed thereon. Alternatively, when a wrapped coin roll is placed on the placement unit 382a, the placement unit 382a is turned downward about the shaft 382b against a biasing force caused by the spring 382f, and the placement unit 382a moves to a position as shown in FIG. 45.

As shown in FIG. 44, a detection plate 382c is provided on the end portion, of the placement unit 382a, opposite to the end portion on which the shaft 382b is provided. In the vicinity of the detection plate 382c, a detection sensor 382d such as an interrupter is provided. The detection sensor 382d detects the detection plate 382c when the placement unit 382a moves from the position shown in FIG. 44 to the position shown in FIG. 45. Specifically, the detection sensor 382d is composed of an optical sensor or the like having a photoemitter and a photodetector (in FIG. 44 and FIG. 45, the position where the photoemitter and the photodetector are provided is represented by reference numeral 382e). When the placement unit 382a moves from the position shown in FIG. 44 to the position shown in FIG. 45, an optical axis between the photoemitter and the photodetector is cut off by the detection plate 382c, whereby the detection plate 382c is detected by the detection sensor 382d. The detection plate 382c and the detection sensor 382d constitute a wrapped-coin detection unit for detecting wrapped coin rolls placed on the placement unit 382a. That is, when no wrapped coin roll is placed on the placement unit 382a, the placement unit 382a is lifted upward by the spring 382f to be maintained at the position shown in FIG. 44, and the detection plate 382c is not detected by the detection sensor 382d. When a wrapped coin roll is placed on the placement unit 382a, the placement unit 382a turns downward about the shaft 382b against the biasing force caused by the spring 382f, and the placement unit 382a moves to the position shown in FIG. 45, whereby the detection plate 382c is detected by the detection sensor 382d.

As shown in FIG. 42 through FIG. 44, a light reflection member such as a mirror is provided on an internal rear side 382k of the wrapped-coin storage member 382. Thus, when the wrapped-coin outlet is opened by the shutter 390 with the wrapped-coin storage member 382 of the lift unit 380 being located at the upper position (the solid-line position in FIG. 32), wrapped coin rolls stored in the wrapped-coin storage member 382, in particular, wrapped coin rolls that have moved frontward in the wrapped-coin storage member 382 due to the placement unit 382a being inclined, are reflected in the light reflection member on the internal rear side 382k of the wrapped-coin storage member 382, and an operator can see, by means of the light reflection member, whether or not wrapped coin rolls remain inside the wrapped-coin storage member 382. In particular, even when an operator who tries to take wrapped coin roll(s) from the wrapped-coin outlet of the wrapped-coin dispensing apparatus 300 is short and it is difficult for the operator to look directly into the wrapped-coin storage member 382, the operator can see whether or not wrapped coin rolls remain inside the wrapped-coin storage member 382 by seeing the light reflection member.

As shown in FIG. 42 through FIG. 45, a packing member 382m formed of rubber or the like, having a rectangular parallelepiped shape and being horizontally extendable, is adhered to an uppermost portion, of the wrapped-coin storage member 382, on the front side of the wrapped-coin outlet. Due to the presence of the packing member 382m, loose coins are prevented from entering the gap between the rear face of the upper door 14 and the wrapped-coin storage member 382 from the opening 61 of the upper door 14 (refer to FIG. 5) when the wrapped-coin storage member 382 is located at the upper position (the solid-line position in FIG. 32), while the wrapped-coin storage member 382 is smoothly moved up and down.

Next, the structure of the lifting and lowering mechanism for lifting and lowering the wrapped-coin storage member 382 will be described in detail with reference to FIG. 46 and FIG. 47. As shown in FIG. 46, the lift unit 380 is provided with a circulating belt 386 extending in the vertical direction, and the wrapped-coin storage member 382 is attached to the circulating belt 386 through a joint member 382j. Further, as shown in FIG. 47, one of a plurality of pulleys over which the circulating belt 386 is stretched is provided with a drive motor 387, and the drive motor 387 is rotatable in both the forward and backward directions. The drive motor 387 allows the circulating belt 386 to circularly move in both the forward and backward directions. In addition, in the vicinity of the circulating belt 386, a guide member 388 extending in the vertical direction is provided, and the guide member 388 guides the lifting and lowering operation of the wrapped-coin storage member 382.

As shown in FIG. 46 and FIG. 47, in the vicinity of the guide member 388, a plurality of detection plates 389a are provided so as to correspond to the respective storage units 310, and each detection plate 389a detects that the wrapped-coin storage member 382 is located at the position opposed to the dispensing mechanism 319 of the corresponding storage unit 310. As shown in FIG. 43, on a side face of the wrapped-coin storage member 382, a detection sensor 382g such as an interrupter for detecting each detection plate 389a is provided. Specifically, the detection sensor 382g is composed of an optical sensor or the like having a photoemitter and a photodetector. When the wrapped-coin storage member 382 moves to the position opposite to the dispensing mechanism 319 of a certain storage unit 310 among the plurality of storage units 310, an optical axis between the photoemitter and the photodetector is cut off by the detection plate 389a, and the detection plate 389a is detected by the detection sensor 382g, whereby the position of the wrapped-coin storage member 382 is detected.

As shown in FIG. 47, in the vicinity of the guide member 388, a retaining plate 389b for causing the wrapped-coin storage member 382 to be retained at the position opposite to the dispensing mechanism 319 of each storage unit 310 is provided, and the retaining plate 389b has a plurality of recessed portions corresponding to the respective storage units 310. As shown in FIG. 43, on the side face of the wrapped-coin storage member 382, a lock plate 382h and a drive unit 382i such as a solenoid are provided. The lock plate 382h enters each of the recessed portions formed in the retaining plate 389b to stop the wrapped-coin storage member 382, and the drive unit 382i actuates the lock plate 382h. When the wrapped-coin storage member 382 moves to the position opposite to the dispensing mechanism 319 of a storage unit 310 among the plurality of storage units 310 and a specified detection plate 389a is detected by the detection sensor 382g, the drive unit 382i actuates the lock plate 382h to cause the lock plate 382h to enter a specified recessed portion of the retaining plate 389b, whereby the wrapped-coin storage member 382 is stopped and retained.

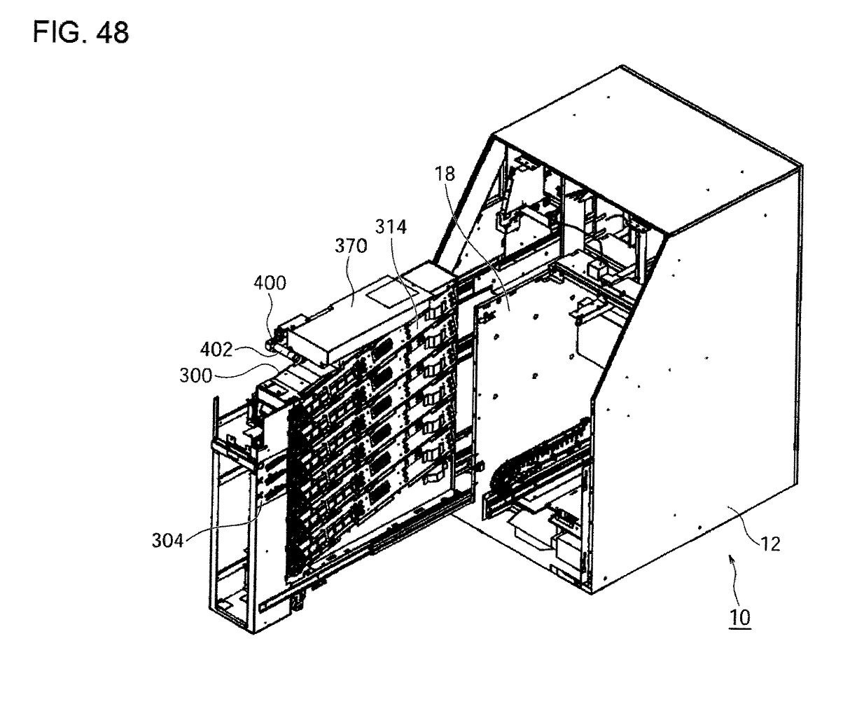

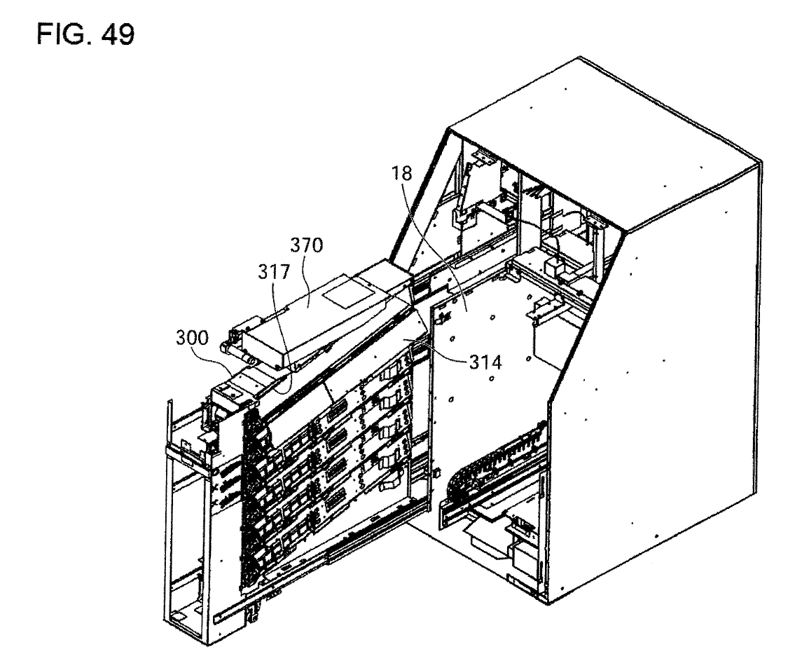

FIG. 48 is a perspective view showing the structure of the money changer 10 shown in FIG. 1 in the state where the wrapped-coin dispensing apparatus 300 is pulled out frontward from the outer housing 12 after the lower door 16 and the upper door 14 are opened. FIG. 49 is a perspective view showing the structure of the money changer 10 in the state where the door 314 of a certain storage unit 310 (specifically, the uppermost storage unit 310) among the plurality of storage units 310 of the wrapped-coin dispensing apparatus 300 is opened from the state shown in FIG. 48. As shown in FIG. 48 and FIG. 49, a partition member 18 for separating the area where the wrapped-coin dispensing apparatus 300 is housed from the area where the loose coin depositing and dispensing apparatus 100 is housed is provided inside the outer housing 12 of the money changer 10. In the state where the door 314 of a storage unit 310 is opened in the wrapped-coin dispensing apparatus 300 as shown in FIG. 49, when an operator tries to house the wrapped-coin dispensing apparatus 300 into the outer housing 12, the door 314 comes into contact with the partition member 18 so that the wrapped-coin dispensing apparatus 300 cannot be housed in the outer housing 12. Thus, in the present embodiment, the wrapped-coin dispensing apparatus 300 cannot be housed in the outer housing 12 unless the door 314 of each storage unit 310 is completely closed in the wrapped-coin dispensing apparatus 300.

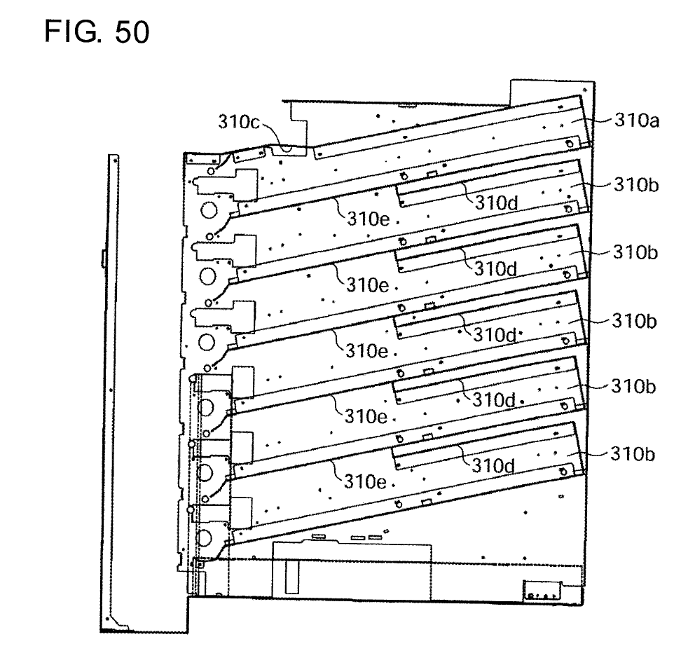

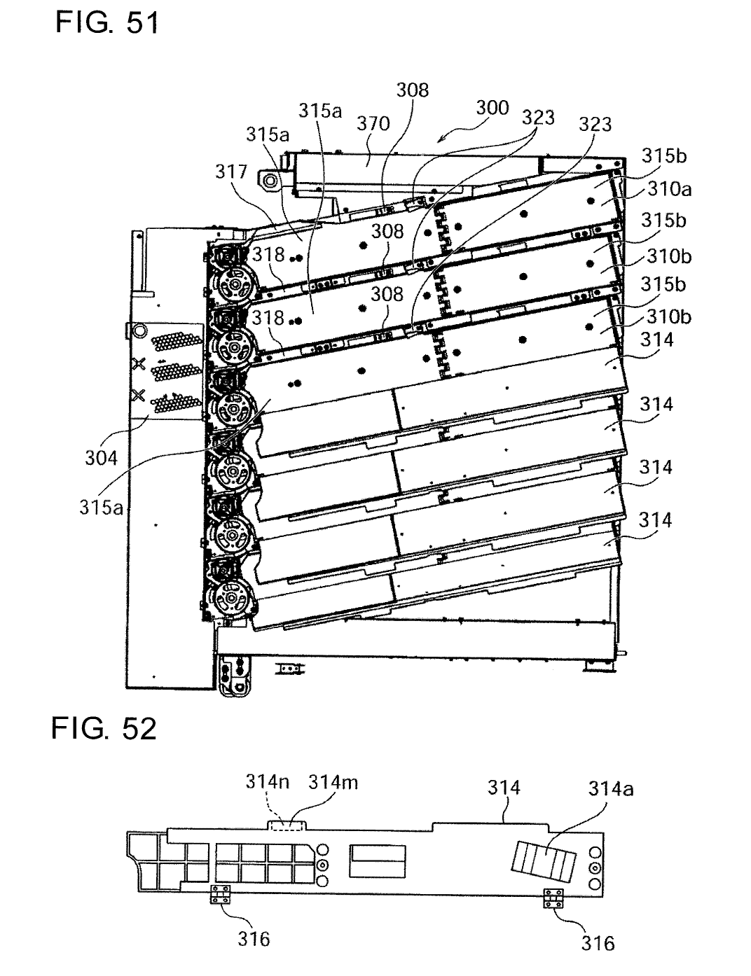

FIG. 50 is a side view of the wrapped-coin dispensing apparatus 300 shown in FIG. 31, showing the internal structure of each storage unit 310. FIG. 51 is a side view of the wrapped-coin dispensing apparatus 300 shown in FIG. 31 in the state where the door 314 of each storage unit 310 is opened. In FIG. 51, the door 314 opened from the uppermost storage unit 310a and the door 314 opened from the second storage unit 310b from the top are not illustrated in order to make the internal structure of each storage unit 310 easy to view.

As shown in FIG. 50, in the present embodiment, the height of the storage area of each storage unit 310 differs between the side where the dispensing mechanism 319 is provided and the side opposite to the side where the dispensing mechanism 319 is provided. Specifically, regarding the uppermost storage unit 310a, as shown in FIG. 50, the distance between a ceiling portion 310c on the side where the dispensing mechanism 319 is provided and the bottom face 312 of the storage unit 310a is greater than that in the other portion, whereby the height of the storage area on the side where the dispensing mechanism 319 is provided in the storage unit 310a is greater than the height of the storage area on the side opposite to the side where the dispensing mechanism 319 is provided. Regarding the storage units 310b other than the uppermost storage unit 310a, as shown in FIG. 50, a storage area regulating portion 310d for reducing the height of the storage area is provided in an upper portion, of each storage unit 310b, on the side opposite to the side where the dispensing mechanism 319 is provided. Thus, in the storage unit 310b, the height of the storage area on the side where the dispensing mechanism 319 is provided is greater than the height of the storage area on the side opposite to the side where the dispensing mechanism 319 is provided. Since, in each of the storage units 310a and 310b, the height of the storage area on the side where the dispensing mechanism 319 is provided is greater than the height of the storage area on the side opposite to the side where the dispensing mechanism 319 is provided, it is possible to avoid a situation that too many wrapped coin rolls are stored in each of the storage units 310a and 310b, thereby avoiding a situation that the wrapped coin rolls stored in each of the storage units 310a and 310b are in the state as shown in FIG. 41 and a plurality of wrapped coin rolls cause so-called bridge phenomenon between the bottom face 312 and the gate unit 330 of each of the storage units 310a and 310b.

As shown in FIG. 51, a plate-shaped wrapped-coin insertion preventing member 317 for preventing a wrapped coin roll from being inserted into an upper portion of the storage area from the outside of the storage unit 310a is provided in an upper portion, on the dispensing mechanism 319 side, of the side face of the uppermost storage unit 310a among the plurality of storage units 310. Since the wrapped-coin insertion preventing member 317 is provided, when an operator replenishes the storage area of the storage unit 310a with wrapped coin rolls from the outside of the storage unit 310a, the wrapped coin rolls are prevented from being stacked in the vicinity of the ceiling portion 310c shown in FIG. 50. Further, as shown in FIG. 51, a plate-shaped wrapped-coin insertion preventing member 318 for preventing wrapped coin rolls from being inserted into an upper portion of the storage area from the outside is also provided in an upper portion, on the dispensing mechanism 319 side, of the side face of each of the storage units 310b other than the Uppermost storage unit 310a. Since the wrapped-coin insertion preventing member 318 is provided, when the operator replenishes the storage area of each storage unit 310b with wrapped coin rolls from the outside of the storage unit 310b, the wrapped coin rolls are prevented from being stacked in the vicinity of a ceiling portion 310e shown in FIG. 50. In the storage unit 310a or the storage unit 310b, if wrapped coin rolls are stacked in the vicinity of the ceiling portion 310c or 310e on the dispensing mechanism 319 side, the wrapped coin rolls stacked in the storage unit 310a or 310b may be in the state as shown in FIG. 41 and a plurality of wrapped coin rolls may cause so-called bridge phenomenon between the bottom face 312 and the gate unit 330 of the storage unit 310a or 310b. On the other hand, in the present embodiment, since the wrapped-coin insertion preventing member 317, 318 for preventing wrapped coin rolls from being inserted in the upper portion of the storage area from the outside of the storage unit 310a, 310b is provided, occurrence of bridge phenomenon as shown in FIG. 41 is avoided.

In the present embodiment, as shown in FIG. 51, a side wall on the far side of each of the storage units 310a and 310b is composed of two joined wall parts 315a and 315b formed of resin, for example. Joined portions of these wall parts 315a and 315b each have a comb-teeth shape, and the comb-teeth shaped portions of the wall parts 315a and 315b are mutually meshed. Since the side wall on the far side of each of the storage units 310a and 310b is formed of two wall parts 315a and 315b, production of the wall parts 315a and 315b by resin molding is facilitated. Further, since the joined portions of the wall parts 315a and 315b each have a comb-teeth shape and the comb-teeth shaped joint portions of the wall parts 315a and 315b are mutually meshed, wrapped coin rolls inside the storage unit 310a or 310b are prevented from being caught by the joined portions of the wall parts 315a and 315b.

In the present embodiment, for example, the two hinges 316 are provided at the lower edge portion of the door 314, and the door 314 is openably and closably attached to the side face of the housing 302 of the wrapped-coin dispensing apparatus 300 by means of the hinges 316, as described above. Further, as shown FIG. 52, the door 314 is provided with a projecting member 314m that projects upward from an upper edge of the door 314, and a plate-shaped magnet member 314n provided on the rear side of the projecting member 314m. The main body of the storage unit 310 is formed of an iron-based member, for example. The main body of the storage unit 310 and the projecting member 314m of the door 314 are attracted to each other by a magnetic force of the magnetic member 314n provided on the door 314, whereby the door 314 can be fixed in its closed state. Instead of providing the plate-shaped magnetic member 314n on the projecting member 314m of the door 314, a plate-shaped magnetic member (not shown) may be provided on a portion, of the main body of the storage unit 310, corresponding to the projecting member 314m of the door 314, and this projecting member 314m may be formed of an iron-based member, for example. Also in this case, the main body of the storage unit 310 and the projecting member 314m of the door 314 are attracted to each other by a magnetic force of the magnetic member provided on the main body of the storage unit 310, whereby the door 314 can be fixed in the closed state.

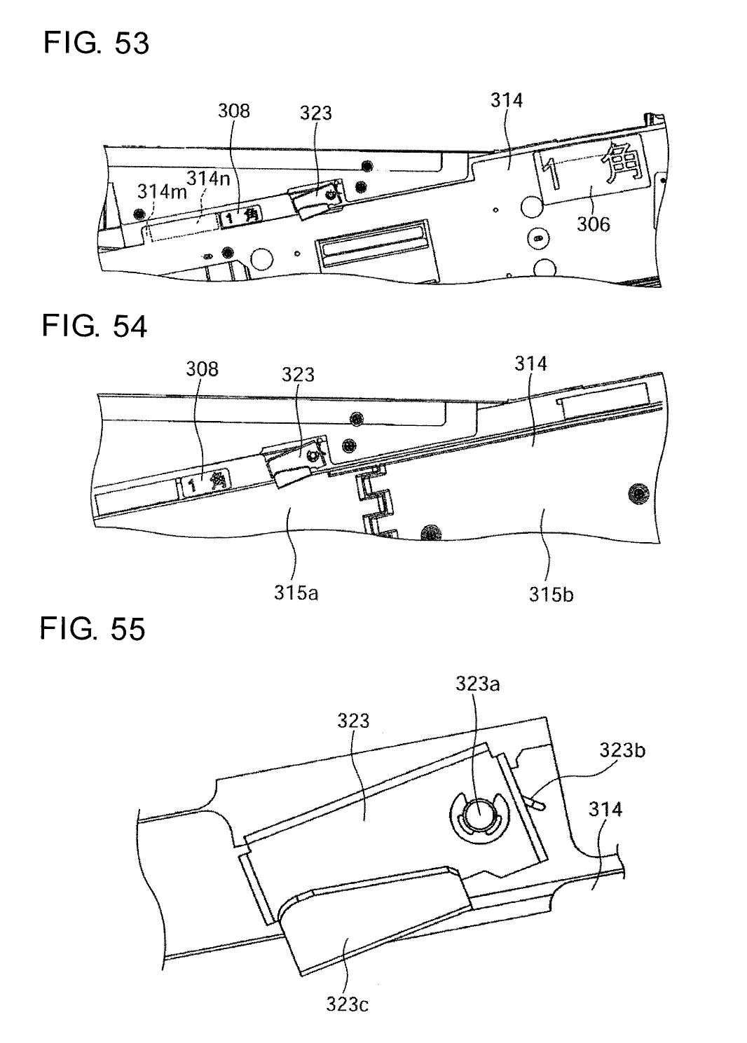

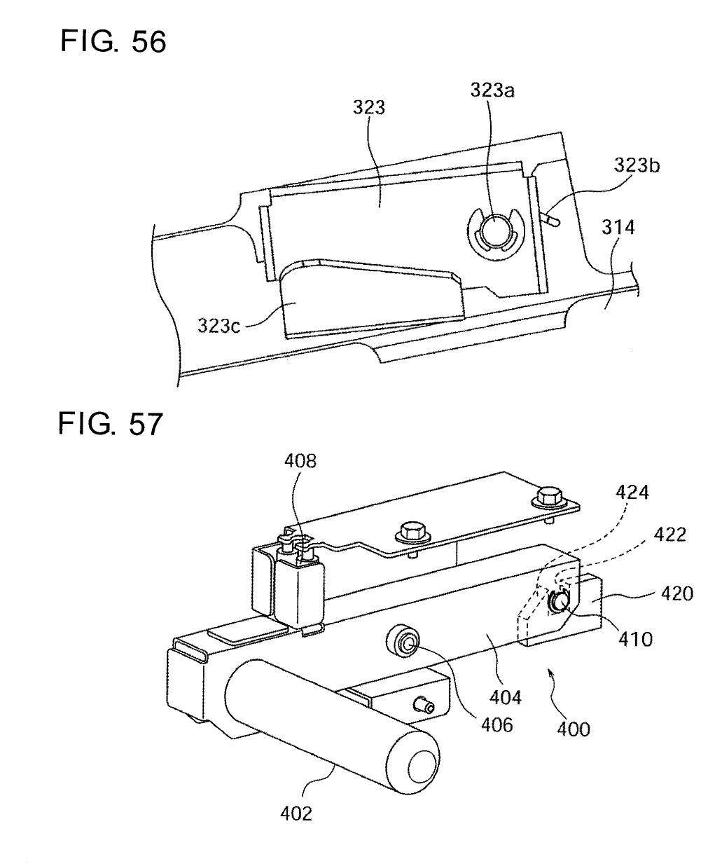

As shown in FIG. 53, the storage unit 310 is provided with, in addition to the above-described magnetic member 314n, a door fixing member (door lock member) 323 for fixing (locking) the door 314 in the closed state. The structure of the door fixing member 323 will be described in detail with reference to FIG. 53 through FIG. 56. FIG. 53 is a side view showing the structure of the door fixing member 323. FIG. 54 is a side view showing the structure when the door 314 is opened from the state shown in FIG. 53. FIG. 55 is a side view showing, in detail, the structure of the door fixing member 323 shown in FIG. 53. FIG. 56 is a side view showing the state when the door is opened by turning the door fixing member 323 shown in FIG. 55 upward.

As shown in FIG. 55 and FIG. 56, the door fixing member 323 is turnable about a shaft 323a provided in the main body of the storage unit 310. The shaft 323a is provided with a torsion spring 323b as a biasing member that biases the door fixing member 323 to keep the door fixing member 323 at a position (the position shown in FIG. 53) in which the door 314 is held in a closed state. The torsion spring 323b applies a force to the door fixing member 323 to turn the door fixing member 323 in the counter clockwise direction in FIG. 55 or FIG. 56 about the shaft 323a. In addition, a pressing member 323c for pressing the upper edge of the door 314 is attached to the door fixing member 323. The pressing member 323c is inclined with respect to the surface of the sheet of FIG. 55 or FIG. 56 so that its upper side is positioned frontward relative to its lower side. Regarding this door fixing member 323, when no force is applied to the door fixing member 323, a force that maintains the door fixing member 323 in the position shown in FIG. 53 is applied to the door fixing member 323 by the torsion spring 323b, and the pressing member 323c presses the upper edge of the door 314, whereby the door 314 is held in a closed state. On the other hand, when opening the door 314, an operator, with his/her fingers, turns the door fixing member 323 in the clockwise direction about the shaft 323a. Then, the pressing member 323c of the door fixing member 323 is retracted upward from the upper edge of the door 314 as shown in FIG. 56, whereby the operator can open the door 314. When the door 314 is opened, as shown in FIG. 54, the torsion spring 323b applies, to the door fixing member 323, a force to turn the door fixing member 323 in the counter clockwise direction about the shaft 323a, whereby the door fixing member 323 returns to the original position.

When the opened door 314 is closed, the pressing member 323c of the door fixing member 323 comes into contact with the upper edge of the door 314. As described above, the pressing member 323c is inclined with respect to the plane of the drawings of FIG. 55 or FIG. 56 so that its upper side is positioned frontward relative to its lower side. Therefore, when the pressing member 323c is pushed by the upper edge of the door 314, the pressing member 323c moves upward, and the door fixing member 323 turns in the clockwise direction in FIG. 55 or FIG. 56 about the shaft 323a. Thus, the pressing member 323c of the door fixing member 323 is retracted upward from the upper edge of the door 314. Thereafter, the door fixing member 323 returns to the position shown in FIG. 53, whereby the door 314 is fixed in the closed state. As described above, when the door 314 is closing, the upper edge of the door 314 comes into contact with the pressing member 323c of the door fixing member 323 and thereby the door fixing member 323 is turned in the clockwise direction in FIG. 55 or FIG. 56 against the biasing force caused by the torsion spring 323b, and thereafter, the door 314 is fixed to the closed state by the door fixing member 323.

As shown in FIG. 53, each storage unit 310 is provided with denomination indicating parts 306 and 308 such as labels indicating the denomination of wrapped coin rolls to be stored in the storage unit 310. Specifically, the denomination indicating part 306 is adhered to the front face of the door 314, while the denomination indicating part 308 is adhered to a portion, to the left of the door fixing member 323, of the main body of the storage unit 310. The denomination indicating parts 306 and 308 thus provided enable the operator to recognize at a glance which denomination of wrapped coin rolls should be replenished in the storage unit 310 in both cases where the door 314 is closed and the door 314 is opened.

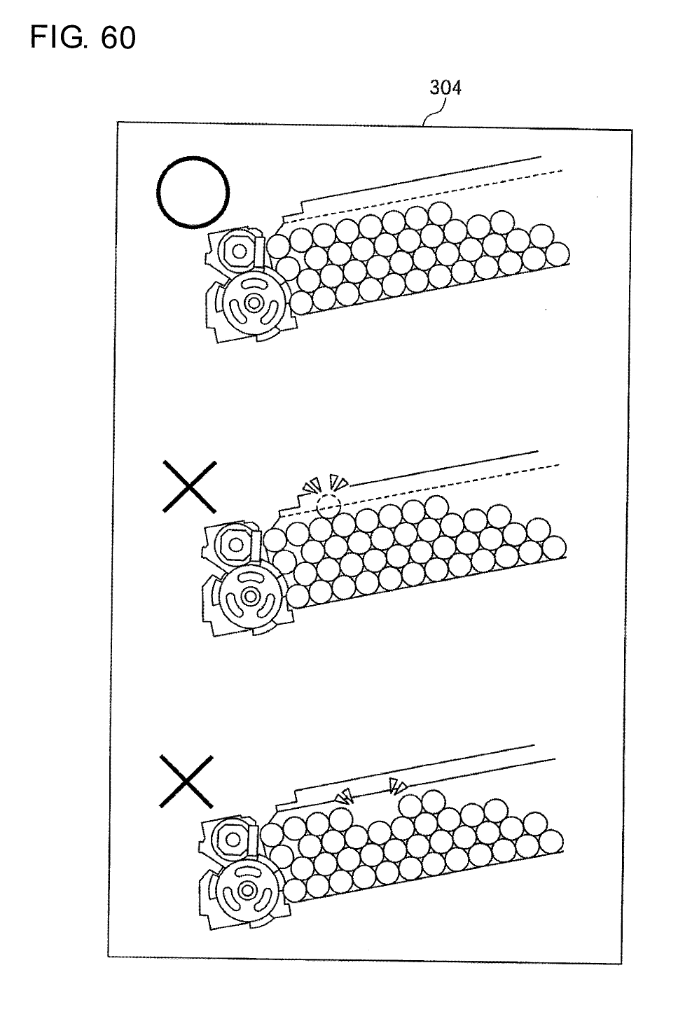

As shown in FIG. 51, a wrapped-coin insertion method indicating part 304 such as a label indicating how to insert wrapped coin rolls from the outside of the storage unit 310 into the storage area of the storage unit 310 is provided on the side face of the wrapped-coin dispensing apparatus 300. The content of the wrapped-coin insertion method indicating part 304 will be described with reference to FIG. 60. As shown in FIG. 60, the top image indicates a correct method of inserting wrapped coin rolls into the storage unit 310, while a second image and a bottom image each indicate an incorrect method of inserting wrapped coin rolls into the storage unit 310. Specifically, the second image indicates that, when inserting wrapped coin rolls, any wrapped coin roll should not be stacked at the rear side of the wrapped-coin insertion preventing member 317 or the wrapped-coin insertion preventing member 318 provided on the dispensing mechanism 319 side of the storage unit 310. The bottom chart indicates that, when inserting wrapped coin rolls, a space should not be formed anywhere among the wrapped coin rolls stacked in multiple layers in the storage area of the storage unit 310.

In the present embodiment, a scale (not shown) indicating the number of wrapped coin rolls stored at the bottom of the storage area may be provided on the bottom face 312 (storage face) of the storage unit 310. Alternatively, the door 314 may be formed of, for example, a transparent member or a semi-transparent member so that the operator can see the inside of the storage unit 310, and a scale (not shown) indicating the number of wrapped coin rolls stored at the bottom of the storage area may be provided on the transparent or semi-transparent member of the door 314. When such a scale is provided on the bottom face 312 of the storage unit 310 or on the door 314, the operator can know the approximate number of the stored wrapped coin rolls when replenishing wrapped coin rolls into the storage unit 310.

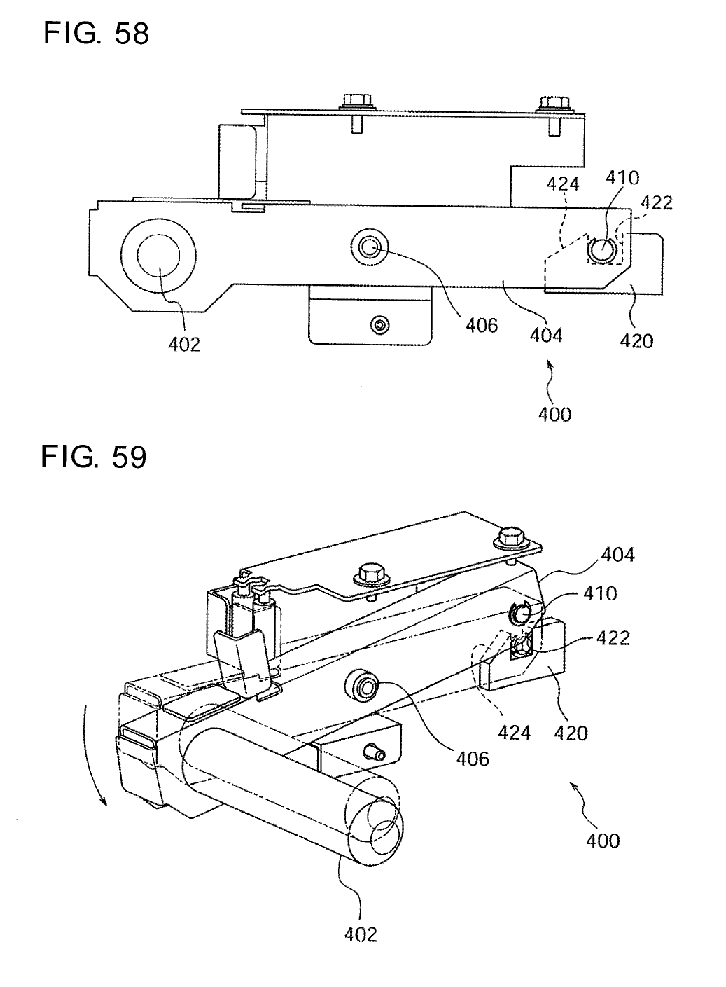

In the present embodiment, a fixing unit (lock unit) 400 for fixing (locking) the wrapped-coin dispensing apparatus 300 to the inside of the outer housing 12 is provided inside the outer housing 12 of the money changer 10. The structure of the fixing unit 400 will be described in detail with reference to FIG. 57 through FIG. 59. FIG. 57 is a perspective view showing the structure of the fixing unit 400. FIG. 58 is a side view of the fixing unit 400 shown in FIG. 57. FIG. 59 is a perspective view showing the operation of canceling the fixed state of the wrapped-coin dispensing apparatus 300 due to the fixing unit 400, by pushing downward a handle 402 provided in the fixing unit 400 shown in FIG. 57.

As shown in FIG. 57 and FIG. 58, the fixing unit 400 includes a bar-shaped member 404 that is turnable about a shaft 406 extending in the horizontal direction. At one of the end portions of the bar-shaped member 404, a handle 402 to be operated by an operator is provided. By operating the handle 402, it disengages the fixing unit 400 so the wrapped-coin dispensing apparatus 300 is free to be pulled out frontward from the inside of the outer housing 12 of the money changer 10. More specifically, after the upper door 14 and the lower door 16 of the outer housing 12 are opened, the fixing unit 400 is disengaged so the wrapped-coin dispensing apparatus 300 is free to be pulled out frontward from the inside of the outer housing 12 of the money changer 10.

As shown in FIG. 31, the fixing unit 400 is attached to the wrapped-coin dispensing apparatus 300, and when the wrapped-coin dispensing apparatus 300 is pulled out from the inside of the outer housing 12, the wrapped-coin dispensing apparatus 300 and the fixing unit 400 are integrally moved. In addition, the handle 402 of the fixing unit 400 is provided above the wrapped-coin dispensing apparatus 300, on the front side in the depth direction of the outer housing 12.

A pin member 410 is provided on the other end portion, of the bar-shaped member 404, opposite to the end portion where the handle 402 is provided. When the wrapped-coin dispensing apparatus 300 is completely housed in the outer housing 12, the pin member 410 can be engaged with a member-to-be-engaged 420 fixedly provided in the outer housing 12. More specifically, a recessed portion 422 is formed at an upper edge of the member-to-be-engaged 420 provided in the outer housing 12, and the pin member 410 is fitted in the recessed portion 422 (refer to FIG. 57 and FIG. 58). Further, a spring 408 that pulls the bar-shaped member 404 upward is provided on the bar-shaped member 404 at a position closer to the handle 402 than to the shaft 406. Thus, when the wrapped-coin dispensing apparatus 300 is completely housed in the outer housing 12, a portion of the bar-shaped member 404 at the position closer to the handle 402 than to the shaft 406 is pulled upward by the spring 408, whereby the pin member 410 is pushed downward and fitted in the recessed portion 422 of the member-to-be-engaged 420 provided in the outer housing 12. In this way, when the pin member 410 is fitted in the recessed portion 422 of the member-to-be-engaged 420 provided in the outer housing 12, the wrapped-coin dispensing apparatus 300 is fixed (locked) inside the outer housing 12 so that the wrapped-coin dispensing apparatus 300 cannot be pulled out frontward from the inside of the outer housing 12.

Meanwhile, when pulling out the wrapped-coin dispensing apparatus 300 frontward from the inside of the outer housing 12, the operator pushes the handle 402 downward to turn the bar-shaped member 404 about the shaft 406 as represented by a solid line in FIG. 59. Thus, the pin member 410 moves upward, and comes out from the recessed portion 422 of the member-to-be-engaged 420 provided in the outer housing 12. In this case, the wrapped-coin dispensing apparatus 300 can be pulled out frontward from the inside of the outer housing 12.

Further, an inclined portion 424 having a slanted surface inclined with respect to the vertical direction is provided frontward of the recessed portion 422 at an upper edge of the member-to-be-engaged 420. Therefore, when the wrapped-coin dispensing apparatus 300 pulled out from the outer housing 12 is returned to the inside of the outer housing 12, the pin member 410 of the fixing unit 400 comes into contact with the inclined portion 424 of the member-to-be-engaged 420. When the wrapped-coin dispensing apparatus 300 is further pushed into the outer housing 12, the bar-shaped member 404 turns about the shaft 406 so that the pin member 410 is raised along the slanted surface of the inclined portion 424. Thereafter, the pin member 410 is fitted in the recessed portion 422 of the member-to-be-engaged 420, whereby the wrapped-coin dispensing apparatus 300 is fixed (locked) inside the outer housing 12.

By virtue of the fixing unit 400, even when a large number of wrapped coin rolls are stored in each storage unit 310 of the wrapped-coin dispensing apparatus 300 and thereby the weight of the wrapped-coin dispensing apparatus 300 is increased, the wrapped-coin dispensing apparatus 300 can be pulled out frontward from the inside of the outer housing 12 by pushing the handle 402 downward to cancel the fixed state of the wrapped-coin dispensing apparatus 300 due to the fixing unit 400, and then pulling the handle 402 frontward. Therefore, the work burden on the operator can be reduced. In addition, since the handle 402 has both the function of canceling the fixed state of the wrapped-coin dispensing apparatus 300 due to the fixing unit 400, and the function of pulling out the wrapped-coin dispensing apparatus 300 frontward from the inside of the outer housing 12, space saving can be achieved.

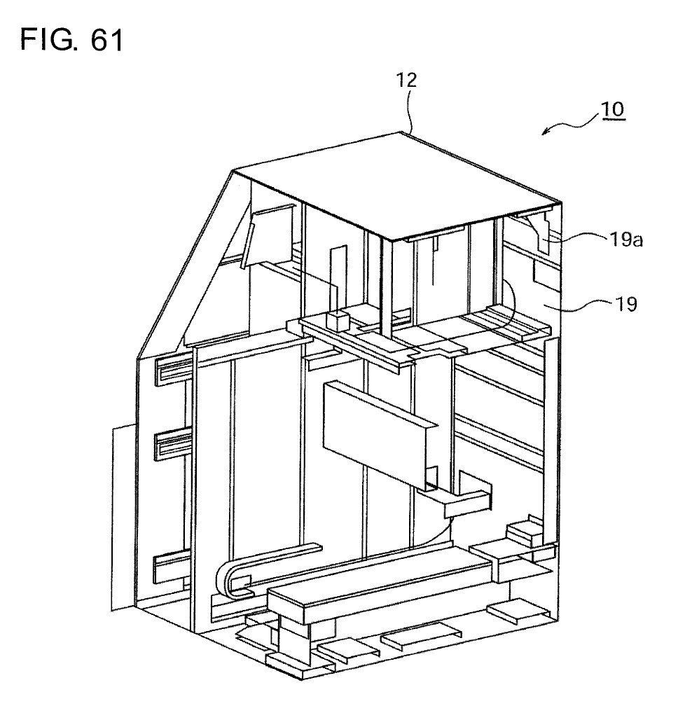

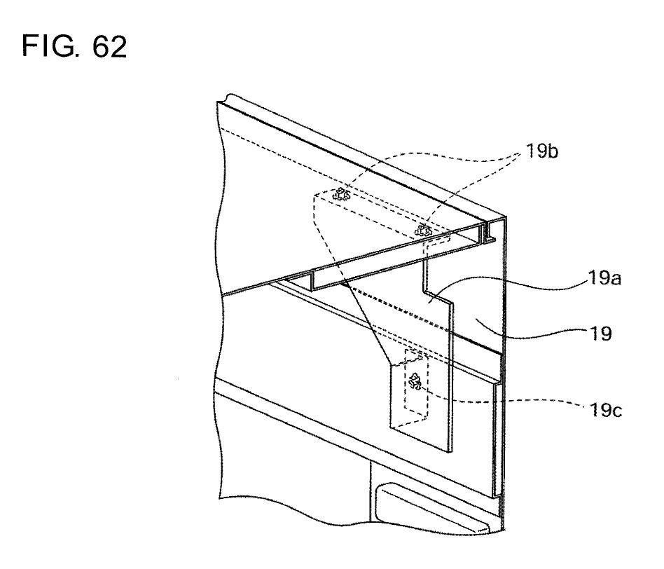

In the money changer 10 of the present embodiment, a back plate 19 provided on the back side is fixed to the outer housing 12 from the inner side by means of screws 19c or the like so as not to be detached from the outside. In addition, a pair of handles 19d is externally provided on the back plate 19 to allow an operator to easily perform a detaching operation of the back plate 19. The structure of the back plate 19 will be described with reference to FIG. 61 through FIG. 63. FIG. 61 is a perspective view showing the structure in which the back plate 19 of the money changer 10 shown in FIG. 1 is attached to the outer housing 12. FIG. 62 is an enlarged perspective view showing, in an enlarged manner, the structure in which the back plate 19 shown in FIG. 61 is attached to the outer housing 12. FIG. 63 is a perspective view showing the structure of the money changer 10 shown in FIG. 1 as seen from the rear side.

As shown in FIG. 61 and FIG. 62, an attachment member 19a is fixed by means of the screws 19c to the inner side of the back plate 19, and the attachment member 19a is also fixed to a ceiling plate of the outer housing 12 by means of screws 19b. Thus, the back plate 19 is fixed to the outer housing 12 from the inner side by means of the screws 19c, and cannot be detached from the outside of the outer housing 12. In addition to the attachment member 19a, a plurality of attachment members (not shown) are fixed by means of screws on the inner side of the back plate 19, and these attachment members are fixed to the side plates, the bottom plate, and the like of the outer housing 12 by means of screws.

As shown in FIG. 63, the pair of handles 19d is externally provided on the back plate 19 to allow an operator to easily perform a detaching operation of the back plate 19. When detaching the back plate 19 from the outer housing 12, the operator detaches the back plate 19 from the attachment member 19a by removing the screws 19c from the inside of the outer housing 12, and thereafter, holds the pair of handles 19d with both hands to carry the back plate 19.

1. A wrapped-coin dispensing apparatus comprising:
a storage unit provided with a dispensing mechanism configured to dispense a plurality of wrapped coin rolls which are stored on a storage face inclined with respect to a horizontal plane so as to be stacked in a direction in which the wrapped coin rolls run along the inclined storage face, the dispensing mechanism dispensing the wrapped coin rolls, one by one, from a side closest to a portion, at a lowest height level, of the storage face; and
a lift unit including a wrapped-coin storage member configured to store, therein, the wrapped coin rolls dispensed from the storage unit by the dispensing mechanism, the lift unit being movable in a vertical direction, wherein
the storage unit includes a pair of side walls which form a storage area for the wrapped coin rolls therebetween,
at least one of the pair of side walls is configured as an openable and closable door through which the wrapped coin rolls are taken in and out from the storage unit, and
the height of the storage area differs between a side, in the storage unit, where the dispensing mechanism is provided, and a side opposite to the side where the dispensing mechanism is provided.

2. The wrapped-coin dispensing apparatus according to claim 1, having a storage area regulating portion configured to reduce the height of the storage area is provided in an upper portion, of the storage unit, on the side opposite to the side where the dispensing mechanism is provided.

3. The wrapped-coin dispensing apparatus according to claim 1, wherein a wrapped-coin insertion preventing portion configured to prevent wrapped coin rolls from being inserted into an upper portion of the storage area from the outside of the storage unit is provided in an upper portion at a side face of the storage unit, on the side where the dispensing mechanism is provided.

4. The wrapped-coin dispensing apparatus according to claim 1, wherein the storage unit is provided with a denomination indicating part which indicates a denomination of wrapped coin rolls to be stored in the storage unit.

5. The wrapped-coin dispensing apparatus according to claim 1, wherein a wrapped-coin insertion method indicating part which indicates a method of inserting wrapped coin rolls into the storage area from the outside of the storage unit is provided.

6. The wrapped-coin dispensing apparatus according to claim 1, wherein the side wall of the storage unit, other than the door, is divided into a plurality of members, each member having a comb teeth shaped joint portion, and the comb teeth shaped joint portions of the members are mutually meshed.

7. The wrapped-coin dispensing apparatus according to claim 1, wherein
the dispensing mechanism includes:
a rotor configured to rotate about an axial center extending in a direction orthogonal to a direction of inclination of the storage unit and in a horizontal direction, the rotor having at least two recessed portions, each recessed portion receiving, one by one, the wrapped coin rolls stored in the storage unit; and
a drive unit configured to rotate the rotor about the axial center, and
a gear configured to transmit a rotational drive force to the rotor is provided on a side of the rotor, and the gear is provided with a plurality of through-holes corresponding to the recessed portions of the rotor.

8. The wrapped-coin dispensing apparatus according to claim 1, wherein a scale indicating the number of wrapped coin rolls stored at a bottom of the storage area is provided on the storage face of the storage unit.

9. The wrapped-coin dispensing apparatus according to claim 1, wherein the door is configured such that an operator is able to visually observe the inside of the storage unit, and the door is provided with a scale indicating the number of wrapped coin rolls stored at a bottom of the storage area.
